(19) United States
(12) Patent Application Publication
(10) Pub. No.: US 2026/0037738 A1
(43) Pub. Date: Feb. 5, 2026

(54) System and Method for Geometric Compression and Persistent Memory Management of Genomic Data Using Dynamic Latent Manifolds

(71) Applicant: AtomBeam Technologies Inc., Moraga, CA (US)

(72) Inventor: Brian Galvin, Silverdale, WA (US)

(21) Appl. No.: 19/351,751

(22) Filed: Oct. 7, 2025

Related U.S. Application Data
(63) Continuation-in-part of application No. 19/321,173, filed on Sep. 6, 2025.
Application No. 19/321,173 is a continuation-in-part of application No. 19/284,115, filed on Jul. 29, 2025.
Application No. 19/284,115 is a continuation of application No. 19/051,193, filed on Feb. 12, 2025, now Pat. No. 12,387,050.
(63) Continuation-in-part of application No. 19/048,846, filed on Feb. 7, 2025, now Pat. No. 12,443,564.
Application No. 19/048,846 is a continuation-in-part of application No. 18/769,416, filed on Jul. 11, 2024, now Pat. No. 12,224,044.
Application No. 18/769,416 is a continuation-in-part of application No. 18/420,771, filed on Jan. 24, 2024, now Pat. No. 12,095,484.
Application No. 18/420,771 is a continuation-in-part of application No. 18/410,980, filed on Jan. 11, 2024, now Pat. No. 12,068,761.
Application No. 18/410,980 is a continuation-in-part of application No. 18/537,728, filed on Dec. 12, 2023, now Pat. No. 12,058,333.
(60) Provisional application No. 63/847,082, filed on Jul. 19, 2025.
(60) Provisional application No. 63/847,091, filed on Jul. 19, 2025.
(60) Provisional application No. 63/847,096, filed on Jul. 19, 2025.
(60) Provisional application No. 63/847,101, filed on Jul. 19, 2025.

(51) Int. Cl. G06F 40/30; G06F 16/332; G06F 16/3329

(52) U.S. Cl. CPC G06F 40/30; G06F 16/3325; G06F 16/3329

(57) ABSTRACT

A system and method for processing genomic data using dynamic latent manifolds that transforms multi-modal genomic datasets into geometric representations within a curved manifold space. The system receives genomic datasets including DNA sequences, genetic variants, and expression data, then extracts biological features and assesses importance using trained neural networks. Manifold curvature values are computed based on biological significance, and genomic data is embedded as geometric structures where semantic relationships are represented through distance and curvature properties. The system generates compression pressure fields that influence processing decisions and computes optimal geodesic paths through the manifold to minimize cognitive action functionals. Adaptive compression rates are determined for different genomic regions based on geometric properties and biological importance. The manifold structure evolves through use, strengthening frequently accessed pathways while applying thermodynamic decay to unused concepts. The system supports hierarchical organization across biological scales, reversible navigation, and federated learning capabilities that enable privacy-preserving collaboration.

### CROSS-REFERENCE TO RELATED APPLICATIONS

Priority is claimed in the application data sheet to the following patents or patent applications, each of which is expressly incorporated herein by reference in its entirety:
Ser. No. 19/321,173
Ser. No. 19/284,115
Ser. No. 19/051,193
63/847,082
63/847,091
63/847,096
63/847,101
Ser. No. 19/048,846
Ser. No. 18/769,416
Ser. No. 18/420,771
Ser. No. 18/410,980
Ser. No. 18/537,728

### BACKGROUND OF THE INVENTION

### Field of the Art

The present invention is in the field of data compression, and more particularly is directed to the problem of recovering data lost from lossy compression and decompression.

### Discussion of the State of the Art

Recent advances in genomic sequencing technologies have generated datasets of unprecedented size and complexity, creating significant challenges in data compression, storage, and analysis. Modern genomic studies routinely produce terabytes of multi-modal data including DNA sequences, gene expression profiles, protein measurements, and clinical annotations, straining existing computational infrastructure and analytical capabilities.

Current genomic data compression approaches rely on general-purpose algorithms such as gzip and specialized tools like CRAM that treat genomic data as generic sequences without exploiting biological structure or functional relationships. These methods achieve modest compression ratios while failing to consider the biological meaning, clinical significance, or downstream analytical requirements of the compressed data. The lack of biologically-informed compression strategies results in suboptimal performance and potential loss of critical biological information.

Existing multi-omics analysis frameworks process diverse genomic data types through separate computational pipelines that fail to leverage fundamental correlations between DNA sequences, expression patterns, and protein measurements. This fragmented approach leads to analytical inefficiencies, missed biological insights, and suboptimal utilization of the rich information content present in integrated genomic datasets. Moreover, current compression and analysis decisions are made independently, without consideration of their impact on biological interpretation or clinical utility.

Artificial intelligence applications in genomics typically employ general-purpose neural networks that were not designed for the hierarchical, multi-scale nature of biological organization. Current AI approaches treat genomic data as flat sequences or independent measurements, failing to capture complex functional relationships across different levels of biological organization from individual nucleotides to cellular pathways to population patterns. This limitation results in models that cannot effectively leverage structured biological knowledge.

Privacy protection in genomic research relies primarily on access controls and data use agreements that limit collaboration and slow scientific progress. Existing privacy-preserving techniques such as differential privacy provide inadequate protection or unacceptable performance degradation when applied to genomic data. The lack of effective privacy-preserving collaboration tools significantly limits researchers' ability to leverage large-scale, diverse genomic datasets essential for biological discovery and clinical validation.

Current genomic processing systems lack intelligent memory management strategies and require loading entire datasets into memory, creating bottlenecks that prevent real-time analysis in clinical settings. Existing approaches also fail to preserve essential biological relationships such as gene regulatory networks and metabolic pathways during data processing, potentially leading to analytical artifacts and clinical misinterpretations.

What is needed is a unified computational framework that integrates geometric processing, adaptive memory management, and biologically-informed optimization to create intelligent genomic data processing systems that preserve biological relationships while achieving superior compression performance and analytical accuracy. Such a system should leverage hierarchical biological organization, employ dynamic adaptation based on biological discoveries, and support privacy-preserving collaborative analysis while maintaining comprehensive biological validation throughout all processing operations.

### SUMMARY OF THE INVENTION

Accordingly, the inventor has conceived and reduced to practice, a system and method for processing genomic data using dynamic latent manifolds that transforms multi-modal genomic datasets into geometric representations within a curved manifold space. The system receives genomic datasets including DNA sequences, genetic variants, and expression data, then extracts biological features and assesses importance using trained neural networks. Manifold curvature values are computed based on biological significance, and genomic data is embedded as geometric structures where semantic relationships are represented through distance and curvature properties. The system generates compression pressure fields that influence processing decisions and computes optimal geodesic paths through the manifold to minimize cognitive action functionals. Adaptive compression rates are determined for different genomic regions based on geometric properties and biological importance. The manifold structure evolves through use, strengthening frequently accessed pathways while applying thermodynamic decay to unused concepts. The system supports hierarchical organization across biological scales, reversible navigation, and federated learning capabilities that enable privacy-preserving collaboration.

According to a preferred embodiment, a computer system for processing genomic data using dynamic latent manifolds is disclosed, comprising: a hardware memory and at least one processor; wherein the computer system is configured to execute software instructions stored on nontransitory machine-readable storage media that: receive genomic datasets; extract biological features from the genomic datasets; assess biological importance of genomic regions using a trained neural network that generates importance scores; compute manifold curvature values using the biological features and importance scores; embed the genomic data into a dynamic latent manifold as geometric structures, wherein the manifold evolves through use and semantic relationships are represented through geometric properties including distance and curvature; generate compression pressure fields derived from local curvature that influence processing decisions; compute optimal geodesic paths through the latent manifold that minimize a cognitive action functional; determine adaptive compression rates for genomic regions based on geometric properties and biological importance; execute compression of genomic data according to the determined rates while preserving manifold coordinate information for reconstruction; update the geometric structure of the latent manifold based on usage patterns; and generate outputs by decoding geometric information from manifold traversals into genomic analysis results.

According to another preferred embodiment, a method for processing genomic data using dynamic latent manifolds is disclosed, comprising the steps of: receiving genomic datasets; extracting biological features from the genomic datasets; assessing biological importance of genomic regions using a trained neural network that generates importance scores; computing manifold curvature values using the biological features and importance scores; embedding the genomic data into a dynamic latent manifold as geometric structures, wherein the manifold evolves through use and semantic relationships are represented through geometric properties including distance and curvature; generating compression pressure fields derived from local curvature that influence processing decisions; computing optimal geodesic paths through the latent manifold that minimize a cognitive action functional; determining adaptive compression rates for genomic regions based on geometric properties and biological importance; executing compression of genomic data according to the determined rates while preserving manifold coordinate information for reconstruction; updating the geometric structure of the latent manifold based on usage patterns; and generating outputs by decoding geometric information from manifold traversals into genomic analysis results.

According to a further aspect, the method includes genomic datasets comprising multi-modal data including DNA sequences, genetic variants, gene expression data, and protein abundance measurements.

According to a further aspect, the method includes biological features which include sequence complexity metrics, conservation scores, functional annotations, and cross-modal correlations between different genomic data types.

According to a further aspect, the method includes the steps of: organizing genomic data into thought bundles comprising coherent submanifolds of semantically related biological concepts; performing bundle reorganization operations including consolidation of related concepts, expansion into new biological domains, and merging of functionally related bundles; and maintaining biological taxonomy during bundle modifications.

According to a further aspect, the method includes trained neural network comprising: recurrent layers for extracting features from genomic datasets; a channel-wise transformer with attention mechanisms to capture dependencies between different genomic data types; hierarchical attention mechanisms operating at multiple biological scales; and multi-task learning heads for generating importance scores, compression predictions, and quality assessments.

According to a further aspect, the method includes the steps of: applying thermodynamic decay to remove unused genomic concepts from the manifold based on activation energy levels; strengthening frequently used geodesic pathways by adjusting geometric properties; and preserving biological relationships during manifold evolution.

According to a further aspect, the method includes the steps of: executing autonomous manifold reorganization during idle periods through perturbation and recombination of existing structures; discovering new biological relationship patterns through geometric analysis; performing topological modifications to create connections between genomic domains; and validating structural changes against biological constraints.

According to a further aspect, the method includes the steps of: implementing hierarchical organization with nested latent manifolds operating at different biological scales; establishing geometric bridges between abstraction levels; enabling navigation between scales while preserving biological relationships; and maintaining consistency across hierarchical levels.

According to a further aspect, the method includes the steps of: maintaining reversible navigation capabilities including forward exploration and backward traversal; creating geometric anchors at decision points in processing paths; storing temporal snapshots of manifold states; and enabling backtracking while preserving semantic relationships.

According to a further aspect, the method includes the steps of: implementing federated learning capabilities for knowledge sharing across multiple processing instances; creating privacy-preserving abstractions through geometric generalization; performing secure computation for collaborative optimization; and maintaining protection of sensitive genomic information during knowledge exchange.

### BRIEF DESCRIPTION OF THE DRAWING FIGURES

FIG. 1 is a block diagram illustrating an exemplary system architecture for upsampling of decompressed data after lossy compression using a neural network, according to an embodiment.

FIGS. 2A and 2B illustrate an exemplary architecture for an AI deblocking network configured to provide deblocking on dual-channel data stream comprising SAR I/Q data, according to an embodiment.

FIG. 3 is a block diagram illustrating an exemplary architecture for a component of the system for SAR image compression, the channel-wise transformer.

FIG. 4 is a block diagram illustrating an exemplary system architecture for providing lossless data compaction, according to an embodiment.

FIG. 5 is a diagram showing an embodiment of one aspect of the lossless data compaction system, specifically data deconstruction engine.

FIG. 6 is a diagram showing an embodiment of another aspect of lossless data compaction system, specifically data reconstruction engine.

FIG. 7 is a diagram showing an embodiment of another aspect of lossless data compaction the system, specifically library manager.

FIG. 8 is a flow diagram illustrating an exemplary method for complex-valued SAR image compression, according to an embodiment.

FIG. 9 is a flow diagram illustrating and exemplary method for decompression of a complex-valued SAR image, according to an embodiment.

FIG. 10 is a flow diagram illustrating an exemplary method for deblocking using a trained deep learning algorithm, according to an embodiment.

FIGS. 11A and 11B illustrate an exemplary architecture for an AI deblocking network configured to provide deblocking for a general N-channel data stream, according to an embodiment.

FIG. 12 is a block diagram illustrating an exemplary system architecture for N-channel data compression with predictive recovery, according to an embodiment.

FIG. 13 is a flow diagram illustrating an exemplary method for processing a compressed n-channel bit stream using an AI deblocking network, according to an embodiment.

FIG. 14 is a block diagram illustrating a system for training a neural network to perform upsampling of decompressed data after lossy compression, according to an embodiment.

FIG. 15 is a flow diagram illustrating an exemplary method for training a neural network to perform upsampling of decompressed data after lossy compression, according to an embodiment.

FIG. 16 is a block diagram illustrating an exemplary architecture for a neural upsampler configured to process N-channel time-series data, according to an embodiment.

FIG. 17 is a block diagram illustrating an exemplary system architecture for upsampling of decompressed sensor data after lossy compression using a neural network, according to an embodiment.

FIG. 18 is a flow diagram illustrating an exemplary method for performing neural upsampling of two or more time-series data streams, according to an embodiment.

FIG. 19 is a block diagram illustrating an exemplary system architecture for neural upsampling of two or more genomic datasets, according to an embodiment.

FIG. 20 is a flow diagram illustrating an exemplary method for performing neural upsampling of two or more genomic datasets, according to an embodiment.

FIG. 21 illustrates an exemplary computing environment on which an embodiment described herein may be implemented, in full or in part.

FIG. 22 is a block diagram illustrating an exemplary system architecture for a multi-task learning neural network for the upsampling of integrative-omics data according to an embodiment.

FIG. 23 is a block diagram illustrating and exemplary architecture of quality analysis core.

FIG. 24 is a method diagram illustrating the variable compression rate selection process according to an embodiment.

FIG. 25 is a method diagram illustrating the training process according to an embodiment.

FIG. 26 is a block diagram illustrating an exemplary system architecture of a Persistent Cognitive Machine (PCM).

FIG. 27 is a block diagram illustrating an exemplary system architecture for genomic data compression using dynamic latent manifolds according to an embodiment.

FIG. 28 is a block diagram illustrating an exemplary mathematical framework for genomic manifold operations, which may be implemented as a multi-layer computing stack, and provides a computational foundation for the genomic data compression system with latent manifolds, according to an embodiment.

FIG. 29 is a block diagram illustrating an exemplary neural network architecture for genomic processing that enables the transformation of biological genomic data into geometric representations suitable for processing within a persistent cognitive machine system.

FIG. 30 is a flow diagram illustrating an exemplary method for genomic data compression using dynamic latent manifolds that implements the core processing pipeline of the system architecture for geometric compression of genomic data, according to an embodiment.

FIG. 31 is a flow diagram illustrating an exemplary method for training a genomic neural network architecture that provides the computational foundation for the genomic data compression system with latent manifolds.

FIG. 32 is a flow diagram illustrating an exemplary method for genomic data recovery from compressed manifold representations that implements the reconstruction capabilities of a genomic decoder, according to an embodiment.

FIG. 33 is a flow diagram illustrating an exemplary method for dynamic manifold evolution during genomic processing that implements the continuous learning and adaptation capabilities of the persistent cognitive machine framework applied to genomic data compression and analysis.

FIG. 34 is a flow diagram illustrating an exemplary method for multi-scale genomic feature extraction and manifold embedding that implements the hierarchical processing capabilities required to represent genomic information across multiple biological scales within the persistent cognitive machine framework.

FIG. 35 is a flow diagram illustrating an exemplary method for federated genomic knowledge sharing across manifold instances that enables collaborative learning between multiple genomic processing systems while maintaining strict privacy protection and preserving the confidentiality of sensitive patient data.

### DETAILED DESCRIPTION OF THE INVENTION

The inventor has conceived, and reduced to practice, a system and method for processing genomic data using dynamic latent manifolds that transforms multi-modal genomic datasets into geometric representations within a curved manifold space. The system receives genomic datasets including DNA sequences, genetic variants, and expression data, then extracts biological features and assesses importance using trained neural networks. Manifold curvature values are computed based on biological significance, and genomic data is embedded as geometric structures where semantic relationships are represented through distance and curvature properties. The system generates compression pressure fields that influence processing decisions and computes optimal geodesic paths through the manifold to minimize cognitive action functionals. Adaptive compression rates are determined for different genomic regions based on geometric properties and biological importance. The manifold structure evolves through use, strengthening frequently accessed pathways while applying thermodynamic decay to unused concepts. The system supports hierarchical organization across biological scales, reversible navigation, and federated learning capabilities that enable privacy-preserving collaboration.

SAR images provide an excellent exemplary use case for a system and methods for upsampling of decompressed data after lossy compression. Synthetic Aperture Radar technology is used to capture detailed images of the Earth's surface by emitting microwave signals and measuring their reflections. Unlike traditional grayscale images that use a single intensity value per pixel, SAR images are more complex. Each pixel in a SAR image contains not just one value but a complex number (I+Qi). A complex number consists of two components: magnitude (or amplitude) and phase. In the context of SAR, the complex value at each pixel represents the strength of the radar signal's reflection (magnitude) and the phase shift (phase) of the signal after interacting with the terrain. This information is crucial for understanding the properties of the surface and the objects present. In a complex-value SAR image, the magnitude of the complex number indicates the intensity of the radar reflection, essentially representing how strong the radar signal bounced back from the surface. Higher magnitudes usually correspond to stronger reflections, which may indicate dense or reflective materials on the ground.

The complex nature of SAR images stems from the interference and coherence properties of radar waves. When radar waves bounce off various features on the Earth's surface, they can interfere with each other. This interference pattern depends on the radar's wavelength, the angle of incidence, and the distances the waves travel. As a result, the radar waves can combine constructively (amplifying the signal) or destructively (canceling out the signal). This interference phenomenon contributes to the complex nature of SAR images. The phase of the complex value encodes information about the distance the radar signal traveled and any changes it underwent during the round-trip journey. For instance, if the radar signal encounters a surface that's slightly elevated or depressed, the phase of the returning signal will be shifted accordingly. Phase information is crucial for generating accurate topographic maps and understanding the geometry of the terrain.

Coherence refers to the consistency of the phase relationship between different pixels in a SAR image. Regions with high coherence have similar phase patterns and are likely to represent stable surfaces or structures, while regions with low coherence might indicate changes or disturbances in the terrain.

Complex-value SAR image compression is important for several reasons such as data volume reduction, bandwidth and transmission efficiency, real-time applications, and archiving and retrieval. SAR images can be quite large due to their high resolution and complex nature. Compression helps reduce the storage and transmission requirements, making it more feasible to handle and process the data. When SAR images need to be transmitted over limited bandwidth channels, compression can help optimize data transmission and minimize communication costs. Some SAR applications, such as disaster response and surveillance, require real-time processing. Compressed data can be processed faster, enabling quicker decision-making. Additionally, compressed SAR images take up less storage space, making long-term archiving and retrieval more manageable.

According to various embodiments, a system is proposed which provides a novel pipeline for compressing and subsequently recovering complex-valued SAR image data using a prediction recovery framework that utilizes a conventional image compression algorithm to encode the original image to a bitstream. In an embodiment, a lossless compaction method may be applied to the encoded bitstream, further reducing the size of the SAR image data for both storage and transmission. Subsequently, the system decodes a prediction of the I/Q channels and then recovers the phase and amplitude via a deep-learning based network to effectively remove compression artifacts and recover information of the SAR image as part of the loss function in the training. The deep-learning based network may be referred to herein as an artificial intelligence (AI) deblocking network.

Deblocking refers to a technique used to reduce or eliminate blocky artifacts that can occur in compressed images or videos. These artifacts are a result of lossy compression algorithms, such as JPEG for images or various video codecs like H.264, H.265 (HEVC), and others, which divide the image or video into blocks and encode them with varying levels of quality. Blocky artifacts, also known as “blocking artifacts,” become visible when the compression ratio is high, or the bitrate is low. These artifacts manifest as noticeable edges or discontinuities between adjacent blocks in the image or video. The result is a visual degradation characterized by visible square or rectangular regions, which can significantly reduce the overall quality and aesthetics of the content. Deblocking techniques are applied during the decoding process to mitigate or remove these artifacts. These techniques typically involve post-processing steps that smooth out the transitions between adjacent blocks, thus improving the overall visual appearance of the image or video. Deblocking filters are commonly used in video codecs to reduce the impact of blocking artifacts on the decoded video frames.

According to various embodiments, the disclosed system and methods may utilize a SAR recovery network configured to perform data deblocking during the data decoding process. Amplitude and phase images exhibit a non-linear relationship, while I and Q images demonstrate a linear relationship. The SAR recovery network is designed to leverage this linear relationship by utilizing the I/Q images to enhance the decoded SAR image. In an embodiment, the SAR recovery network is a deep learned neural network. According to an aspect of an embodiment, the SAR recovery network utilizes residual learning techniques. According to an aspect of an embodiment, the SAR recovery network comprises a channel-wise transformer with attention. According to an aspect of an embodiment, the SAR recovery network comprises Multi-Scale Attention Blocks (MSAB).

A channel-wise transformer with attention is a neural network architecture that combines elements of both the transformer architecture and channel-wise attention mechanisms. It's designed to process multi-channel data, such as SAR images, where each channel corresponds to a specific feature map or modality. The transformer architecture is a powerful neural network architecture initially designed for natural language processing (NLP) tasks. It consists of self-attention mechanisms that allow each element in a sequence to capture relationships with other elements, regardless of their position. The transformer has two main components: the self-attention mechanism (multi-head self-attention) and feedforward neural networks (position-wise feedforward layers). Channel-wise attention, also known as “Squeeze-and-Excitation” (SE) attention, is a mechanism commonly used in convolutional neural networks (CNNs) to model the interdependencies between channels (feature maps) within a single layer. It assigns different weights to different channels to emphasize important channels and suppress less informative ones. At each layer of the network, a channel-wise attention mechanism is applied to the input data. This mechanism captures the relationships between different channels within the same layer and assigns importance scores to each channel based on its contribution to the overall representation. After the channel-wise attention, a transformer-style self-attention mechanism is applied to the output of the channel-wise attention. This allows each channel to capture dependencies with other channels in a more global context, similar to how the transformer captures relationships between elements in a sequence. Following the transformer self-attention, feedforward neural network layers (position-wise feedforward layers) can be applied to further process the transformed data.

The system and methods described herein in various embodiments may be directed to the processing of audio data such as, for example, speech channels associated with one or more individuals.

According to various embodiments, the quality analysis core comprises multiple integrated subsystems working in concert to evaluate genomic data importance. The feature analysis subsystem analyzes genomic sequences, computing relevant metrics including GC content, sequence complexity, and pattern identification while maintaining a comprehensive feature registry. Working in parallel, the quality assessment subsystem assigns importance scores to regions, generates confidence metrics, and validates quality scores against curated reference datasets. A dedicated training subsystem handles model updates and maintains version control while performing continuous validation against known important genomic regions.

A rate control engine determines optimal compression rates based on the quality scores generated by the quality analysis core. Its rate selection subsystem processes these quality scores through specialized algorithms that balance quality preservation against compression efficiency. A resource management subsystem monitors and optimizes system resource usage, while the configuration subsystem maintains compression parameters and adapts to varying system constraints. This dynamic approach ensures efficient processing of genomic data while maintaining critical information fidelity.

A data pipeline manager orchestrates the flow of genomic data through the system via a series of specialized buffers. An input buffer receives incoming sequences and organizes them into processing windows, while a processing buffer manages data during active analysis across multiple regions simultaneously. The output buffer ensures data integrity during final assembly of compressed regions. This pipeline architecture enables efficient parallel processing of multiple genomic datasets while maintaining strict data quality controls.

A recovery integration engine provides seamless connection with the existing recovery network through several specialized components. An integration manager coordinates the overall process while maintaining version compatibility, while a data transform subsystem ensures format compatibility across different data structures. The recovery control subsystem optimizes reconstruction parameters based on compression metadata, and an error recovery subsystem implements sophisticated retry logic for failed recoveries. A performance monitor tracks recovery metrics and generates detailed performance analytics.

A metadata engine maintains comprehensive tracking of system operations through multiple specialized subsystems. A storage and version control subsystem organizes metadata storage and ensures data integrity, while an access control subsystem manages queries and enforces security policies. The version control subsystem handles model versions and ensures backward compatibility, while an optimization feedback subsystem tracks compression effectiveness and implements continuous improvement loops based on recovery performance.

The system's neural network incorporates multi-task learning capabilities specifically designed for genomic data processing. This architecture enables simultaneous processing of different genomic data types while maintaining task-specific features. The channel-wise transformer implements sophisticated attention mechanisms that capture both local and global relationships within the genomic sequence data, particularly important for identifying functional relationships between distant regions. This transformer architecture assigns dynamic importance weights to different regions based on their contextual relevance, enabling more effective information recovery during decompression.

Resources are managed through a sophisticated system management core that provides real-time oversight of operations. Error management implements detection and recovery procedures while monitoring quality thresholds, while monitoring and logging collects comprehensive performance metrics. Cache management optimizes data access patterns across different processing stages, and a resource governor coordinates parallel processing while managing system resource allocation. This integrated approach ensures efficient processing of large-scale genomic datasets while maintaining strict quality controls.

According to various embodiments, the system implements a sophisticated data flow architecture that can operate either as a standalone genomic data compression system or in conjunction with existing compression recovery frameworks. Initial data ingestion begins at the data pipeline manager, where incoming genomic sequences are received by the input buffer and organized into configurable processing windows. The sequence preprocessing subsystem performs initial validation checks and format normalization before passing the data to the quality analysis engine.

Within the quality analysis engine, the feature analysis subsystem extracts key characteristics from the genomic sequences, computing metrics such as GC content, sequence complexity, and pattern identification. These features are passed to the quality assessment subsystem, which generates importance scores for each region based on both computed metrics and reference datasets. The quality scores and feature vectors are then forwarded to the rate control engine, which determines optimal compression parameters for each region based on its assessed importance.

The rate control engine's selection subsystem processes these quality scores in conjunction with current system resource availability and configuration parameters to determine region-specific compression rates. This adaptive approach ensures that regions identified as highly important receive preferential treatment in the compression process, maintaining higher fidelity for crucial genomic sequences while allowing greater compression in less critical regions.

When operating independently, the system proceeds to compress the genomic data according to the determined rates, with the output buffer assembling the compressed regions and associated metadata into a complete package for storage or transmission. The metadata engine maintains comprehensive records of the compression parameters, quality scores, and region-specific settings to facilitate accurate reconstruction during subsequent decompression.

When operating in conjunction with the existing recovery system, the integration manager coordinates the handoff between systems. The data transform subsystem ensures format compatibility, while the recovery control subsystem provides compression metadata to inform the recovery process. This integrated operation enables the quality-driven compression to work seamlessly with the existing neural recovery network, enhancing overall reconstruction quality through the combination of adaptive compression and sophisticated recovery techniques.

During the recovery phase, whether operating independently or in conjunction with the existing system, the channel-wise transformer leverages the preserved metadata to inform the reconstruction process. The transformer's attention mechanism utilizes the quality scores and compression parameters to guide the recovery of different regions, applying appropriate levels of processing based on the original assessment of importance. This approach ensures that the recovery process maintains fidelity to the original genomic sequence characteristics while effectively managing computational resources.

The system management core provides continuous oversight throughout the entire process, with the resource governor dynamically allocating processing resources based on current demands and the cache management subsystem optimizing data access patterns. The monitoring and logging subsystem maintains detailed records of system performance and recovery quality, enabling continuous optimization of the compression and recovery parameters through the optimization feedback subsystem.

According to various embodiments, the system is designed to process multiple types of correlated datasets while maintaining data fidelity and compression efficiency. While genomic data represents a primary use case, with the system being particularly effective at handling parallel genome datasets, DNA sequences, single nucleotide polymorphisms (SNPs), gene expression data, and integrative-omics data, the architecture can be adapted to various other forms of correlated data. The system can process time-series data from multiple sensors, particularly when temporal or spatial correlations exist between the data streams, such as in Internet of Things (IoT) deployments where multiple sensors monitor related phenomena. Complex-valued data, such as SAR imagery with its I and Q components, demonstrates another effective use case where the system leverages the inherent relationships between channels to enhance recovery quality. The system can also handle multi-channel audio data, such as multiple speech channels from different individuals, where cross-channel dependencies can be exploited for improved compression and recovery. For each data type, the quality analysis engine adapts its feature extraction and importance scoring mechanisms to the specific characteristics of the data, while the rate control engine optimizes compression parameters based on the identified correlations and dependencies between channels or datasets. This flexibility enables the system to maintain high reconstruction quality across diverse data types while achieving efficient compression ratios through the exploitation of inter-channel and cross-dataset relationships.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

The term “bit” refers to the smallest unit of information that can be stored or transmitted. It is in the form of a binary digit (either 0 or 1). In terms of hardware, the bit is represented as an electrical signal that is either off (representing 0) or on (representing 1).

The term “codebook” refers to a database containing sourceblocks each with a pattern of bits and reference code unique within that library. The terms “library” and “encoding/decoding library” are synonymous with the term codebook.

The terms “compression” and “deflation” as used herein mean the representation of data in a more compact form than the original dataset. Compression and/or deflation may be either “lossless”, in which the data can be reconstructed in its original form without any loss of the original data, or “lossy” in which the data can be reconstructed in its original form, but with some loss of the original data.

The terms “compression factor” and “deflation factor” as used herein mean the net reduction in size of the compressed data relative to the original data (e.g., if the new data is 70% of the size of the original, then the deflation/compression factor is 30% or 0.3.)

The terms “compression ratio” and “deflation ratio”, and as used herein all mean the size of the original data relative to the size of the compressed data (e.g., if the new data is 70% of the size of the original, then the deflation/compression ratio is 70% or 0.7.)

The term “data set” refers to a grouping of data for a particular purpose. One example of a data set might be a word processing file containing text and formatting information. Another example of a data set might comprise data gathered/generated as the result of one or more radars in operation.

The term “sourcepacket” as used herein means a packet of data received for encoding or decoding. A sourcepacket may be a portion of a data set.

The term “sourceblock” as used herein means a defined number of bits or bytes used as the block size for encoding or decoding. A sourcepacket may be divisible into a number of sourceblocks. As one non-limiting example, a 1 megabyte sourcepacket of data may be encoded using 512 byte sourceblocks. The number of bits in a sourceblock may be dynamically optimized by the system during operation. In one aspect, a sourceblock may be of the same length as the block size used by a particular file system, typically 512 bytes or 4,096 bytes.

The term “codeword” refers to the reference code form in which data is stored or transmitted in an aspect of the system. A codeword consists of a reference code to a sourceblock in the library plus an indication of that sourceblock's location in a particular data set.

The term “deblocking” as used herein refers to a technique used to reduce or eliminate blocky artifacts that can occur in compressed images or videos. These artifacts are a result of lossy compression algorithms, such as JPEG for images or various video codecs like H.264, H.265 (HEVC), and others, which divide the image or video into blocks and encode them with varying levels of quality. Blocky artifacts, also known as “blocking artifacts,” become visible when the compression ratio is high, or the bitrate is low. These artifacts manifest as noticeable edges or discontinuities between adjacent blocks in the image or video. The result is a visual degradation characterized by visible square or rectangular regions, which can significantly reduce the overall quality and aesthetics of the content. Deblocking techniques are applied during the decoding process to mitigate or remove these artifacts. These techniques typically involve post-processing steps that smooth out the transitions between adjacent blocks, thus improving the overall visual appearance of the image or video. Deblocking filters are commonly used in video codecs to reduce the impact of blocking artifacts on the decoded video frames. A primary goal of deblocking is to enhance the perceptual quality of the compressed content, making it more visually appealing to viewers. It's important to note that deblocking is just one of many post-processing steps applied during the decoding and playback of compressed images and videos to improve their quality.

### Conceptual Architecture

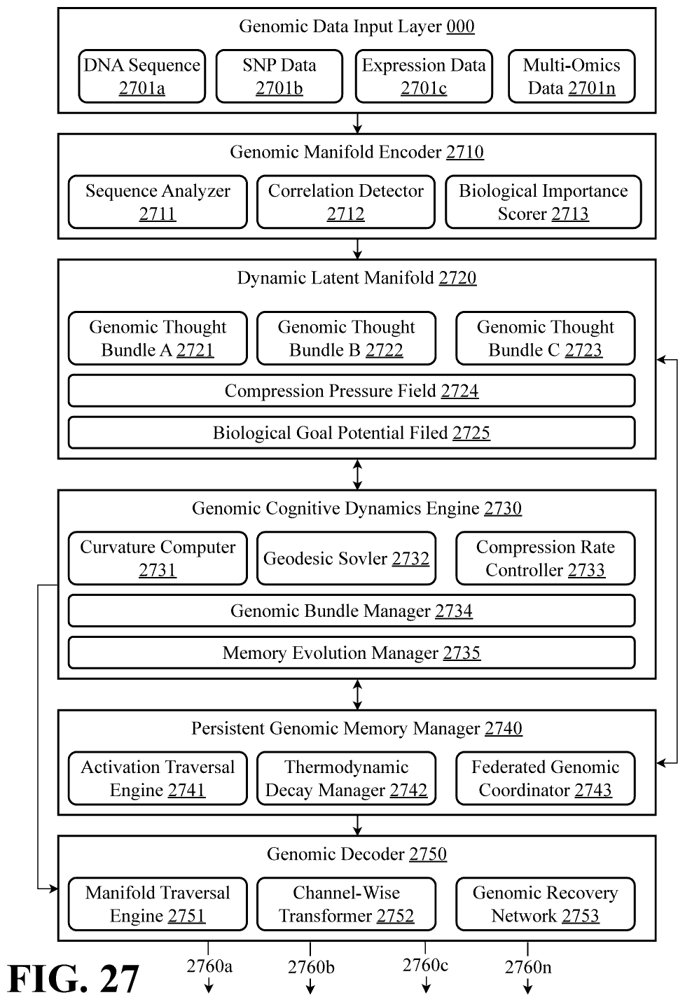

FIG. 27 is a block diagram illustrating an exemplary system architecture for genomic data compression using dynamic latent manifolds according to an embodiment. The system comprises a genomic data input layer that receives multiple types of correlated genomic datasets including, but not limited to, DNA sequences 2701a, SNP data 2701b, expression data 2701c, and multi-omics data 2701n. These heterogeneous but correlated genomic inputs are processed by a genomic manifold encoder 2710 which transforms the raw genomic data into geometric representations suitable for embedding within the dynamic latent manifold. The genomic manifold encoder 2710 comprises one or more specialized subsystems: a sequence analysis component 2711 configured to extract fundamental sequence characteristics including GC content, complexity metrics, and pattern frequencies; a correlation detector 2712 configured to identify and quantify relationships between different genomic datasets including linkage disequilibrium patterns, co-expression relationships, and phylogenetic correlations; and a biological importance scorer 2713 configured to assign significance values to genomic regions based on functional annotations, conservation scores, and clinical relevance markers.

The encoded genomic data is embedded within a dynamic latent manifold 2720 which serves as the central geometric substrate for all cognitive operations related to genomic data processing. Within the manifold, genomic information is organized into thought bundles comprising genomic thought bundle A 2721, genomic thought bundle B 2722, and genomic thought bundle C 2723, each representing coherent submanifolds of semantically and functionally related genomic concepts. The manifold 2720 further comprises a compression pressure field 2724 derived from genomic importance and sequence complexity, which creates regions of varying traversal difficulty based on the biological significance and information density of different genomic regions. A biological goal potential field 2725 generates attractive forces within the manifold based on clinical relevance and research priorities, guiding attention and processing resources toward genomically important regions during compression and recovery operations.

The geometric structure and dynamics of the manifold 2720 are maintained and evolved by a genomic cognitive dynamics engine 2730 which implements specialized algorithms for managing the curved space of genomic knowledge. The engine comprises a curvature computer 2731 configured to calculate Ricci curvature and derived compression pressure fields based on the local density of genomic information and functional relationships. A geodesic solver 2732 computes optimal paths through the genomic manifold for attention traversal and information processing, balancing traversal efficiency with semantic coherence and biological relevance. A compression rate controller 2733 determines region-specific compression parameters based on the computed geodesic costs and biological importance scores, implementing adaptive compression that preserves critical genomic information while maximizing storage efficiency. The engine further comprises a genomic bundle manager 2734 configured to orchestrate the dynamic reorganization of thought bundles through operations including, but not limited to, consolidation of related genomic concepts, expansion of bundles to incorporate new discoveries, and recombination to form higher-order biological abstractions. A memory evolution manager 2735 implements autonomous optimization of the manifold structure during idle periods, performing operations analogous to biological memory consolidation to improve the efficiency and organization of stored genomic knowledge.

Long-term persistence of genomic information is managed by a persistent genomic memory manager 2740 which implements thermodynamic principles for maintaining genomic knowledge across extended time periods. The memory manager comprises an activation energy tracker 2741 configured to monitor the usage and relevance of different genomic structures within the manifold, assigning and updating energy values based on access frequency, biological importance, and contribution to successful reasoning outcomes. A thermodynamic decay manager 2742 implements natural forgetting mechanisms where genomic information with consistently low activation energy undergoes gradual removal from the manifold, ensuring that storage resources are focused on biologically relevant and frequently accessed genomic knowledge. A federated genomic coordinator 2743 enables knowledge sharing across multiple genomic processing instances while maintaining privacy through geometric abstraction, allowing collaborative genomic intelligence while preserving sensitive information through appropriate levels of generalization.

The compressed genomic information is reconstructed through a genomic decoder 2750 which reverses the encoding process to generate enhanced genomic outputs. The decoder may comprise a manifold traversal engine 2751 configured to navigate the geometric structures within the manifold to retrieve relevant genomic information based on query requirements and biological context. A channel-wise transformer 2752 processes the retrieved geometric information using attention mechanisms specifically designed for multi-channel genomic data, capturing both local sequence features and global inter-genomic relationships. A genomic recovery network 2753 implements neural network architectures optimized for reconstructing genomic information from compressed representations, leveraging the correlations between different genomic datasets to recover information that may have been lost during compression. The system generates reconstructed genomic data including, for instance, enhanced DNA sequences 2760a, recovered SNP data 2760b, restored expression data 2760c, and integrated multi-omics data 2760n, with the reconstruction process preserving biological relationships and functional annotations while enabling improved compression ratios compared to conventional genomic compression approaches.

The bidirectional connections between the dynamic latent manifold 2720, the genomic cognitive dynamics engine 2730, and the persistent genomic memory manager 2740 enable continuous learning and adaptation of the geometric substrate based on genomic processing outcomes and biological feedback. This integrated architecture transforms genomic data compression from a purely statistical process into a biologically-informed geometric operation where the structure of the compression space itself reflects evolutionary relationships, functional associations, and clinical relevance, enabling both superior compression performance and enhanced interpretability of genomic information processing outcomes.

Consider an exemplary system operation scenario related to cancer research. The system processes a multi-patient cancer genomics dataset comprising whole genome sequences, tumor-specific mutations, gene expression profiles, and protein abundance data from a longitudinal study of 500 breast cancer patients over a 5-year treatment period.

Raw genomic data enters through the input layer with DNA sequences 2701a containing 3.2 billion base pairs per patient genome, SNP data 2701b identifying 4.3 million variant positions, expression data 2701c measuring RNA levels for 20,000 genes across multiple time points, and multi-omics data 2701n including proteomics and metabolomics measurements. The genomic manifold encoder 2710 begins processing by having the sequence analysis component 2711 compute GC content variations around known oncogenes, identifying regions with complexity scores indicating potential regulatory elements. The correlation detector 2712 discovers strong linkage disequilibrium patterns between BRCA1/BRCA2 mutations and downstream pathway alterations, while simultaneously detecting temporal correlations between chemotherapy treatment timing and expression profile changes. The biological importance scorer 2713 assigns high significance values to tumor suppressor genes, oncogenes, and drug resistance markers based on clinical annotations from cancer genomics databases, with scores ranging from 0.95 for critical therapeutic targets to 0.1 for intergenic regions with no known function.

Within the dynamic latent manifold 2720, the processed genomic data forms distinct organizational structures. Genomic thought bundle A 2721 develops around DNA damage response pathways, creating a high-curvature submanifold where BRCA1, BRCA2, TP53, and ATM genes cluster together with their associated regulatory networks. Genomic thought bundle B 2722 organizes around drug metabolism and resistance mechanisms, incorporating cytochrome P450 variants, ABC transporter expressions, and corresponding protein abundance measurements. Genomic thought bundle C 2723 forms around immune system interactions, clustering HLA typing data, tumor infiltration markers, and immunotherapy response predictors.

The compression pressure field 2724 creates regions of high resistance around these clinically critical bundles, with pressure values reaching P(x)=15.7 in the BRCA pathway region compared to P(x)=2.1 in non-coding intergenic areas. The biological goal potential field 2725 generates strong attractive forces (φ=12.3) around regions associated with treatment response prediction and drug resistance mechanisms, while maintaining moderate attraction (φ=6.8) for prognostic markers and minimal attraction (φ=1.2) for population genetics variants not directly relevant to cancer treatment.

The genomic cognitive dynamics engine 2730 orchestrates the compression process through coordinated geometric operations. The curvature computer 2731 calculates local Ricci curvature, finding R=−8.4 in the dense BRCA pathway region where multiple genes interact functionally, while discovering R=−1.1 in isolated genomic regions with independent markers. The geodesic solver 2732 computes optimal traversal paths, determining that reasoning about drug resistance requires a 47-step geodesic path connecting baseline mutations through metabolic expression changes to treatment outcome data, while prognostic scoring follows a more direct 12-step path through established biomarkers. The compression rate controller 2733 implements adaptive parameters, allocating 98.5% fidelity preservation to BRCA variants and associated regulatory sequences, 85.2% fidelity to expression data for drug resistance markers, 67.8% fidelity to general tumor markers, and 23.1% fidelity to common population variants not associated with cancer risk. The genomic bundle manager 2734 performs consolidation operations, merging initially separate bundles for “chemotherapy response” and “DNA repair efficiency” when discovering they share 73% of their genomic markers, while the memory evolution manager 2735 creates new cross-bundle connections linking immune infiltration patterns with treatment response prediction based on observed correlations across the patient cohort.

The persistent genomic memory manager 2740 maintains long-term knowledge about cancer genomics patterns discovered during processing. The activation energy tracker 2741 monitors usage patterns, finding that BRCA1 variants maintain consistently high energy (E=98.7) due to frequent queries about hereditary cancer risk, while rare population variants drop to low energy levels (E=12.3) when not accessed for extended periods. The thermodynamic decay manager 2742 implements selective forgetting, gradually reducing the precision of benign population variants that haven't contributed to clinical predictions over multiple patient cohorts, while preserving full fidelity for all therapeutically relevant mutations regardless of individual patient frequency. The federated genomic coordinator 2743 shares abstracted findings with other cancer research institutions, transmitting generalized patterns about “platinum-based chemotherapy response signatures” without revealing patient-specific genomic details, enabling collaborative learning while maintaining privacy through geometric abstraction that preserves clinical utility while obscuring individual identity markers.

When researchers query the system for treatment recommendations for a new patient, the genomic decoder 2750 initiates reconstruction. The manifold traversal engine 2751 follows geodesic paths from the patient's BRCA2 variant through the established thought bundles, traversing regions of high curvature around DNA repair mechanisms while avoiding paths through irrelevant population genetics variants. The channel-wise transformer 2752 processes the geometric information using attention mechanisms that weight the patient's specific mutation profile against the learned patterns from the 500-patient training cohort, identifying that this patient's particular BRCA2 variant occurs in a geometric neighborhood associated with favorable platinum-based chemotherapy response. The genomic recovery network 2753 reconstructs detailed predictions by leveraging correlations between the patient's genomic profile and the preserved high-fidelity regions of the manifold, generating treatment recommendations with confidence scores derived from the geometric distance to established response patterns.

The system outputs enhanced DNA sequences 2760a highlighting the specific variants relevant to treatment decisions, recovered SNP data 2760b focusing on the subset of variants that contribute to drug metabolism predictions, restored expression data 2760c providing baseline biomarker levels needed for monitoring treatment response, and integrated multi-omics data 2760n combining genomic, transcriptomic, and proteomic information to generate comprehensive treatment guidance. The final output indicates 87.3% confidence in platinum sensitivity, 23.7% likelihood of developing carboplatin resistance, and recommendations for monitoring specific biomarkers at 3-month intervals, with all predictions traceable back through the geometric reasoning paths that connected the patient's genomic profile to similar cases in the learned manifold structure.

Following successful treatment prediction and subsequent clinical validation, the system updates its geometric structure through memory evolution. Successful treatment responses reinforce the geodesic pathways that led to accurate predictions, increasing local curvature around validated biomarker combinations while creating new thought bundle connections between previously unlinked genomic features and treatment outcomes. Failed predictions trigger geometric reorganization, with the curvature computer 2731 analyzing the reasoning paths that led to incorrect conclusions and the bundle manager 2734 restructuring the relationships between genomic markers and clinical outcomes. Over multiple patient interactions, the manifold develops increasingly sophisticated representations of cancer genomics knowledge, with compression efficiency improving from initial 67% to 89% while maintaining 96% accuracy in treatment response prediction, demonstrating the system's ability to learn and adapt its geometric knowledge representation based on clinical outcomes and genomic discoveries.

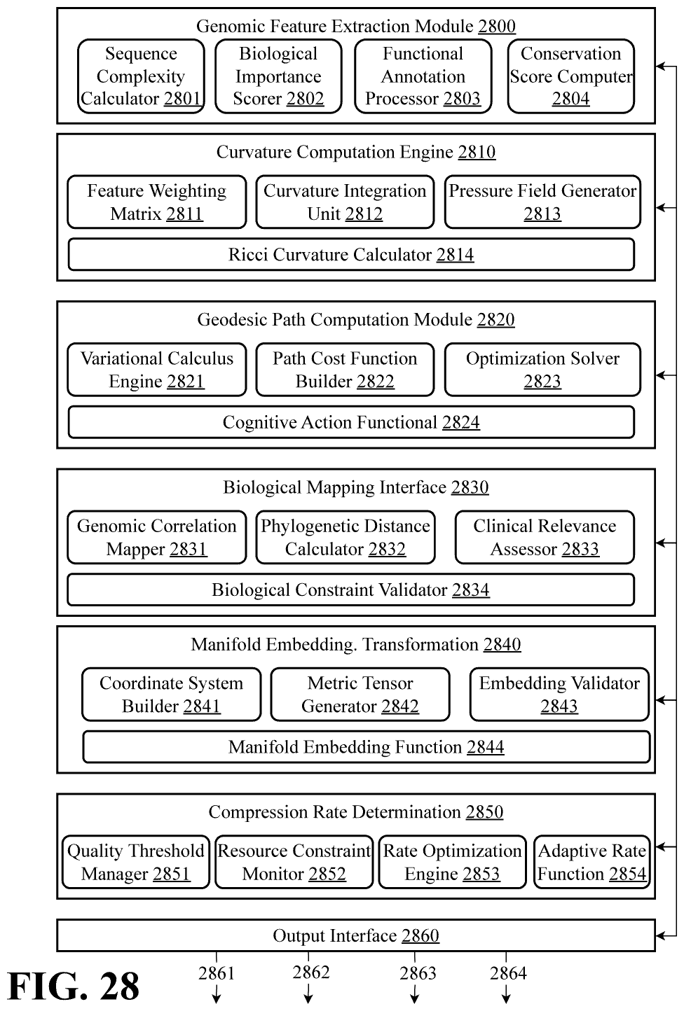

FIG. 28 is a block diagram illustrating an exemplary mathematical framework for genomic manifold operations, which may be implemented as a multi-layer computing stack, and provides a computational foundation for the system architecture shown in FIG. 27. The mathematical framework transforms raw genomic features into geometric representations suitable for processing within the dynamic latent manifold while preserving biological relationships and functional constraints throughout the computational pipeline.

The system can include a genomic feature extraction module 2800 which comprises various specialized computational components that analyze different aspects of genomic data to generate quantitative metrics suitable for geometric processing. A sequence complexity calculator 2801 computes entropy-based measures, repeat pattern frequencies, and information content metrics for DNA sequences, generating complexity scores C_{seq}(x) that reflect the information density and structural organization of genomic regions. A biological importance scorer 2802 analyzes functional annotations, conservation data, and clinical significance markers to generate importance values I_{bio}(x) that quantify the biological relevance of different genomic regions based on known functional roles, disease associations, and evolutionary conservation patterns. A functional annotation processor 2803 integrates data from multiple genomic databases including gene ontology classifications, pathway memberships, and regulatory element annotations to produce functional significance scores F_{func}(x) that capture the known biological roles and regulatory importance of genomic sequences. A conservation score computer 2804 analyzes phylogenetic data across multiple species to generate conservation metrics S_{cons}(x) that reflect evolutionary pressure and functional constraint, with higher scores indicating regions that have been preserved across evolutionary time due to functional importance.

The extracted genomic features are processed by a curvature computation engine 2810 which transforms the biological metrics into geometric curvature values that define the local structure of the genomic manifold. A feature weighting matrix 2811 applies learned coefficients α, β, γ, and δ to balance the relative contributions of different biological features based on their predictive value for compression decisions and clinical outcomes. A curvature integration unit 2812 combines the weighted features using mathematical operations that preserve the biological relationships while generating geometrically valid curvature measures suitable for manifold operations. A pressure field generator 2813 converts the integrated curvature values into compression pressure fields that guide attention flow and processing resource allocation within the manifold. The engine implements a Ricci curvature calculator 2814 that computes local curvature values according to the mathematical relationship R(x)=α·I_{bio}(x)+β·C_{seq}(x)+γ·F_{func}(x)+δ·S_{cons}(x), where the coefficients are learned through training on genomic datasets with known biological ground truth and compression performance outcomes.

A geodesic path computation module 2820 determines optimal traversal paths through the genomic manifold by solving variational optimization problems that balance multiple competing objectives. A variational calculus engine 2821 implements mathematical algorithms for finding paths that minimize the cognitive action functional while respecting the geometric constraints imposed by the manifold structure. A path cost function builder 2822 constructs composite cost measures that incorporate kinetic energy of manifold traversal, compression pressure penalties, goal potential attraction, and biological constraint violations. An optimization solver 2823 employs numerical methods including, but not limited to, gradient descent, simulated annealing, and genetic algorithms to identify geodesic paths that achieve optimal trade-offs between computational efficiency and biological coherence. The module implements a cognitive action functional 2824 defined as S[γ]=∫[∥γ∥²+P(γ(t))−φ(γ(t))+B_{penalty}(γ(t))]dt, where ∥γ∥² represents the kinetic energy of path traversal, P(γ(t)) is the compression pressure encountered along the path, φ(γ(t)) is the goal potential providing attractive forces toward relevant genomic regions, and B_{penalty}(γ(t)) penalizes paths that violate biological constraints or evolutionary relationships.

The mathematical operations can be validated and constrained by a biological mapping interface 2830 which ensures that geometric computations preserve meaningful biological relationships throughout the processing pipeline. A genomic correlation mapper 2831 analyzes linkage disequilibrium patterns, co-expression relationships, and functional pathway memberships to ensure that geometrically close regions in the manifold correspond to biologically related genomic elements. A phylogenetic distance calculator 2832 computes evolutionary distances between genomic sequences and validates that manifold distances reflect evolutionary relationships, ensuring that closely related species or conserved functional elements maintain appropriate geometric proximity. A clinical relevance assessor 2833 evaluates the preservation of known disease associations, drug response relationships, and diagnostic markers throughout the geometric transformations, validating that clinically important relationships are maintained in the compressed representation. A biological constraint validator 2834 monitors the entire computational pipeline to ensure that geometric operations preserve evolutionary constraints, functional relationships, and biological topology, implementing checks that prevent mathematically valid but biologically meaningless transformations.

A manifold embedding transformation 2840 converts the validated geometric representations into coordinate systems suitable for processing within dynamic latent manifold 2720. A coordinate system builder 2841 establishes local coordinate charts that respect the curved geometry while enabling efficient computational operations on genomic data. A metric tensor generator 2842 creates the mathematical structures that define distances, angles, and volumes within the genomic manifold, ensuring that geometric measurements reflect biological significance and functional relationships. An embedding validator 2843 verifies that the coordinate transformations preserve essential biological information while enabling efficient manifold operations including geodesic computation, curvature analysis, and attention flow calculation. The transformation implements a manifold embedding function 2844 which, in some embodiments, may be defined as f: G→M where G represents the high-dimensional genomic feature space and M represents the curved manifold space, with the embedding designed to preserve biological topology while enabling efficient geometric operations.

The mathematical framework concludes with a compression rate determination 2850 that converts the geometric analysis into practical compression parameters for genomic data processing. A quality threshold manager 2851 establishes minimum fidelity requirements for different categories of genomic information based on biological importance, clinical relevance, and research priorities. A resource constraint monitor 2852 tracks available computational and storage resources to ensure that compression decisions remain feasible within system limitations while maintaining biological accuracy requirements. A rate optimization engine 2853 balances quality preservation against compression efficiency using multi-objective optimization techniques that consider both immediate compression gains and long-term system performance. The determination process implements an adaptive rate function 2854 defined as r(x)=fᵣₐₜₑ(R(x), φ(x), Q_{bio}(x), C_{available}), where the compression rate r(x) is determined as a function of local curvature R(x), goal potential φ(x), biological quality requirements Q_{bio}(x), and available computational resources C_{available}.

The mathematical framework outputs may be provided through an output interface 2860 that supplies computational results to the main system components of FIG. 27. Curvature field data 2861 provides the local geometric structure information used by genomic cognitive dynamics engine 2730 to maintain and evolve the manifold geometry. Geodesic path data 2862 supplies optimal traversal routes used by manifold traversal engine 2751 during genomic information retrieval and reconstruction. Compression rate map 2863 provides region-specific compression parameters used by compression rate controller 2733 to implement adaptive genomic data compression. Embedding coordinates 2864 supply the geometric representation of genomic information used by dynamic latent manifold 2720 to organize and process genomic thought bundles.

The mathematical framework of FIG. 28 directly enables and supports the system architecture of FIG. 27 by providing the computational foundation for transforming biological genomic data into geometric representations suitable for processing within the persistent cognitive machine architecture. The curvature computation engine 2810 generates the geometric structure that defines compression pressure field 2724 and influences the formation and organization of genomic thought bundles 2721-2723 within dynamic latent manifold 2720. The geodesic path computation module 2820 provides the mathematical algorithms used by geodesic solver 2732 to determine optimal attention traversal paths through the genomic manifold. The biological mapping interface 2830 ensures that the geometric operations performed by genomic cognitive dynamics engine 2730 preserve the biological relationships that are essential for meaningful genomic analysis and clinical applications. The compression rate determination 2850 supplies the adaptive algorithms used by compression rate controller 2733 to balance quality preservation against storage efficiency while maintaining biological accuracy. This mathematical framework thus transforms the abstract geometric concepts of the persistent cognitive machine into concrete computational procedures specifically optimized for genomic data processing, enabling the practical implementation of biologically-informed geometric compression and recovery of genomic information.

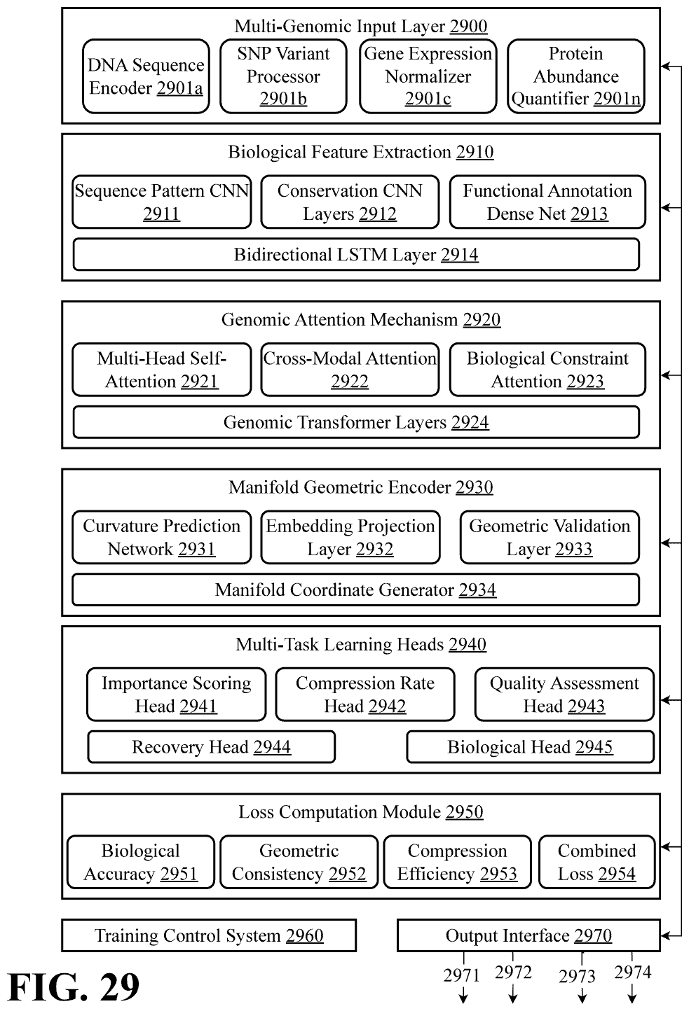

FIG. 29 is a block diagram illustrating an exemplary neural network architecture for genomic processing that enables the transformation of biological genomic data into geometric representations suitable for processing within a persistent cognitive machine system. The neural network architecture implements end-to-end learning that simultaneously optimizes biological accuracy, geometric consistency, and compression efficiency while preserving the functional relationships and evolutionary constraints inherent in genomic data.

The architecture comprises a multi-genomic input layer 2900 that processes heterogeneous genomic datasets through specialized encoding modules tailored to different data modalities. A DNA sequence encoder 2901a converts raw nucleotide sequences into numerical representations using one-hot encoding and k-mer tokenization, handling variable-length sequences and maintaining positional information essential for downstream biological analysis. A SNP variant processor 2901b transforms single nucleotide polymorphism data into structured feature vectors that capture both the genomic position and functional impact of genetic variations, incorporating population frequency data and linkage disequilibrium patterns. A gene expression normalizer 2901c processes RNA sequencing and microarray data using log-transformation and z-score normalization techniques to handle the wide dynamic range typical of expression measurements while preserving relative expression relationships between genes and samples. A protein abundance quantifier 2901n converts mass spectrometry and immunoassay data into standardized abundance measures, accounting for technical variability and batch effects while maintaining the quantitative relationships essential for multi-omics integration.

The encoded genomic data flows into a biological feature extraction module 2910 which employs specialized neural network architectures designed to capture the hierarchical structure and functional organization characteristic of biological systems. A sequence pattern CNN 2911 implements one-dimensional convolutional layers with multiple filter sizes ranging from, for example, 3 to 15 nucleotides to detect local sequence motifs including transcription factor binding sites, splice junctions, and regulatory elements, using techniques adapted from natural language processing but optimized for the four-letter alphabet of genomic sequences. Conservation CNN layers 2912 process cross-species alignment data using convolutional architectures that detect evolutionarily conserved patterns across multiple organisms simultaneously, implementing shared weight structures that capture conservation patterns while allowing for species-specific variations. A functional annotation dense network 2913 processes gene ontology classifications, pathway memberships, and protein domain annotations through fully connected layers that learn complex relationships between functional categories and genomic features. The biological feature extraction culminates in a bidirectional LSTM layer 2914 that captures long-range dependencies and contextual relationships within genomic sequences, with forward and backward processing paths that enable the network to consider both upstream and downstream genomic context when making predictions about individual nucleotides or genomic regions.

The extracted biological features can be processed by a genomic attention mechanism 2920 that implements sophisticated attention patterns specifically designed for multi-scale genomic analysis. A multi-head self-attention module 2921 enables the network to focus on relevant genomic regions regardless of their linear distance in the sequence, using multiple attention heads with different learned attention patterns to capture diverse types of genomic relationships including, but not limited to, regulatory interactions, structural variations, and functional dependencies. Cross-modal attention 2922 coordinates information flow between different genomic data types, enabling the network to leverage correlations between DNA sequence features, gene expression patterns, and protein abundance measurements to make more accurate predictions about genomic importance and compressibility. Biological constraint attention 2923 implements attention mechanisms that respect known biological relationships and evolutionary constraints, using attention weights that are constrained to maintain biologically meaningful relationships such as gene regulatory networks and metabolic pathway structures. The attention mechanisms are organized into genomic transformer layers 2924 that operate at different hierarchical levels: gene-level attention for local sequence patterns and regulatory motifs, pathway-level attention for functional gene groups and biological processes, chromosome-level attention for structural features and large-scale genomic organization, and genome-level attention for global relationships including inter-chromosomal interactions and population-level genetic variations.

The attended genomic features may be transformed into geometric representations by a manifold geometric encoder 2930 that bridges the biological and geometric domains while preserving essential relationships. A curvature prediction network 2931 uses the biological features to predict local curvature values for the genomic manifold, implementing dense layers with residual connections that learn the mapping between biological importance, functional significance, and geometric curvature in the latent space. An embedding projection layer 2932 transforms the high-dimensional biological feature vectors into coordinates suitable for the curved manifold space, using learned linear transformations followed by nonlinear activation functions that respect the geometric constraints of the target manifold. A geometric validation layer 2933 ensures that the generated manifold coordinates satisfy mathematical constraints including smoothness, continuity, and curvature bounds while maintaining biological interpretability. The geometric encoding process culminates in a manifold coordinate generator 2934 that implements a sequence of dense layers with tanh activation functions followed by a geometric constraint layer, ensuring that the output coordinates correspond to valid points within the curved manifold space while preserving the biological relationships encoded in the input data.

The geometric representations are processed by multi-task learning heads 2940 that simultaneously optimize multiple objectives relevant to genomic data compression and analysis. An importance scoring head 2941 predicts biological importance scores for genomic regions using dense layers with sigmoid activation, generating probability values that reflect the clinical relevance, functional significance, and evolutionary conservation of different genomic elements. A compression rate prediction head 2942 determines optimal compression parameters for each genomic region based on the learned geometric and biological features, using regression layers that balance compression efficiency against information preservation requirements. A quality assessment head 2943 predicts the expected reconstruction quality achievable with different compression levels, enabling the system to make informed trade-offs between storage requirements and biological accuracy. A recovery prediction head 2944 estimates the effectiveness of the neural recovery network for different types of genomic information, using this information to guide compression decisions and ensure that critical biological information can be accurately reconstructed. A biological constraint head 2945 monitors the preservation of known biological relationships throughout the compression and recovery process, implementing classification layers that detect potential violations of evolutionary constraints, functional dependencies, or clinical associations.

The multi-task predictions are evaluated using a loss computation module 2950 that implements sophisticated loss functions designed to balance competing objectives while maintaining biological validity. A biological accuracy loss 2951 measures the preservation of known functional relationships, clinical associations, and evolutionary patterns using specialized distance metrics that account for the hierarchical structure of biological knowledge. A geometric consistency loss 2952 ensures that the learned manifold embeddings satisfy mathematical constraints while preserving biological topology, using metrics derived from differential geometry to validate curvature properties and geodesic distances. A compression efficiency loss 2953 optimizes the trade-off between storage requirements and reconstruction quality, using rate-distortion theory adapted for the specific characteristics of genomic data. The module implements a combined loss function 2954 which may defined, in some embodiments, as Lₜₒₜₐₗ=α·L_{bio}+β·L_{geo}+γ·L_{comp}+δ·L_{recovery}+ε·L_{constraint}+ζ·L_{manifold} (and variants thereof), where the coefficients α, β, γ, δ, ε, and ζ are learned or manually tuned to balance the different optimization objectives based on the specific requirements of the genomic application and the available computational resources.

Training of the neural network can be managed by a training control system 2960 that implements advanced optimization techniques adapted for the complexity and scale of genomic data processing. An adaptive learning rate controller monitors training progress and adjusts learning rates for different components of the network based on convergence patterns and gradient magnitudes, using techniques including cyclical learning rates and warm restarts to handle the non-convex optimization landscape typical of deep neural networks applied to biological data. A gradient clipping engine prevents gradient explosion and ensures stable training by monitoring and limiting gradient magnitudes across all network parameters, with clipping thresholds adapted to the different scales and sensitivities of the various network components. A learning rate scheduler implements sophisticated scheduling policies including cosine annealing and polynomial decay that are coordinated with validation performance to ensure optimal convergence while preventing overfitting to the training data. A validation monitor tracks performance metrics on held-out genomic datasets to detect overfitting and guide early stopping decisions, using biological validation metrics that ensure the network maintains biological interpretability rather than simply optimizing mathematical loss functions. A model checkpoint manager maintains versioned snapshots of the network parameters during training, enabling recovery from training failures and facilitating the deployment of models at different points in the optimization process.

The trained neural network produces outputs through an output interface 2970 that provides the geometric and biological information required by the broader genomic compression system. Manifold embeddings 2971 supply the coordinate representations of genomic data within the curved latent space, formatted for direct integration with dynamic latent manifold 2720. Importance scores 2972 provide the biological significance values used by compression rate controller 2733 to implement adaptive compression that preserves critical genomic information while maximizing storage efficiency. Compression parameters 2973 supply region-specific compression settings optimized for the biological characteristics and geometric properties of different genomic elements. Recovery weights 2974 provide the neural network parameters required by genomic recovery network 2753 to implement accurate reconstruction of compressed genomic data.

The neural network architecture of FIG. 29 directly enables and supports the genomic processing capabilities of the system shown in FIG. 27 by providing the learned representations and predictive models essential for geometric genomic data processing. The biological feature extraction module 2910 generates the complex feature representations that inform biological importance scorer 2713 in genomic manifold encoder 2710. The genomic attention mechanism 2920 provides the sophisticated attention patterns used by channel-wise transformer 2752 in genomic decoder 2750 to capture complex relationships between different genomic data modalities. The manifold geometric encoder 2930 supplies the mathematical transformations that enable dynamic latent manifold 2720 to represent genomic information as geometric structures while preserving biological meaning and evolutionary relationships. The multi-task learning heads 2940 generate the diverse predictions required by multiple components of FIG. 27, including importance scores for compression pressure field 2724, geometric parameters for genomic cognitive dynamics engine 2730, and recovery guidance for persistent genomic memory manager 2740. This exemplary neural network architecture thus provides the intelligent processing capabilities that enable the persistent cognitive machine framework to handle the unique challenges and requirements of genomic data compression while maintaining the biological validity and clinical utility essential for practical genomic applications.

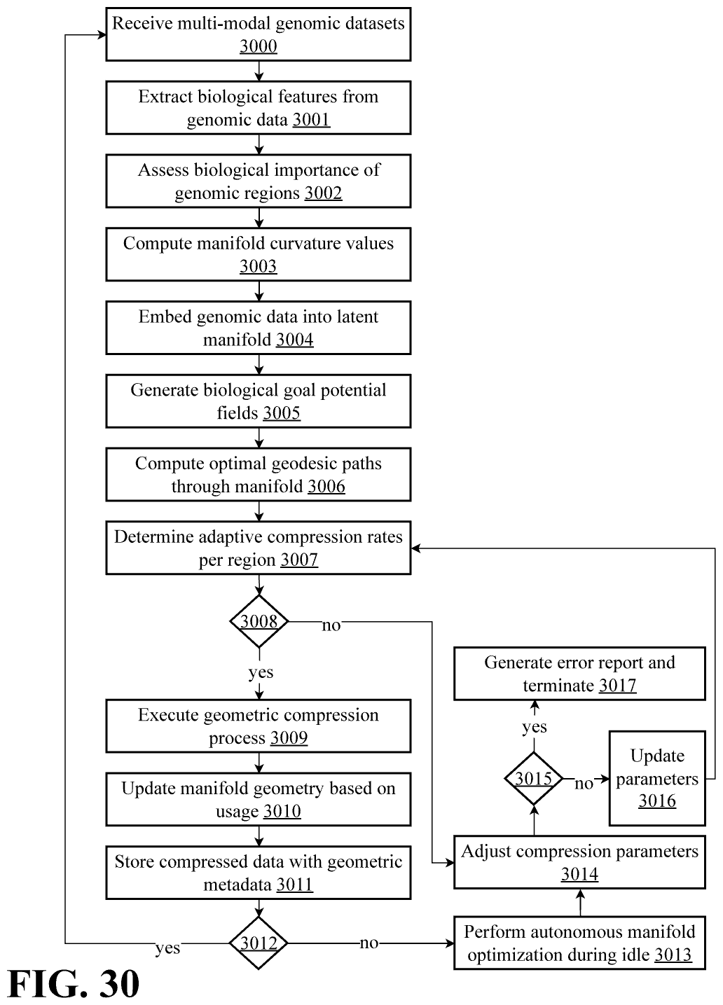

FIG. 30 is a flow diagram illustrating an exemplary method for genomic data compression using dynamic latent manifolds that implements the core processing pipeline of the system architecture for geometric compression of genomic data, according to an embodiment. The method transforms biological genomic data into geometric representations within a curved manifold space, applies adaptive compression based on biological importance and geometric properties, and maintains the manifold structure through continuous learning and optimization.

According to the embodiment, the process begins at step 3000 by receiving multi-modal genomic datasets comprising heterogeneous but correlated genomic information including DNA sequences with nucleotide-level resolution, SNP data identifying genetic variants and their population frequencies, expression profiles measuring RNA and protein abundance across multiple conditions, and additional genomic data types such as epigenetic modifications, structural variants, and clinical annotations. The system validates data integrity through format compatibility checks, missing data analysis, and biological consistency validation, while organizing the datasets into processing batches that preserve temporal relationships, maintain cross-modal correlations, and enable efficient parallel processing of related genomic elements.

At step 3001, the method extracts biological features from the received genomic data using sophisticated computational approaches specifically designed for multi-modal genomic analysis. Sequence complexity metrics are computed using entropy-based measures, k-mer frequency analysis, and repeat pattern detection to quantify the information content and structural organization of DNA sequences. Conservation scores are analyzed across multiple species through phylogenetic alignment algorithms that identify evolutionarily conserved regions indicating functional importance and selective pressure. Functional annotations may be extracted from curated genomic databases including gene ontology classifications, pathway memberships, regulatory element annotations, and disease association records. Correlation matrices are generated between different data modalities to identify relationships such as expression quantitative trait loci linking genetic variants to gene expression changes, co-expression networks revealing functional gene modules, and multi-omics associations connecting genomic features across different biological measurement scales.

The method proceeds to step 3002 where biological importance assessment is performed for each genomic region using trained neural networks that have learned to recognize patterns associated with functional significance, clinical relevance, and evolutionary constraint. The neural network importance scorer integrates multiple evidence sources including conservation patterns across species, functional annotation confidence scores, disease association strength from genome-wide association studies, and clinical utility metrics from medical genomics databases. Evolutionary conservation data is weighted based on the phylogenetic distance and functional similarity of the compared species, with higher weights assigned to conservation patterns that span diverse evolutionary lineages. The assessment generates importance probability scores ranging from 0 to 1 for each genomic region, where values approaching 1 indicate critical biological elements such as essential genes, regulatory elements controlling development, and pharmacogenomic variants affecting drug response.

At step 3003, manifold curvature values are computed using the biological features and importance scores through a mathematical transformation that maps biological significance to geometric properties. The curvature computation implements the formula R(x)=α·I_{bio}(x)+β·C_{seq}(x)+γ·F_{func}(x)+8. S_{cons}(x), where the coefficients α, β, γ, and δ are learned parameters that weight the relative contributions of biological importance I_{bio}(x), sequence complexity C_{seq}(x), functional annotation scores F_{func}(x), and conservation scores S_{cons}(x). The compression pressure field is generated according to P(x)=−R(x), creating regions of high pressure around biologically important elements that resist aggressive compression and low pressure regions around less critical sequences that can accommodate higher compression ratios. Geometric consistency validation ensures that the computed curvature values satisfy mathematical constraints for a valid Riemannian manifold while biological constraint validation confirms that the geometric properties preserve known functional relationships and evolutionary patterns.

The method continues to step 3004 where genomic data is embedded into the latent manifold through geometric transformation algorithms that preserve biological relationships while enabling efficient manifold operations. Biological features are transformed to manifold coordinates using the embedding function f: G→M that maps from the high-dimensional genomic feature space G to the curved manifold space M while preserving essential topological relationships. Genomic thought bundles are formed by clustering related sequences based on functional similarity, co-expression patterns, pathway membership, and evolutionary relationships, creating compact submanifolds that represent coherent biological concepts. Geodesic connections are established between functional elements such as genes and their regulatory sequences, pathway components and their interaction partners, and disease-associated variants and their phenotypic targets, creating a network of minimal-energy paths that reflect biological causality and functional dependency.

At step 3005, biological goal potential fields are generated to create attractive forces within the manifold that guide compression decisions and attention allocation toward genomically important regions. Attraction fields are created based on clinical priorities including therapeutic target genes, diagnostic biomarkers, pharmacogenomic variants, and disease susceptibility loci, with field strength proportional to clinical utility and medical relevance. Research objectives and therapeutic targets are weighted according to current scientific interest, funding priorities, and translational potential, creating dynamic potential landscapes that adapt to evolving research needs. Gradient flows are established toward high-value genomic regions, creating directional forces that attract processing resources and attention toward areas of maximum biological and clinical significance. Multiple competing objectives are balanced through field composition techniques that create complex potential landscapes with multiple attractors, enabling the system to simultaneously optimize for diverse biological and clinical requirements.

The method proceeds to step 3006 where optimal geodesic paths through the manifold are computed by solving the cognitive action functional that balances multiple competing objectives while respecting the geometric structure of the manifold. The variational optimization problem minimizes the action functional S[γ]=∫[∥γ∥²+P(γ(t))−φ(γ(t))+B_{penalty}(γ(t))]dt, where ∥γ∥² represents the kinetic energy of manifold traversal, P(γ(t)) is the compression pressure that penalizes paths through high-importance regions, φ(γ(t)) is the goal potential that attracts paths toward clinically relevant areas, and B_{penalty}(γ(t)) penalizes paths that violate known biological relationships or evolutionary constraints. Minimal-energy traversal routes are identified between genomic concepts using numerical optimization techniques including gradient descent on manifolds, simulated annealing for global optimization, and genetic algorithms for multi-objective path finding. Path validation ensures that computed geodesics preserve biological relationships by verifying that traversal routes respect known functional dependencies, maintain evolutionary coherence, and preserve clinical associations.

At step 3007, adaptive compression rates are determined for each genomic region based on the computed geometric properties, biological importance scores, and available computational resources. In some embodiments, region-specific compression rates may be calculated using the function r(x)=fᵣₐₜₑ(R(x), φ(x), Q_{bio}(x), C_{available}), where the compression rate r(x) depends on local curvature R(x) indicating biological importance, goal potential φ(x) reflecting clinical relevance, biological quality requirements Q_{bio}(x) specifying minimum fidelity thresholds, and available computational resources C_{available} constraining processing capabilities. High fidelity preservation is allocated to critical genomic elements including disease-associated variants, therapeutic target genes, essential regulatory sequences, and pharmacogenomic markers, ensuring that medically relevant information is preserved with minimal loss. Aggressive compression is applied to low-importance regions including intergenic sequences with no known function, common population variants not associated with disease, and repetitive elements that provide limited biological information. Compression decisions are validated against quality thresholds that ensure biological accuracy requirements are met while achieving optimal storage efficiency.

The method includes a quality control decision point 3008 where compression parameters are evaluated against biological and technical quality thresholds to ensure that the proposed compression strategy will preserve essential genomic information while achieving acceptable efficiency gains. If quality thresholds are not met, the method branches to an adjustment loop beginning at step 3014 where compression parameters are systematically modified to improve quality while maintaining efficiency. If quality requirements are satisfied, the method proceeds to step 3009 where geometric compression is executed according to the determined parameters.

At step 3009, the geometric compression process is executed by applying the computed compression rates to genomic data regions while preserving the manifold structure and biological relationships essential for accurate reconstruction. Compression rates are applied to genomic data regions using algorithms that respect the geometric constraints of the manifold while maintaining biological coherence across different compression levels. Manifold coordinate information is preserved for reconstruction purposes, enabling the recovery system to navigate the geometric structure during decompression and accurately restore the original genomic relationships. Compression metadata is generated with biological annotations that document the compression decisions, quality trade-offs, and biological constraints that guided the process, providing essential information for reconstruction algorithms and biological interpretation. Geodesic path information is maintained for recovery guidance, enabling the reconstruction process to follow optimal paths through the manifold that preserve biological meaning and functional relationships.

The method continues to step 3010 where manifold geometry is updated based on usage patterns and compression outcomes to improve future processing efficiency and biological accuracy. Frequently traversed geodesic connections are strengthened through metric adjustments that reduce the energy required for common reasoning paths, creating preferential routes through the manifold that correspond to important biological relationships. Curvature is adjusted based on compression success patterns, with regions that consistently achieve high-quality compression developing modified geometric properties that facilitate future processing. Thought bundle boundaries and internal organization evolve through unsupervised learning algorithms that optimize the clustering of genomic elements based on observed functional relationships and compression performance. Thermodynamic decay is applied to unused genomic patterns, gradually reducing the influence of genomic features that do not contribute to successful compression or biological understanding.

At step 3011, compressed data is stored with geometric metadata that preserves the information necessary for accurate reconstruction while maintaining the biological context essential for genomic analysis. Compressed genomic data is archived together with manifold coordinates that specify the geometric location of each genomic element within the curved space, enabling precise reconstruction of both sequence information and biological relationships. Biological relationship preservation records document which functional dependencies, evolutionary constraints, and clinical associations have been maintained during compression, providing validation information for downstream analysis. Recovery parameters and attention guidance information are stored to direct the reconstruction process toward optimal paths through the manifold that preserve biological meaning and functional coherence. Compression performance metrics and quality reports are generated to document the achieved efficiency gains, biological accuracy preservation, and system resource utilization for process optimization and validation purposes.

The method includes a decision point 3012 to determine whether additional genomic data requires processing, enabling batch processing of large genomic datasets while maintaining consistency across processing runs. If additional data is present, the method returns to the beginning of the processing pipeline to handle the next batch of genomic information. If no additional data remains, the method proceeds to autonomous optimization procedures.

At step 3013, autonomous manifold optimization is performed during idle periods to improve the geometric structure and processing efficiency through unsupervised learning and reorganization processes analogous to biological memory consolidation. Dreaming operations execute geometric reorganization algorithms that test the stability of existing thought bundles, explore potential new connections between genomic elements, and optimize the overall manifold topology for improved compression and reconstruction performance. Related genomic thought bundles are consolidated when analysis reveals significant functional overlap, evolutionary relationships, or compression synergies that justify combining previously separate conceptual clusters. New biological relationship patterns are discovered through analysis of successful compression and reconstruction outcomes, leading to the formation of new geodesic connections and thought bundle associations that reflect emergent understanding of genomic organization. Manifold topology optimization algorithms improve compression efficiency by restructuring the geometric space to minimize the energy required for common operations while preserving the biological relationships essential for accurate genomic analysis.

The method includes an adjustment loop beginning at step 3014 that is executed when quality thresholds are not met during the compression process, implementing systematic parameter optimization to achieve acceptable biological accuracy while maintaining compression efficiency. Quality threshold failure causes are analyzed through detailed examination of the biological features, geometric properties, and compression outcomes that led to inadequate performance, enabling targeted adjustments that address specific deficiencies. Importance weighting coefficients α, β, γ, and δ in the curvature computation are modified based on the analysis results, adjusting the relative influence of different biological factors to improve compression decisions. Curvature computation parameters are adjusted to modify the geometric structure of the manifold in ways that better reflect biological importance and improve compression performance. Neural network prediction confidence is recalibrated through retraining or parameter adjustment procedures that improve the accuracy of biological importance assessment and geometric property prediction.

At decision point 3015, the method evaluates whether maximum iterations have been reached in the parameter adjustment process, preventing infinite loops while allowing sufficient optimization attempts to achieve acceptable quality. If maximum iterations have not been reached, the method returns to step 3016 where updated parameters are applied by returning to step 3007 to recompute compression rates with the adjusted settings. If maximum iterations have been reached without achieving acceptable quality, the method proceeds to step 3017 where error reporting and termination procedures document the failure and preserve partial results for analysis.

At step 3017, comprehensive error reporting and graceful termination procedures document compression failures while preserving valuable information for system improvement and debugging. Compression failure causes are documented through detailed logging of the biological features, geometric properties, compression parameters, and quality metrics that led to inadequate performance, enabling systematic analysis and improvement of future processing. Partial results are preserved for debugging purposes, maintaining intermediate calculations, geometric transformations, and biological assessments that can inform system optimization and parameter tuning. Recommendations for parameter adjustment are generated based on the failure analysis, providing specific guidance for modifying importance weighting, curvature computation, neural network training, or quality thresholds to improve future performance. Biological constraint violations are logged for analysis, documenting cases where the compression process failed to preserve essential functional relationships, evolutionary patterns, or clinical associations, enabling targeted improvements to the biological validation and constraint enforcement mechanisms.

The method integrates sophisticated biological analysis with advanced geometric processing to achieve superior compression performance while preserving the functional relationships and clinical utility essential for genomic applications. Through adaptive parameter adjustment, continuous learning, and biological constraint enforcement, the method ensures that the compression process evolves to meet the changing requirements of genomic research and clinical applications while maintaining the highest standards of biological accuracy and scientific validity.

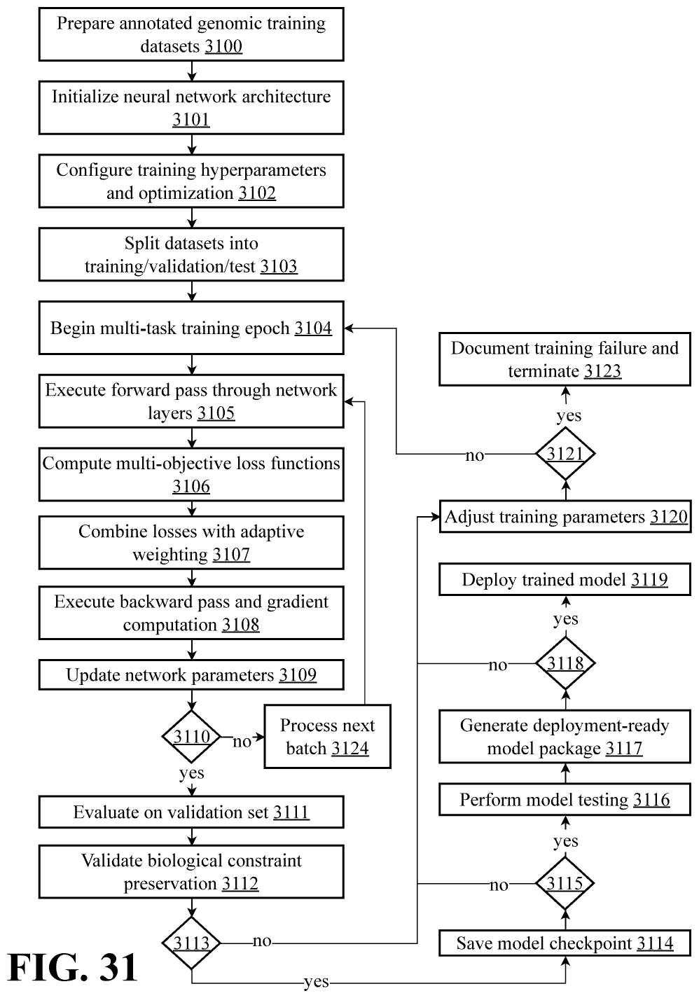

FIG. 31 is a flow diagram illustrating an exemplary method for training a genomic neural network architecture that provides the computational foundation for the system shown in FIG. 27 and implements the network structure detailed in FIG. 29. The training method employs multi-task learning approaches specifically designed for genomic data processing while ensuring biological validity and geometric consistency throughout the optimization process.

According to the embodiment, the process begins at step 3100 by preparing annotated genomic training datasets that provide the biological ground truth necessary for supervised learning of genomic importance, functional relationships, and compression quality trade-offs. Multi-modal genomic data may be collected from diverse sources including, but not limited to, whole genome sequences with known functional annotations, expression datasets with validated biological interpretations, SNP data with established disease associations, and protein abundance measurements with confirmed functional roles. Functional annotations and clinical significance labels are curated from authoritative genomic databases including gene ontology classifications, pathway membership databases, disease association repositories, and clinical variant interpretation guidelines, ensuring that the training targets reflect established biological knowledge and medical relevance. Cross-species conservation data can be validated through phylogenetic analysis that confirms evolutionary relationships, functional constraint patterns, and selection pressure indicators across multiple organisms to provide training signals that capture the evolutionary importance of different genomic regions. Quality-labeled compression and reconstruction pairs are generated by applying various compression algorithms to genomic datasets and evaluating the biological accuracy of reconstructed data, creating training examples that teach the network to predict compression outcomes while preserving functional relationships.

At step 3101, the neural network architecture is initialized according to, for example, the design specifications outlined in FIG. 29, with careful attention to the multi-modal nature of genomic data and the geometric requirements of manifold processing. Multi-modal input encoders are configured for different genomic data types including sequence encoders optimized for nucleotide patterns, variant processors designed for SNP and structural variation data, expression normalizers adapted for the dynamic range of transcriptomic measurements, and protein quantifiers calibrated for mass spectrometry and immunoassay data. Biological feature extraction layers are initialized with random weights using techniques such as Xavier initialization or He initialization adapted for the specific activation functions and layer types employed in genomic processing, with special consideration for the hierarchical nature of biological feature extraction from local motifs to global genomic organization. Hierarchical transformer attention mechanisms can be set up with multiple attention heads operating at different genomic scales, from gene-level attention for local sequence patterns to genome-level attention for chromosomal and population-level relationships, with attention parameters initialized to encourage exploration of diverse biological relationships during early training phases. Multi-task learning heads are configured for the diverse objectives required in genomic processing, including importance scoring, compression rate prediction, quality assessment, recovery optimization, and biological constraint validation, with each head initialized to produce reasonable default predictions before training optimization.

The method continues to step 3102 where training hyperparameters and optimization settings are configured based on the specific characteristics of genomic data and the computational requirements of the multi-task learning architecture. Initial learning rates are set for different network components using adaptive strategies that account for the varying scales and sensitivities of genomic features, with typically higher learning rates for feature extraction layers that must learn diverse biological patterns and lower learning rates for attention mechanisms that require stable convergence to capture long-range genomic relationships. Batch sizes are configured based on genomic data characteristics including sequence length distributions, memory requirements for processing large genomic regions, and the need to maintain biological diversity within each training batch while ensuring computational efficiency. Loss function weighting coefficients are initialized to balance the competing objectives of biological accuracy, geometric consistency, compression efficiency, and constraint preservation, with initial weights typically favoring biological accuracy during early training phases before gradually increasing emphasis on compression performance and geometric properties. Gradient clipping and regularization parameters are set up to prevent training instability in the complex multi-task architecture, with gradient clipping thresholds adapted to the typical magnitude of gradients in genomic neural networks and regularization strength calibrated to prevent overfitting while maintaining the network's capacity to learn complex biological patterns.

At step 3103, datasets are split into training, validation, and test sets using stratification strategies specifically designed to maintain biological diversity and prevent data leakage that could compromise the evaluation of genomic processing performance. Biological diversity is maintained across sets by ensuring balanced representation of different chromosomes, genomic regions, functional categories, and species to prevent the network from learning dataset-specific artifacts rather than generalizable biological patterns. Genomic coverage balance is maintained across chromosomes and species by stratifying splits based on genomic coordinate distributions, ensuring that each split contains representative samples from all major genomic regions and evolutionary lineages included in the dataset. Temporal relationships in longitudinal datasets are preserved by maintaining the time-series structure within individual splits while preventing temporal leakage between training and evaluation sets, enabling the network to learn temporal dynamics while ensuring valid performance assessment. Data leakage validation is performed through comprehensive analysis of sequence similarities, patient relationships, and temporal dependencies between splits to ensure that evaluation metrics reflect true generalization performance rather than memorization of training examples.

The method proceeds to step 3104 where multi-task training epochs begin with careful management of the diverse data types and learning objectives inherent in genomic processing. Training batches of genomic data are loaded together with their corresponding ground truth labels, annotations, and quality metrics, with batch composition designed to maintain biological diversity while ensuring computational efficiency and stable gradient estimation. Data augmentation techniques are applied while preserving biological relationships, including sequence perturbations that maintain functional motifs, expression noise addition that preserves relative abundance patterns, and temporal jittering in longitudinal data that maintains causal relationships. Gradient accumulation is initialized for large genomic sequences that exceed available memory capacity, enabling the processing of complete chromosomal regions or large gene sets through accumulation techniques that maintain the mathematical equivalence of large batch training. Epoch-level performance tracking metrics are reset to monitor training progress across the diverse objectives of genomic processing, including biological accuracy measures, geometric consistency indicators, compression performance metrics, and constraint violation tracking.

At step 3105, forward passes are executed through the network layers according to the exemplary architecture specified in FIG. 29, processing genomic inputs through the hierarchical feature extraction and attention mechanisms while generating predictions for all multi-task learning objectives. Genomic inputs are processed through biological feature extraction layers that identify sequence patterns, conservation signals, functional annotations, and cross-modal correlations using the convolutional and recurrent architectures optimized for genomic data characteristics. Hierarchical attention mechanisms are applied across multiple genomic scales, with gene-level attention focusing on local regulatory elements and splice sites, pathway-level attention capturing functional gene modules and metabolic networks, chromosome-level attention identifying structural features and linkage patterns, and genome-level attention recognizing population genetics patterns and evolutionary relationships. Manifold embeddings and geometric coordinate predictions are generated through the geometric encoding layers that transform biological features into representations suitable for the curved manifold space, ensuring that the geometric properties reflect biological importance and functional relationships. Predictions are computed from all multi-task learning heads including biological importance scores, optimal compression rates, expected reconstruction quality, recovery network parameters, and biological constraint satisfaction indicators.

The method continues to step 3106 where multi-objective loss functions are computed to evaluate the network's performance across all training objectives while maintaining focus on biological accuracy and constraint preservation. Biological accuracy loss is calculated for functional predictions by comparing network outputs to validated biological ground truth using metrics that account for the hierarchical structure of biological knowledge and the varying confidence levels of different types of biological annotations. Geometric consistency loss is computed for manifold coordinates by evaluating whether the predicted embeddings satisfy the mathematical constraints of the curved manifold space while preserving the topological relationships that reflect biological function and evolutionary history. Compression efficiency loss is evaluated for rate predictions by comparing predicted optimal compression rates to empirically determined rates that achieve specified quality thresholds on validation datasets, encouraging the network to learn compression strategies that balance storage efficiency with biological accuracy. Biological constraint preservation is assessed across all outputs by evaluating whether the network predictions maintain known functional relationships, evolutionary patterns, clinical associations, and cross-modal correlations that are essential for biological interpretability and clinical utility.

At step 3107, the individual loss components are combined using adaptive weighting schemes that balance the competing objectives while ensuring that biological accuracy remains the primary optimization target throughout training. The combined loss function Lₜₒₜₐₗ=α·L_{bio}+β·L_{geo}+γ·L_{comp}+δ·L_{recovery}+ε·L_{constraint}+ζ·L_{manifold} incorporates weighting coefficients that are adjusted dynamically based on training progress, with initial emphasis on biological accuracy and constraint preservation gradually expanding to include geometric consistency and compression performance as the network develops stable biological representations. Weighting coefficients are adjusted based on training progress using adaptive algorithms that monitor the relative convergence rates of different objectives, increasing emphasis on objectives that are lagging behind their target performance levels while maintaining minimum weights for critical biological accuracy components. Combined loss validation ensures that the weighted combination maintains biological interpretability by verifying that optimization progress preserves the known biological relationships and functional constraints that are essential for genomic analysis applications.

The method proceeds to step 3108 where backward passes and gradient computation are executed with special attention to the challenges of training large-scale genomic neural networks with multiple competing objectives. Gradients are computed for all network parameters using automatic differentiation techniques adapted for the complex architecture that includes attention mechanisms, geometric transformations, and multi-task outputs, with careful management of computational graphs that can become very large when processing extended genomic sequences. Gradient clipping is applied to prevent gradient explosion in the large networks typical of genomic processing, with clipping thresholds dynamically adjusted based on the observed gradient magnitude distributions and the convergence characteristics of different network components. Gradient magnitudes are monitored for vanishing gradient problems that can occur in deep networks processing long genomic sequences, with diagnostic procedures that identify problematic layers and suggest architectural modifications or training procedure adjustments when gradient flow becomes inadequate. Gradient validation ensures that computed gradients preserve biological constraint satisfaction by verifying that parameter updates do not systematically violate known biological relationships or geometric requirements.

At step 3109, network parameters are updated using optimization algorithms specifically adapted for the characteristics of genomic neural networks and the multi-task learning objectives. Optimizer steps are applied using algorithms such as Adam, SGD with momentum, or adaptive variants like AdaGrad or RMSprop, with optimizer selection and hyperparameter tuning based on the convergence characteristics observed in genomic training data and the stability requirements of multi-task optimization. Learning rates are updated according to scheduling policies that account for the different convergence rates of biological feature learning, attention mechanism optimization, and geometric transformation training, with common approaches including cosine annealing, polynomial decay, or adaptive scheduling based on validation performance plateaus. Weight decay and regularization constraints are applied to prevent overfitting while maintaining the network's capacity to learn complex biological patterns, with regularization strength adapted to the amount of available training data and the complexity of the biological relationships being learned. Parameter update magnitudes are logged for convergence monitoring, enabling early detection of training problems such as parameter instability, gradient explosion, or convergence to poor local minima.

The method includes a decision point 3110 to determine whether the current training batch is complete, enabling efficient batch processing while maintaining the computational efficiency required for large-scale genomic data processing. If additional data remains in the current batch, the method returns to step 3124 to process the next training batch, continuing the forward and backward pass cycle while maintaining gradient accumulation and parameter update procedures. If the batch is complete, the method proceeds to validation evaluation to assess training progress.

At step 3111, the trained network is evaluated on validation sets to assess generalization performance and training progress across all learning objectives while ensuring that biological accuracy is maintained throughout the optimization process. Validation genomic data is processed through the trained network using the same forward pass procedures employed during training but without gradient computation or parameter updates, enabling assessment of generalization performance on data not used for parameter optimization. Biological accuracy metrics are computed on held-out sequences by comparing network predictions to validated biological ground truth, using metrics such as precision, recall, and F1 scores for categorical predictions, correlation coefficients for continuous predictions, and specialized biological metrics such as pathway enrichment analysis and functional annotation consistency. Geometric consistency is assessed for manifold embedding quality by evaluating whether the predicted coordinates satisfy manifold constraints, preserve biological relationships, and enable accurate reconstruction of genomic information through the geometric processing pipeline. Compression performance is evaluated against ground truth compression ratios achieved by optimal compression algorithms on the validation datasets, ensuring that the network learns to predict compression strategies that achieve specified quality targets while maximizing storage efficiency.

The method continues to step 3112 where biological constraint preservation is validated to ensure that the training process maintains the functional relationships and evolutionary patterns essential for biological interpretability. Known functional relationships are checked by verifying that the network predictions preserve established gene regulatory networks, protein-protein interactions, metabolic pathway structures, and other documented biological interactions that are critical for understanding genomic function. Evolutionary phylogenetic patterns are verified by confirming that the network outputs maintain conservation relationships, speciation patterns, and evolutionary distance metrics that reflect established phylogenetic knowledge and evolutionary constraints. Clinical association maintenance is validated by ensuring that network predictions preserve established relationships between genomic variants and disease phenotypes, drug responses, and other clinically relevant outcomes that are essential for medical genomics applications. Cross-modal correlation preservation is assessed by verifying that the network maintains established relationships between different types of genomic measurements such as the correlations between gene expression and protein abundance, between genetic variants and expression quantitative trait loci, and between epigenetic modifications and gene regulation.

At decision point 3113, the method evaluates whether validation performance has improved compared to previous training iterations, implementing early stopping and model selection strategies that prevent overfitting while ensuring optimal generalization performance. If validation performance has improved, the method proceeds to save model checkpoints and continue training optimization. If validation performance has not improved or has degraded, the method branches to parameter adjustment procedures to address potential overfitting, inadequate optimization, or architectural limitations that are preventing effective learning.

When validation performance improves, the method proceeds to step 3114 where model checkpoints are saved to preserve the current state of training and enable recovery from potential training failures or deployment of intermediate models. Network weights and architecture configuration are stored using standardized formats that preserve the complete state of all network parameters, layer configurations, attention mechanisms, and multi-task learning head specifications, enabling exact restoration of the trained model for deployment or further training. Training hyperparameters and optimization state are saved including learning rates, optimizer parameters, loss function weights, and gradient accumulation settings to enable seamless continuation of training from saved checkpoints. Validation metrics and biological performance measures are recorded to document training progress and enable comparison of different model versions based on both computational performance and biological accuracy criteria. Model version metadata is generated for deployment tracking, including training dataset characteristics, biological validation results, computational requirements, and compatibility information for integration with genomic processing systems.

At decision point 3115, convergence criteria are evaluated to determine whether training has achieved sufficient performance to warrant deployment or whether additional optimization iterations are required. Convergence criteria may include, but is not limited to, stabilization of validation loss values, achievement of target biological accuracy levels, satisfaction of geometric consistency requirements, and convergence of compression performance metrics to acceptable levels. If convergence criteria are met, the method proceeds to comprehensive testing procedures. If additional training is required, the method returns to continue optimization with potential parameter adjustments based on observed convergence patterns.

The method continues to step 3116 where comprehensive model testing is performed on independent test datasets to evaluate final performance and ensure generalization across diverse genomic applications. Independent test sets with diverse genomic data are used to evaluate performance on data that was not involved in any aspect of training or validation, including different species, populations, genomic regions, and experimental conditions to ensure broad applicability. Generalization is assessed across different species and populations by testing the trained network on genomic data from organisms and populations not represented in the training datasets, evaluating whether the learned biological patterns and geometric representations transfer effectively across evolutionary and demographic boundaries. Compression and reconstruction quality are tested on clinical datasets that represent the intended application domain, ensuring that the network performs adequately on real-world genomic data with the noise, missing data, and complexity characteristic of clinical genomics applications. Biological interpretability of learned representations is validated by analyzing whether the network's internal features correspond to known biological concepts, whether attention patterns align with established functional relationships, and whether the geometric embeddings preserve meaningful biological distances and relationships.

At step 3117, deployment-ready model packages are generated that include all components necessary for integration with the geometric compression system for genomic data. Trained network weights and architecture specifications are finalized in formats compatible with the deployment environment, including optimization for computational efficiency, memory usage, and integration with existing genomic processing pipelines. Integration interfaces are created for the genomic compression system, providing standardized APIs that enable seamless communication between the trained neural network and other system components such as the manifold processing engine, compression rate controller, and biological constraint validator. Performance documentation and biological validation reports are generated to support deployment decisions and provide users with comprehensive information about the network's capabilities, limitations, and optimal operating conditions. Model packages are created with complete metadata including training provenance, biological validation results, computational requirements, and versioning information to support production deployment and maintenance.

The method includes a final validation decision point 3118 where model performance is evaluated against acceptance criteria to determine whether the trained network meets the requirements for production deployment. If model performance is acceptable, the method proceeds to deployment. If performance is insufficient, the method branches to parameter adjustment and retraining procedures to address identified deficiencies.

When model performance is acceptable, the method proceeds to step 3119 where the trained model is deployed in the production genomic compression system architecture. The model is installed in the system architecture with proper integration with manifold processing components, compression rate controllers, and biological constraint validators as specified in FIG. 27. Integration is configured with manifold processing components to ensure that the neural network outputs are properly formatted for geometric processing and that the manifold embeddings preserve biological relationships throughout the compression and reconstruction pipeline. Production monitoring and performance tracking systems are initialized to continuously assess model performance, detect potential degradation, and trigger maintenance procedures when necessary. Continuous learning and model update procedures are established to enable the deployed system to adapt to new genomic data, evolving biological knowledge, and changing application requirements while maintaining consistency and reliability in production environments.

The method includes parameter adjustment procedures beginning at step 3120 that are executed when validation performance fails to improve, convergence criteria are not met, or model performance is insufficient for deployment. Training parameters are adjusted through systematic analysis of training dynamics, validation performance patterns, and biological constraint satisfaction to identify and address specific optimization problems. Learning rates are modified based on observed convergence patterns, with adjustments that may include reducing learning rates for components showing instability, increasing learning rates for components converging too slowly, or implementing adaptive scheduling policies that respond to training dynamics. Loss function weighting coefficients are adjusted to rebalance the competing objectives based on observed performance across different tasks, potentially increasing emphasis on poorly performing objectives or reducing weights for objectives that are overwhelming the optimization process. Regularization parameters are updated to improve generalization performance, with modifications that may include adjusting weight decay strength, dropout rates, or other regularization techniques based on observed overfitting patterns. Network architecture may be reconfigured if performance is insufficient, with potential modifications including adjusting layer sizes, modifying attention mechanisms, or restructuring multi-task learning heads to better capture the requirements of genomic processing.

At decision point 3121, the method evaluates whether maximum training iterations have been reached to prevent excessive optimization time while allowing sufficient iterations for convergence. If maximum iterations have not been reached, the method returns to step 3104 to continue training with adjusted parameters. If maximum iterations have been reached without achieving acceptable performance, the method proceeds to failure documentation and termination.

At step 3123, comprehensive documentation and graceful termination procedures are executed when training fails to achieve acceptable performance within the specified iteration limits. Final model performance and biological validation metrics are recorded to document the best performance achieved and provide information for future training attempts or architectural improvements. Detailed analysis of convergence failure causes is generated through examination of training dynamics, gradient patterns, loss function behavior, and biological constraint satisfaction to identify specific problems that prevented successful optimization. The best model checkpoint is preserved for potential future refinement, enabling researchers to resume training from the most promising intermediate state or to analyze the partially trained network to understand optimization challenges. Recommendations are created for architecture modifications, data improvements, hyperparameter adjustments, or alternative training strategies that might address the identified problems and enable successful training in future attempts.

The method includes a batch processing loop at step 3124 that manages the efficient processing of training data in batches while maintaining the mathematical equivalence of full dataset training through gradient accumulation and proper parameter updates. The next batch of genomic training data is loaded with appropriate balancing of biological diversity, computational efficiency, and memory constraints that enable processing of large genomic datasets within available computational resources. Forward and backward pass cycles are continued with consistent procedures for gradient computation, parameter updates, and performance monitoring to ensure training stability and progress. Gradient accumulation and parameter updates are maintained across batches to enable processing of datasets that exceed available memory capacity while preserving the mathematical properties of gradient-based optimization. Training metrics and loss convergence are monitored continuously to detect potential problems early and enable prompt intervention if training becomes unstable or begins to diverge.

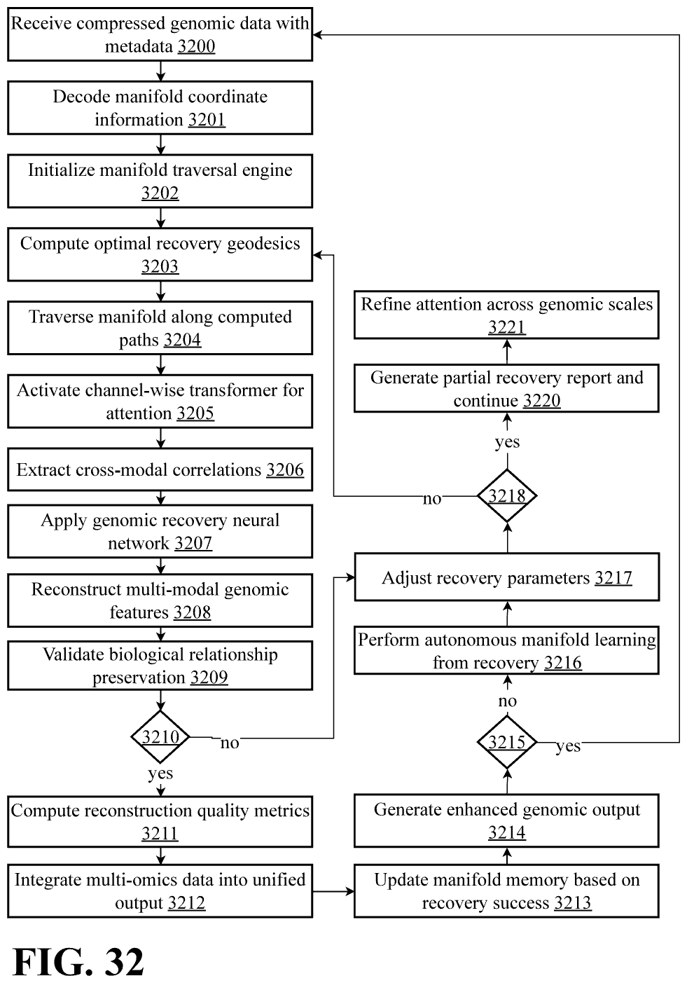

FIG. 32 is a flow diagram illustrating an exemplary method for genomic data recovery from compressed manifold representations that implements the reconstruction capabilities of the genomic decoder 2750 and utilizes the neural network architecture detailed in FIG. 29. The recovery method transforms compressed geometric representations back into biologically meaningful genomic data while preserving functional relationships, evolutionary constraints, and clinical associations through sophisticated manifold navigation and multi-scale attention mechanisms.

According to an embodiment, the process begins at step 3200 by receiving compressed genomic data together with the geometric metadata necessary for accurate reconstruction within the manifold framework. The compressed genomic bitstream is loaded along with manifold coordinates that specify the geometric location of each genomic element within the curved latent space, enabling precise navigation during the recovery process. Compression metadata and geometric consistency markers are validated to ensure that the received data maintains the mathematical and biological constraints required for meaningful reconstruction, including verification of coordinate validity, curvature consistency, and preservation of topological relationships. Biological annotation preservation records are retrieved to guide the reconstruction process toward maintaining known functional relationships, clinical associations, and evolutionary patterns that were identified as critical during the original compression process. Recovery parameters are initialized from stored configuration data that documents the compression decisions, quality trade-offs, and biological priorities that guided the original processing, enabling the recovery system to optimize reconstruction based on the specific characteristics and requirements of the compressed genomic dataset.

At step 3201, manifold coordinate information is decoded to reconstruct the geometric structure that will guide the recovery process through the curved latent space. Geometric embedding coordinates are extracted for each genomic region, providing the precise manifold locations that correspond to different biological elements and enabling navigation through the space of genomic concepts during reconstruction. Manifold curvature and pressure field data are reconstructed from the compressed geometric information, restoring the local geometric properties that encode biological importance, functional density, and compression resistance throughout the genomic manifold. Geodesic path information is recovered for attention guidance, providing the optimal traversal routes that were computed during compression to connect related genomic elements while preserving biological relationships and minimizing reconstruction error. Coordinate consistency is validated with manifold constraints to ensure that the decoded geometric information satisfies the mathematical requirements for valid manifold operations while preserving the biological topology essential for meaningful genomic reconstruction.

The method continues to step 3202 where the manifold traversal engine is initialized with the parameters necessary to navigate the geometric space effectively while maintaining biological constraints throughout the recovery process. Geometric navigation parameters are configured for recovery paths based on the decoded manifold structure, establishing the mathematical frameworks for computing optimal traversal routes that balance reconstruction accuracy with biological constraint preservation. Attention flow computation is set up based on stored metadata that documents the attention patterns and flow dynamics that were successful during compression, enabling the recovery system to replicate effective information processing strategies. Biological constraint validators are initialized for path planning to ensure that all manifold navigation decisions respect known functional relationships, evolutionary constraints, and clinical associations throughout the reconstruction process. Goal potential fields are established for reconstruction guidance, creating attractive forces within the manifold that draw attention toward genomic regions of highest importance and guide the recovery process toward optimal biological accuracy.

At step 3203, optimal recovery geodesics are computed through variational optimization that balances multiple competing objectives while respecting the geometric structure of the manifold and the biological constraints essential for meaningful genomic reconstruction. Minimal-energy paths are calculated to genomic thought bundles using algorithms that identify traversal routes requiring minimum computational effort while maximizing biological information recovery and preserving functional relationships. The recovery action functional S[γ]=∫[∥γ∥²−P_{recovery}(γ(t))+P_{target}(γ(t))+Qₚᵣₑₛₑᵣᵥₐₜᵢₒₙ(γ(t))]dt is applied where ∥γ∥² represents the kinetic energy of manifold traversal, P_{recovery}(γ(t)) is a negative pressure term that reduces cost for paths through information-rich regions, P_{target}(γ(t)) is the target potential that attracts paths toward reconstruction goals, and Qₚᵣₑₛₑᵣᵥₐₜᵢₒₙ(γ(t)) rewards paths that maintain biological quality and constraint satisfaction. Path optimization maximizes biological information recovery by finding routes that access the most relevant genomic knowledge while minimizing reconstruction error and preserving the functional relationships essential for biological interpretation. Geodesic validation ensures that computed paths preserve evolutionary and functional relationships by verifying that traversal routes maintain known biological dependencies, respect phylogenetic constraints, and preserve clinical associations throughout the reconstruction process.

The method proceeds to step 3204 where manifold traversal is executed along the computed optimal paths, systematically collecting biological information while maintaining attention weights that preserve cross-modal correlations essential for accurate genomic reconstruction. Navigation through genomic thought bundles follows the optimal routes computed in the previous step, accessing the compressed biological knowledge stored in coherent submanifolds while respecting the geometric structure that encodes functional relationships and evolutionary constraints. Biological feature information is collected during traversal by extracting the compressed representations of sequence patterns, functional annotations, conservation scores, and cross-modal relationships stored within the accessed thought bundles. Attention weights are maintained for cross-modal correlation recovery, ensuring that the relationships between different types of genomic data such as sequence variants, expression patterns, and protein abundances are preserved throughout the reconstruction process. Bundle activation patterns are tracked for quality assessment, monitoring which thought bundles are accessed during recovery and how effectively they contribute to reconstruction accuracy, providing feedback for manifold optimization and future recovery improvements.

At step 3205, the channel-wise transformer is activated to apply hierarchical attention mechanisms that process multi-modal genomic data across multiple scales simultaneously, ensuring comprehensive reconstruction of both local details and global relationships. Multi-modal genomic data is processed through hierarchical attention layers that operate at different levels of biological organization, from individual nucleotides to entire genomes, enabling the recovery system to capture both fine-grained sequence details and broad functional relationships. Gene-level attention may be applied for local sequence reconstruction, focusing computational resources on regulatory elements, coding sequences, and functional motifs that require high-fidelity recovery to maintain biological functionality. Pathway-level attention can be executed for functional group recovery, ensuring that genes participating in common biological processes, metabolic networks, and regulatory cascades are reconstructed with preserved functional relationships and coordinated expression patterns. Genome-level attention may be implemented for global relationship restoration, maintaining chromosomal structure, population genetics patterns, and evolutionary relationships that span large genomic regions or multiple individuals within the dataset.

The method continues to step 3206 where cross-modal correlations are extracted to restore the functional relationships between different types of genomic measurements that are essential for biological interpretation and downstream analysis. Relationships between DNA sequences and expression data can be recovered by leveraging the geometric proximity information stored in the manifold to identify sequence variants that influence gene expression, regulatory elements that control transcriptional activity, and structural features that affect RNA stability or processing. SNP-phenotype associations are restored from geometric proximity by using manifold distances to reconstruct the relationships between genetic variants and their phenotypic effects, including disease susceptibility, drug response, and quantitative trait associations that are critical for medical genomics applications. Protein-gene regulatory networks are reconstructed by extracting the functional relationships between transcriptional regulators, their target genes, and the resulting protein products, ensuring that the complex regulatory hierarchies essential for cellular function are preserved throughout the recovery process. Cross-modal consistency is validated with biological constraints to ensure that the reconstructed relationships satisfy known biological principles, evolutionary patterns, and experimental observations that define valid genomic interactions.

At step 3207, the genomic recovery neural network is applied to process the manifold features collected during traversal and generate specific predictions for sequence reconstruction, variant calling, and expression quantification with associated confidence estimates. Manifold features are processed through the trained recovery architecture described herein, applying the learned transformations that convert geometric representations back into biologically meaningful genomic information while preserving functional relationships and maintaining reconstruction accuracy. Sequence-level reconstruction predictions are generated using the network's ability to leverage cross-modal correlations and functional constraints to infer missing or degraded sequence information based on the preserved geometric relationships and biological context. Variant quality scores and confidence intervals are predicted to provide users with quantitative assessments of reconstruction accuracy for individual genetic variants, enabling downstream analysis pipelines to appropriately weight genomic information based on reconstruction reliability. Expression value recovery is estimated with uncertainty bounds that reflect both the technical limitations of the compression and reconstruction process and the biological variability inherent in gene expression measurements across different conditions and time points.

The method proceeds to step 3208 where multi-modal genomic features are reconstructed through integration of the neural network predictions with the geometric information extracted during manifold traversal. DNA sequences can be rebuilt with position-specific quality scores that reflect the confidence in each nucleotide reconstruction, enabling downstream analysis tools to appropriately handle regions with varying reconstruction accuracy while maintaining sequence integrity for functional analysis. SNP genotype calls are recovered with confidence probabilities that indicate the reliability of variant detection and genotype assignment, providing essential information for genetic association studies, pharmacogenomics analyses, and clinical interpretation of genetic variants. Gene expression values may be restored with measurement uncertainty that reflects both technical variability from the original measurements and additional uncertainty introduced by the compression and reconstruction process, enabling appropriate statistical analysis of expression differences and regulatory relationships. Protein abundance data can be reconstructed with quantification accuracy estimates that guide the interpretation of proteomic results and enable integration with other genomic measurements while accounting for the specific challenges of protein quantification and the effects of data compression on measurement precision.

At step 3209, biological relationship preservation is validated through comprehensive analysis of the reconstructed genomic data to ensure that essential functional dependencies, evolutionary patterns, and clinical associations have been maintained throughout the recovery process. Known gene regulatory networks are verified by comparing the reconstructed expression patterns and regulatory relationships to established databases of transcriptional regulation, ensuring that the recovery process has preserved the complex hierarchical relationships that control gene expression and cellular function. Phylogenetic relationships are checked by analyzing the reconstructed sequence data for conservation patterns and evolutionary distances that match established phylogenetic knowledge, validating that the compression and recovery process has not introduced artifacts that would compromise evolutionary analysis or species identification. Clinical variant-phenotype associations are validated by verifying that the reconstructed genetic variants maintain their established relationships to disease susceptibility, drug response, and other clinically relevant phenotypes, ensuring that the recovered data remains suitable for medical genomics applications and clinical decision making. Functional pathway integrity is assessed after reconstruction by analyzing whether the reconstructed genomic data preserves the coordinated patterns of gene expression, protein interaction, and metabolic activity that define biological pathways and cellular processes.

The method includes a critical validation decision point 3210 where the biological validation results are evaluated to determine whether the reconstruction has successfully preserved the biological relationships essential for downstream analysis. If biological validation passes, indicating that functional relationships, evolutionary patterns, and clinical associations have been adequately preserved, the method proceeds to quality metric computation and output generation. If biological validation fails, indicating that critical biological information has been lost or corrupted during reconstruction, the method branches to parameter adjustment procedures at step 3217 to optimize the recovery process and attempt to improve biological preservation.

When biological validation is successful, the method continues to step 3211 where comprehensive reconstruction quality metrics are computed to provide quantitative assessments of recovery accuracy across all genomic data types and biological relationships. Sequence accuracy is calculated against reference standards by comparing reconstructed sequences to gold standard references, computing metrics such as per-base accuracy, indel detection sensitivity, and structural variant reconstruction fidelity that enable users to assess the reliability of sequence-level information. Variant calling sensitivity and specificity are assessed by evaluating the recovery system's ability to correctly identify true genetic variants while avoiding false positive calls, providing essential information for genetic association studies and clinical variant interpretation. Expression correlation with original measurements is evaluated by computing correlation coefficients between reconstructed and original expression values across genes, samples, and experimental conditions, enabling users to assess the reliability of expression-based analyses and regulatory network reconstruction. Comprehensive quality reports are generated with confidence intervals that provide detailed documentation of reconstruction performance, including region-specific accuracy assessments, data type-specific quality metrics, and overall system performance summaries that guide appropriate use of the recovered genomic data.

The method proceeds to step 3212 where multi-omics data integration creates unified outputs that preserve the relationships between different types of genomic measurements while maintaining the temporal and biological coherence essential for comprehensive genomic analysis. Reconstructed genomic layers can be combined with preserved relationships to create integrated datasets that maintain the cross-modal correlations between DNA sequences, gene expression, protein abundance, and other genomic measurements that are essential for systems biology approaches and personalized medicine applications. Integrated multi-omics profiles are generated for downstream analysis by organizing the reconstructed data into formats suitable for pathway analysis, regulatory network reconstruction, and clinical interpretation while preserving the quality annotations and confidence estimates that enable appropriate statistical analysis. Temporal coherence is maintained in longitudinal datasets by preserving the time-series relationships between measurements taken at different time points, ensuring that dynamic biological processes and treatment responses can be accurately analyzed using the reconstructed data. Patient-specific or sample-specific identifiers are preserved to enable personalized analysis and clinical application while maintaining appropriate privacy protections and data security measures.

At step 3213, manifold memory is updated based on recovery success patterns to enable continuous improvement of the reconstruction system through learning from successful and unsuccessful recovery attempts. Geodesic paths that achieved high recovery quality are strengthened through metric adjustments that reduce the computational cost of traversing successful routes, creating preferential pathways through the manifold that correspond to effective reconstruction strategies. Curvature is adjusted in regions with successful reconstruction to reflect the demonstrated utility of different genomic regions and biological relationships for accurate recovery, optimizing the geometric structure to improve future reconstruction performance. Thought bundle coherence is updated based on recovery patterns by modifying the internal organization and boundary definitions of genomic concept clusters to better reflect the relationships that contribute to successful reconstruction. Reinforcement learning algorithms are applied to optimize future recovery paths by using recovery success as a reward signal to train path selection algorithms that can automatically identify optimal traversal strategies for different types of genomic reconstruction tasks.

The method continues to step 3214 where enhanced genomic output is generated with comprehensive quality annotations, confidence estimates, and biological interpretation guidance that enable effective use of the reconstructed data in downstream analysis applications. Reconstructed genomic data is produced with quality annotations that provide detailed information about reconstruction accuracy, uncertainty estimates, and reliability assessments for each genomic element, enabling downstream analysis tools to appropriately weight and filter genomic information based on reconstruction quality. Confidence scores and uncertainty estimates may be included for all reconstructed measurements, providing quantitative assessments of reconstruction reliability that enable appropriate statistical analysis and interpretation of genomic results while accounting for the effects of compression and reconstruction on measurement precision. Biological interpretation guidance can be provided through automated pathway analysis, functional annotation, and regulatory network analysis that helps users understand the biological significance of the reconstructed data and identify potential artifacts or limitations that might affect downstream analysis. Visualization data is generated for genomic relationship networks that enable interactive exploration of the reconstructed biological relationships, providing researchers with intuitive tools for understanding the complex interactions between genomic elements and validating the biological coherence of the recovered data.

At 3215, the method includes a decision point to determine whether additional compressed genomic data requires processing, enabling batch processing of large genomic datasets while maintaining consistency and efficiency across multiple recovery operations. If additional compressed data is present, the method returns to the beginning of the recovery pipeline to process the next dataset using the optimized parameters and improved manifold structure developed during previous recovery operations. If no additional data remains, the method proceeds to autonomous manifold learning procedures that further optimize the system based on the accumulated recovery experience.

At step 3216, autonomous manifold learning is performed to analyze recovery patterns and optimize the geometric structure for improved future performance through unsupervised learning algorithms that identify successful reconstruction strategies and incorporate them into the manifold organization. Recovery patterns can be analyzed for manifold topology optimization by examining which geometric structures, traversal paths, and attention patterns contributed most effectively to successful reconstruction, identifying optimization opportunities that can improve future recovery performance. New biological relationship patterns may be discovered from success data by analyzing cases where unexpected genomic relationships contributed to successful reconstruction, potentially revealing novel biological insights or previously unrecognized functional dependencies that can be incorporated into the manifold structure. Geometric representations are updated based on recovery outcomes by modifying the manifold coordinates, curvature patterns, and thought bundle organizations to better reflect the biological relationships that prove most important for accurate genomic reconstruction. Learned recovery strategies are consolidated into manifold structure by incorporating successful reconstruction approaches into the persistent geometric representation, enabling the system to automatically apply effective strategies to similar future reconstruction tasks.

The method includes parameter adjustment procedures beginning at step 3217 that are executed when biological validation fails, implementing systematic optimization to improve reconstruction quality while maintaining computational efficiency. Attention weights are modified based on validation failure patterns by analyzing which attention mechanisms failed to preserve biological relationships and adjusting the attention parameters to better focus on critical biological dependencies. Neural network recovery confidence thresholds are adjusted to optimize the balance between reconstruction completeness and accuracy, potentially requiring higher confidence for critical biological elements while accepting lower confidence for less important genomic regions. Cross-modal correlation strength parameters are recalibrated to improve the preservation of relationships between different types of genomic measurements, ensuring that functional dependencies between sequence variants, expression patterns, and protein abundances are maintained throughout reconstruction. Biological constraint validation criteria are updated to reflect lessons learned from validation failures, potentially tightening constraints for critical biological relationships while relaxing constraints for less important associations to improve overall reconstruction success rates.

At decision point 3218, the method evaluates whether maximum recovery iterations have been reached to prevent excessive optimization time while allowing sufficient attempts to achieve acceptable biological preservation. If maximum iterations have not been reached, the method returns to step 3203 to recompute optimal recovery geodesics with the adjusted parameters and attempt reconstruction with improved settings. If maximum iterations have been reached without achieving acceptable biological validation, the method proceeds to step 3220 for partial recovery reporting and continuation with available results.

At step 3220, partial recovery reporting and continuation procedures document the biological validation challenges while preserving successfully recovered genomic components for downstream analysis. Biological validation failures and partial successes are documented through detailed analysis of which biological relationships were successfully preserved and which were lost during reconstruction, providing valuable information for system improvement and user guidance. Successfully recovered genomic components are preserved and made available for analysis with appropriate quality warnings that alert users to limitations in biological relationship preservation and potential impacts on downstream analysis results. Quality warnings are generated for downstream analysis applications that specify which types of biological analyses may be compromised by the validation failures and which analyses remain reliable based on the successfully preserved biological relationships. Recommendations are created for improved recovery in similar cases by analyzing the validation failure patterns and identifying potential modifications to compression parameters, recovery algorithms, or biological constraint definitions that might improve success rates for similar genomic datasets.

The method includes an attention refinement loop at step 3221 that optimizes the hierarchical attention mechanisms across multiple genomic scales to improve reconstruction accuracy through iterative adjustment of attention parameters. Gene-level attention can be adjusted for improved local reconstruction by modifying the attention weights and patterns that focus on regulatory elements, coding sequences, and local sequence features to enhance the accuracy of fine-grained sequence reconstruction. Pathway-level attention is modified for better functional recovery by adjusting the attention mechanisms that coordinate the reconstruction of functionally related genes, ensuring that biological pathways and regulatory networks are reconstructed with preserved functional relationships. Chromosome-level attention can be updated for structural preservation by optimizing the attention patterns that maintain large-scale genomic organization, chromosomal structure, and linkage relationships during reconstruction. Genome-level attention is balanced for population pattern maintenance by adjusting the mechanisms that preserve population genetics relationships, evolutionary patterns, and cross-individual correlations that are essential for population genomics and evolutionary analysis.

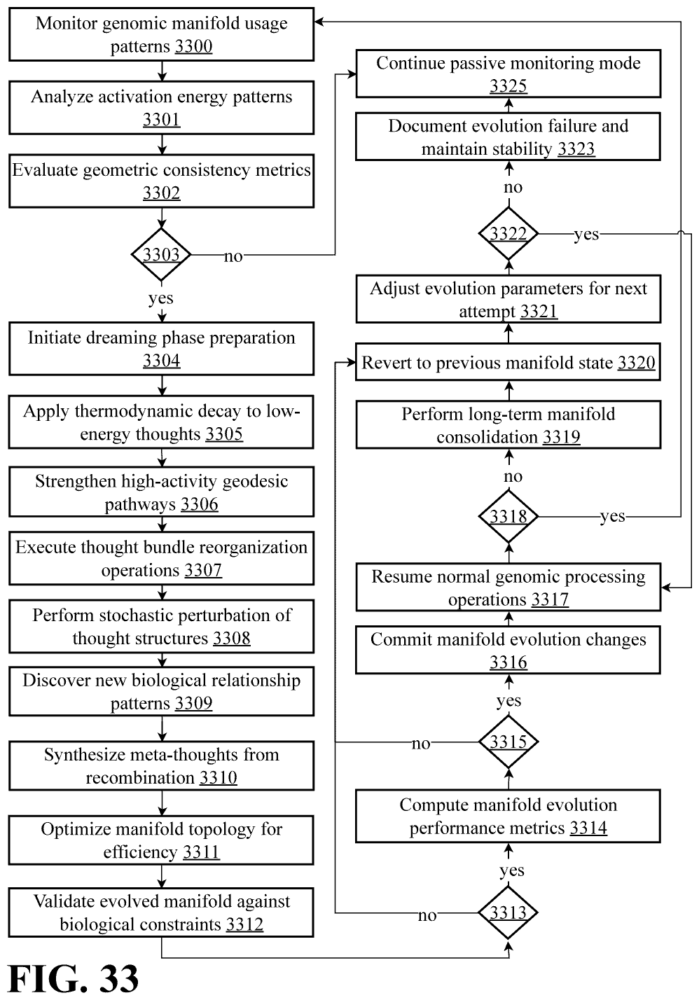

FIG. 33 is a flow diagram illustrating an exemplary method for dynamic manifold evolution during genomic processing that implements the continuous learning and adaptation capabilities of the persistent cognitive machine framework applied to genomic data compression and analysis. The method enables autonomous optimization of the geometric substrate through usage-driven evolution while maintaining biological validity and preserving essential functional relationships throughout the adaptation process.

According to the embodiment, the process begins at step 3300 by monitoring genomic manifold usage patterns to identify opportunities for structural optimization and performance improvement through systematic analysis of how the geometric substrate is utilized during operational genomic processing. Frequency of geodesic path traversal is tracked across different manifold regions to identify commonly used reasoning pathways that connect related genomic concepts, frequently accessed biological relationships, and underutilized areas of the genomic knowledge space that may benefit from reorganization or removal. Thought bundle activation patterns and co-occurrence are recorded to understand which genomic concepts are typically accessed together during compression and reconstruction operations, revealing functional relationships and biological dependencies that should be preserved or strengthened during manifold evolution. Compression success rates are monitored for different genomic regions to identify areas where the current manifold structure effectively supports high-quality compression and reconstruction versus regions where structural improvements might enhance performance. Biological constraint satisfaction is logged across processing cycles to ensure that manifold evolution maintains the functional relationships, evolutionary patterns, and clinical associations essential for meaningful genomic analysis while identifying constraints that may be overly restrictive or insufficiently enforced.

At step 3301, activation energy patterns are analyzed to understand the thermodynamic state of genomic knowledge within the manifold and identify candidates for strengthening or removal based on their contribution to successful genomic processing. Activation energy Eᵢ(t) is computed for each genomic thought using the thermodynamic framework where energy levels reflect the frequency of access, biological importance, and contribution to successful compression and reconstruction outcomes. High-energy regions are identified that indicate frequent biological use, including genomic concepts that are regularly accessed during processing, biological relationships that consistently contribute to successful outcomes, and functional patterns that demonstrate persistent utility across diverse genomic datasets. Low-energy regions approaching thermodynamic decay are detected, including unused genomic concepts, obsolete biological relationships, and ineffective reasoning patterns that consume computational resources without contributing to processing success. Energy distribution is assessed across different genomic data types to understand how various categories of biological information contribute to overall system performance and identify opportunities for rebalancing computational resources toward more effective genomic processing strategies.

The method continues to step 3302 where geometric consistency metrics are evaluated to assess the mathematical and biological validity of the current manifold structure while identifying potential improvements that could enhance processing efficiency and biological accuracy. Curvature stability is checked across manifold regions to ensure that the geometric properties that encode biological importance and functional relationships remain mathematically valid and biologically meaningful throughout operational use. Geodesic path optimality and biological coherence are validated to verify that the computed traversal routes continue to represent efficient reasoning pathways that preserve functional dependencies and evolutionary constraints during genomic processing. Thought bundle boundary integrity and semantic clustering are assessed to ensure that the organization of genomic concepts into coherent submanifolds continues to reflect meaningful biological relationships and functional groupings. Compression pressure field gradients and discontinuities are monitored to identify regions where the geometric encoding of biological importance may have become inconsistent or suboptimal for current processing requirements.

At decision point 3303, the method evaluates whether manifold evolution should be triggered based on the accumulated monitoring data and predefined performance criteria. Evolution triggering considers factors including degraded processing performance, suboptimal resource utilization, identification of new biological relationships, or accumulation of structural inconsistencies that warrant geometric reorganization. If evolution is not triggered, the method proceeds to step 3325 for continued passive monitoring. If evolution conditions are met, the method initiates the dreaming phase for active manifold restructuring.

When evolution is triggered, the method proceeds to step 3304 where dreaming phase preparation establishes the controlled environment necessary for safe geometric reorganization while preserving system stability and enabling rollback if evolution attempts prove unsuccessful. Active compression operations are suspended for geometric reorganization to prevent interference between operational processing and structural modification, ensuring that manifold evolution occurs in a controlled environment without disrupting ongoing genomic analysis workflows. Manifold state snapshots can be created for rollback capability, preserving the complete geometric configuration including curvature patterns, thought bundle organizations, geodesic path networks, and all parameters necessary to restore the original manifold structure if evolution attempts fail or produce suboptimal results. Evolution parameters may be configured based on usage analysis results, including perturbation strength based on manifold stability, exploration scope determined by identified optimization opportunities, and biological constraint enforcement levels adapted to preserve essential functional relationships. Perturbation sampling strategies are initialized for thought exploration, establishing the mathematical frameworks for systematically testing structural modifications while maintaining geometric validity and biological coherence.

At step 3305, thermodynamic decay is applied to low-energy thoughts to remove unused genomic concepts and free computational resources for more effective biological processing. In some embodiments, the decay equation dEᵢ/dt=−λEᵢ(t)+Aᵢ(t) is implemented where λ is the decay constant and Aᵢ(t) represents activity-based energy input, with thoughts receiving energy boosts when accessed during successful genomic processing and losing energy when unused over extended periods. Thoughts with Eᵢ(t)<Eₘᵢₙ are identified for potential pruning, including genomic concepts that have not contributed to successful processing, biological relationships that have proven ineffective, and reasoning patterns that consume resources without providing value. Manifold representation is gradually reduced for unused concepts through geometric operations that remove or compress regions of the manifold associated with low-energy thoughts while preserving the overall manifold structure and connectivity. Critical biological relationships are preserved during the decay process through protective mechanisms that maintain essential functional dependencies, evolutionary constraints, and clinical associations regardless of their recent usage patterns, ensuring that important but infrequently accessed biological knowledge is not inadvertently removed.

The method continues to step 3306 where high-activity geodesic pathways are strengthened to improve the efficiency of successful reasoning patterns and create preferential routes through the manifold that correspond to proven biological relationships. Frequently traversed paths with high biological success are identified through analysis of usage patterns and compression outcomes, focusing on reasoning routes that consistently lead to accurate genomic analysis and successful preservation of biological relationships. Geodesic curvature is reduced along successful reasoning routes by adjusting the local metric tensor to decrease the energy required for traversing proven pathways, creating computational shortcuts that improve processing efficiency for common biological reasoning patterns. The metric tensor is adjusted to decrease traversal energy requirements for successful pathways while maintaining the geometric validity of the manifold and preserving the biological meaning encoded in geodesic distances and relationships. Preferential channels are created for proven biological relationships by establishing low-resistance pathways in the manifold that facilitate rapid access to frequently used biological knowledge and enable efficient reasoning about well-established functional dependencies and evolutionary patterns.

At step 3307, thought bundle reorganization operations are executed to optimize the clustering of genomic concepts based on observed functional relationships and processing patterns while maintaining biological taxonomy and semantic coherence. Fanning-in operations are performed for semantically similar genomic concepts that have demonstrated functional relationships during processing, consolidating related ideas into more coherent thought bundles that improve computational efficiency and biological interpretability. Fanning-out operations are executed to expand bundles into new biological domains when genomic concepts have demonstrated broader applicability than originally recognized, enabling thought bundles to encompass related biological phenomena and functional relationships that have emerged through operational experience. Rebinding operations may be applied to merge functionally related bundles when analysis reveals significant overlap, shared functionality, or synergistic relationships that justify combining previously separate conceptual clusters into unified biological representations. Bundle modifications can be validated to preserve biological taxonomy by ensuring that reorganization operations maintain established biological classifications, functional hierarchies, and evolutionary relationships that are essential for meaningful genomic interpretation.

The method proceeds to step 3308 where stochastic perturbation of thought structures enables exploration of the local manifold neighborhood around established genomic concepts to discover optimization opportunities and test structural stability. Thought bundles are sampled based on recent activity and biological importance, focusing perturbation efforts on genomic concepts that are actively used during processing while avoiding disruption of stable, unused regions. In some embodiments, controlled noise is applied according to z′ᵢ=zᵢ+εᵢ where εᵢ˜N(0, Σᵢ), with the covariance structure Σᵢ adapted to local manifold properties to ensure that perturbations respect geometric constraints while enabling meaningful exploration of alternative configurations. Structural stability may be tested through perturbation response analysis by observing how small modifications to thought structure affect processing performance, biological constraint satisfaction, and overall system behavior. Local manifold neighborhoods can be explored for optimization opportunities by analyzing the geometric landscape around established genomic concepts to identify potential improvements in positioning, relationships, or internal organization that could enhance biological accuracy or computational efficiency.

At step 3309, new biological relationship patterns are discovered through systematic analysis of perturbation outcomes and exploration results to identify emergent biological insights that can improve genomic processing accuracy and biological interpretation. Perturbation outcomes are analyzed for emergent biological insights by examining cases where modified genomic concepts led to improved processing performance, discovered functional relationships, or enhanced biological constraint satisfaction that was not apparent in the original manifold structure. Novel correlations may be identified between previously separate concepts by analyzing the geometric relationships that emerge during perturbation and exploration, potentially revealing biological dependencies, functional associations, or evolutionary relationships that were not explicitly encoded in the original system. Discovered relationships can be validated against biological databases through systematic comparison with established biological knowledge including gene ontology classifications, pathway databases, evolutionary relationships, and clinical association records to ensure that identified patterns reflect genuine biological phenomena rather than computational artifacts. New geodesic connections may be created for validated biological patterns by establishing low-energy pathways in the manifold that connect genomic concepts with demonstrated biological relationships, improving future processing efficiency and biological accuracy.

The method continues to step 3310 where meta-thoughts are synthesized from recombination operations to create higher-order biological abstractions that capture emergent patterns and improve the manifold's capacity for biological reasoning. Weighted interpolations are generated according to zₘₑₜₐ=Σαᵢ·z′ᵢ where the weights αᵢ reflect the relative importance and biological relevance of contributing thought components, creating new conceptual representations that capture the essential features of multiple related genomic concepts. Higher-order abstractions are created from multiple thought bundles by identifying common patterns, shared functional characteristics, and emergent properties that arise from the interaction of previously separate biological concepts. Meta-thought coherence and biological interpretability are validated by ensuring that synthesized concepts maintain meaningful biological content, preserve functional relationships, and provide interpretable biological insights rather than creating abstract mathematical constructs without biological significance. Compression and reconstruction performance of new abstractions is tested by evaluating whether meta-thoughts contribute to improved genomic processing outcomes, enhanced biological accuracy, and more efficient computational performance compared to the original separate concepts.

At step 3311, manifold topology is optimized for processing efficiency through geometric algorithms that improve the overall structure of the genomic knowledge space while preserving biological relationships and functional dependencies. Ricci flow-inspired curvature smoothing algorithms are applied to reduce geometric irregularities and optimize the distribution of curvature throughout the manifold, creating a more uniform and efficient geometric substrate for genomic processing. Topological surgery is performed to create new conceptual bridges between previously disconnected regions of the manifold when analysis reveals functional relationships that warrant direct connections, enabling more efficient reasoning about biological phenomena that span multiple genomic domains. The geodesic network is optimized for minimal average path length by adjusting manifold geometry to reduce the computational cost of traversing common reasoning pathways while maintaining the biological meaning encoded in geodesic distances and relationships. Local clustering is balanced with global connectivity requirements to ensure that related genomic concepts remain grouped together while maintaining sufficient connectivity to enable reasoning about biological phenomena that involve interactions between different functional domains.

The method includes validation procedures at step 3312 where the evolved manifold structure is comprehensively tested against biological constraints to ensure that structural modifications have preserved essential functional relationships and biological validity. Known gene regulatory networks may be verified by testing whether the evolved manifold structure maintains established transcriptional regulatory relationships, protein-protein interactions, and other documented biological networks that are essential for meaningful genomic analysis. Phylogenetic and evolutionary relationships can be checked by validating that the manifold evolution has preserved conservation patterns, speciation relationships, and evolutionary distances that reflect established phylogenetic knowledge and evolutionary constraints. Clinical variant-phenotype associations are validated by ensuring that the evolved structure maintains established relationships between genetic variants and disease susceptibility, drug responses, and other clinically relevant phenotypes that are critical for medical genomics applications. Functional pathway integrity is assessed after manifold modifications by verifying that biological pathways, metabolic networks, and cellular processes remain coherently represented in the evolved manifold structure.

At decision point 3313, the method evaluates whether biological constraints have been satisfied throughout the evolution process. If biological constraints are not satisfied, indicating that evolution has compromised essential biological relationships, the method branches to rollback procedures at step 3320 to restore the previous stable manifold state. If biological validation is successful, the method proceeds to performance evaluation.

When biological constraints are satisfied, the method continues to step 3314 where comprehensive performance metrics are computed to quantify the benefits achieved through manifold evolution and validate that structural changes have improved system performance. Compression efficiency improvements are measured by comparing compression ratios, quality preservation, and processing speed before and after evolution to quantify the computational benefits achieved through structural optimization. Reconstruction accuracy changes are assessed after manifold updates by evaluating whether the evolved structure improves the quality of genomic data recovery and biological relationship preservation during decompression operations. Biological relationship preservation is evaluated across modifications by testing whether the evolved manifold better maintains functional dependencies, evolutionary patterns, and clinical associations compared to the original structure. Computational efficiency gains are calculated from structural optimization by measuring improvements in processing speed, memory usage, and resource utilization that result from the manifold evolution process.

At decision point 3315, the method determines whether performance improvement has been achieved through the evolution process. If performance has not improved sufficiently to justify the evolution effort, the method branches to rollback procedures to restore the original manifold state. If significant performance improvements have been achieved, the method proceeds to commit the evolution changes.

When performance improvement is validated, the method proceeds to step 3316 where manifold evolution changes are committed to make the structural improvements permanent and integrate them into the operational genomic processing system. The updated geometric structure and thought bundle organization are finalized by consolidating all modifications into a stable manifold configuration that can support ongoing genomic processing operations. Persistent memory is updated with the evolved manifold configuration to ensure that structural improvements are preserved across system restarts and operational cycles. Compression and attention parameter caches are regenerated to reflect the new manifold structure and optimize computational performance for the evolved geometric configuration. Evolution success metrics are logged for future optimization guidance, documenting which types of modifications proved effective and establishing baselines for future evolution attempts.

The method continues to step 3317 where normal genomic processing operations are resumed using the evolved manifold structure while monitoring performance improvements and maintaining readiness for future evolution cycles. Compression and reconstruction systems are reactivated with the evolved manifold providing improved geometric substrate for genomic processing operations. Monitoring is initialized for the next evolution cycle by establishing baseline performance metrics and tracking usage patterns that will inform future optimization opportunities. The evolved manifold structure is applied to new genomic processing tasks to validate performance improvements and ensure that evolution benefits are realized in operational workflows. Performance improvements are tracked in operational genomic workflows to quantify the real-world benefits of manifold evolution and identify additional optimization opportunities.

At decision point 3318, the method determines whether continued monitoring should proceed or whether long-term consolidation procedures should be initiated. If continued monitoring is selected, the method returns to step 3300 to begin the next monitoring cycle. If consolidation is chosen, the method proceeds to archive successful evolution patterns and prepare for extended operational deployment.

When consolidation is selected, the method proceeds to step 3319 where long-term manifold consolidation preserves successful evolution strategies and prepares the system for extended operational deployment. Successful evolution patterns are archived for future reference, documenting which types of structural modifications proved effective for different categories of genomic processing tasks. Comprehensive evolution reports are generated with biological insights that document discovered biological relationships, improved reasoning patterns, and enhanced computational efficiencies achieved through the evolution process. The system knowledge base is updated with discovered biological patterns that can inform future processing decisions and provide biological insights for genomic analysis applications. The manifold structure is prepared for extended operational deployment by optimizing computational parameters, validating system stability, and ensuring readiness for sustained genomic processing operations.

The method includes rollback procedures beginning at step 3320 that are executed when biological constraint validation fails or performance improvements are insufficient, ensuring system stability and preserving operational capability. The manifold geometry is restored from saved snapshots by returning all geometric parameters, thought bundle organizations, and structural relationships to their pre-evolution state. Thought bundle modifications are rolled back to stable configuration by reversing all reorganization operations and restoring the original clustering and relationship patterns. Geometric parameters are reset to pre-evolution values while preserving lessons learned for future evolution attempts, maintaining the knowledge gained through the evolution process even when structural changes are not adopted.

At step 3321, evolution parameters are adjusted for future attempts based on analysis of the factors that led to evolution failure, improving the likelihood of success in subsequent optimization efforts. Perturbation strength is modified based on failure analysis by adjusting the magnitude and scope of structural modifications to better balance exploration with stability requirements. Biological constraint thresholds are adjusted for evolution success by fine-tuning the validation criteria to ensure that future evolution attempts achieve adequate biological preservation while enabling meaningful structural improvements. Evolution triggering criteria are updated to prevent similar failures by modifying the conditions that initiate evolution to focus on more promising optimization opportunities. Manifold stability metrics and validation procedures are recalibrated to improve the detection of successful versus unsuccessful evolution outcomes and provide better guidance for future optimization attempts.

At decision point 3322, the method evaluates whether evolution retry attempts remain available, preventing excessive optimization efforts while allowing reasonable opportunities for successful evolution. If retry attempts remain, the method returns to step 3317 to resume operational processing with the original manifold structure and continue monitoring for future evolution opportunities. If retry attempts are exhausted, the method proceeds to failure documentation and stability maintenance.

At step 3323, evolution failure is documented while maintaining system stability and preserving the capability for future optimization attempts. Detailed analysis of evolution failure causes is recorded including the specific biological constraints that were violated, performance metrics that failed to improve, and structural modifications that proved problematic. The current manifold state is preserved as a stable baseline for future evolution attempts, maintaining the proven operational configuration while documenting the lessons learned through unsuccessful optimization efforts. Recommendations are generated for future evolution parameter tuning based on the failure analysis, providing guidance for subsequent optimization attempts. Monitoring continues for alternative evolution opportunities that might prove more successful under different operational conditions or with modified optimization strategies.

The method includes passive monitoring procedures at step 3325 that maintain system awareness during periods when evolution is not warranted, ensuring readiness for future optimization opportunities while preserving operational stability. Observation of manifold usage patterns continues to identify potential optimization opportunities and track system performance trends. Activation energy tracking is updated without geometric changes to maintain awareness of which genomic concepts are contributing to successful processing outcomes. Biological constraint satisfaction is logged for trend analysis to identify patterns that might inform future evolution attempts or reveal emerging optimization opportunities. Preparation is maintained for future evolution trigger conditions by monitoring the factors that indicate when structural optimization might benefit system performance and biological accuracy.

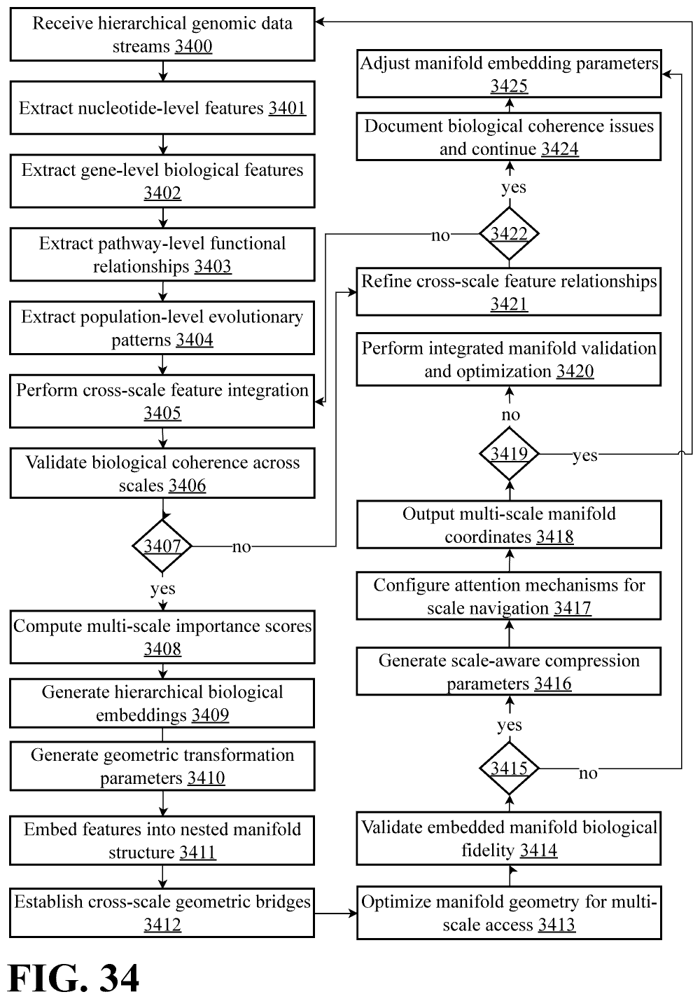

FIG. 34 is a flow diagram illustrating an exemplary method for multi-scale genomic feature extraction and manifold embedding that implements the hierarchical processing capabilities required to represent genomic information across multiple biological scales within the persistent cognitive machine framework. The method transforms genomic data from nucleotide-level sequences to population-level evolutionary patterns into a unified geometric representation that preserves biological relationships and functional dependencies across all scales of biological organization.

According to an embodiment, the process begins at step 3400 by receiving hierarchical genomic data streams that span multiple scales of biological organization, enabling comprehensive representation of genomic information from molecular details to evolutionary patterns. Nucleotide-level sequences are received with base quality scores that provide confidence estimates for individual nucleotide calls, enabling the system to appropriately weight sequence information based on measurement reliability and technical quality. Gene-level annotations are processed with functional classifications including gene ontology terms, pathway memberships, regulatory roles, and phenotypic associations that provide biological context for individual genes and their relationships to cellular processes. Pathway-level networks are ingested with regulatory relationships including protein-protein interactions, metabolic network connections, signaling cascade dependencies, and transcriptional regulatory hierarchies that capture the complex functional relationships between genes and biological processes. Population-level variants are received with frequency distributions including allele frequencies across different populations, linkage disequilibrium patterns, and evolutionary selection signatures that provide evolutionary context and population genetics information essential for understanding genomic variation and its biological significance.

At step 3401, nucleotide-level features are extracted to capture the local sequence patterns and structural characteristics that determine biological function at the molecular scale. K-mer frequency distributions are computed for multiple values (k=3, 4, 5, 6) to capture both short-range sequence patterns that correspond to specific binding motifs and longer patterns that reflect larger structural features and regulatory elements. Sequence motifs and regulatory element patterns are analyzed using position weight matrices and hidden Markov models to identify transcription factor binding sites, splice junctions, promoter elements, and other functional sequence features that determine gene regulation and expression. Local GC content and sequence complexity metrics are calculated using sliding window approaches to identify regions of unusual nucleotide composition that may indicate functional elements, repetitive sequences, or evolutionary signatures. Repeat patterns and tandem sequence structures are identified through alignment-based and statistical methods to characterize repetitive elements, tandem repeats, and other structural features that affect genome stability and evolutionary dynamics.

The method continues to step 3402 where gene-level biological features are extracted to characterize the functional properties and structural organization of individual genes within their genomic context. Coding sequence characteristics and splice patterns are processed to identify exon-intron boundaries, alternative splicing variants, and coding sequence features that determine protein structure and function. Promoter regions and transcription factor binding sites are analyzed to characterize the regulatory elements that control gene expression, including core promoter elements, enhancers, silencers, and tissue-specific regulatory sequences. Gene length, exon count, and structural complexity are computed to quantify the architectural features of genes that influence their expression regulation, evolutionary constraints, and functional characteristics. Expression correlation patterns are extracted across tissues and conditions to identify co-expression relationships, tissue-specific expression patterns, and condition-dependent regulatory responses that provide functional context for individual genes.

At step 3403, pathway-level functional relationships are extracted to capture the higher-order biological organization that emerges from the interaction of multiple genes and their products. Protein-protein interaction networks are identified through integration of experimental interaction data, computational predictions, and literature-derived associations to map the physical and functional relationships between gene products. Metabolic pathway memberships and regulatory hierarchies are mapped using curated pathway databases and network analysis algorithms to identify the functional modules and regulatory cascades that coordinate cellular metabolism and signaling. Co-expression modules and functional gene clusters are analyzed using network clustering algorithms and correlation analysis to identify groups of genes that are coordinately regulated and functionally related. Signaling cascade dependencies and feedback loops are extracted through pathway analysis and regulatory network reconstruction to identify the dynamic regulatory relationships that control cellular responses to environmental stimuli and developmental signals.

The method proceeds to step 3404 where population-level evolutionary patterns are extracted to capture the evolutionary history and population genetics context that shapes genomic variation and functional constraint. Allele frequencies and Hardy-Weinberg equilibrium are computed across different populations to characterize the distribution of genetic variants and identify deviations from neutral evolutionary expectations that may indicate natural selection or population structure. Linkage disequilibrium patterns and haplotype blocks are analyzed to identify the correlated inheritance patterns that reflect population history, recombination patterns, and evolutionary processes. Phylogenetic distances and evolutionary conservation are calculated across multiple species to identify regions under evolutionary constraint and quantify the strength of purifying selection acting on different genomic elements. Signatures of natural selection and genetic drift are identified through population genetics statistics and evolutionary analysis to characterize the evolutionary forces that have shaped genomic variation and functional evolution.

At step 3405, cross-scale feature integration is performed to identify the relationships between biological phenomena at different scales and create unified representations that capture multi-scale biological organization. Nucleotide patterns are correlated with gene expression levels to identify sequence features that influence transcriptional regulation, mRNA stability, and translational efficiency. Gene variants are linked to pathway disruption signatures by analyzing how individual genetic variants affect pathway function, metabolic flux, and regulatory network dynamics. Population patterns are connected to functional constraint evolution by examining how evolutionary selection on functional elements varies across populations and evolutionary time scales. Multi-scale biomarkers and composite feature patterns are identified that combine information from multiple biological scales to create more robust and informative biological signatures for phenotype prediction and functional analysis.

The method includes validation procedures at step 3406 where biological coherence is assessed across all scales to ensure that the extracted features maintain meaningful biological relationships and functional consistency throughout the hierarchical representation. Consistency of functional annotations is verified at multiple levels by checking that gene-level functional classifications are compatible with pathway-level functional roles and population-level evolutionary constraints. Evolutionary relationships are checked for preservation across scales by validating that phylogenetic patterns observed at the sequence level are consistent with gene family evolution and population-level diversity patterns. Pathway integrity is validated from gene to population perspectives by ensuring that pathway-level functional relationships are supported by gene-level expression patterns and population-level evolutionary signatures. Clinical relevance coherence is assessed across genomic scales by verifying that clinically important variants maintain their functional significance across molecular, cellular, and population-level analyses.

At decision point 3407, the method evaluates whether biological coherence has been validated across all scales. If biological coherence validation fails, indicating inconsistencies in the multi-scale representation, the method branches to feature refinement procedures at step 3421 to adjust cross-scale relationships and improve biological consistency. If biological coherence is successfully validated, the method proceeds to importance scoring and embedding generation.

When biological coherence is validated, the method continues to step 3408 where multi-scale importance scores are computed to weight different biological features based on their functional impact, clinical relevance, and evolutionary significance. Nucleotide features may be weighted by functional impact predictions that assess how sequence variations affect protein function, gene regulation, and cellular processes. Gene features can be scored by pathway centrality and clinical relevance metrics that evaluate the importance of individual genes for pathway function, disease susceptibility, and therapeutic targeting. Pathway features may be evaluated by evolutionary conservation strength that reflects the degree of selective constraint and functional importance of different biological pathways across species and populations. Population features are assessed by medical genetics significance that quantifies the clinical utility and medical relevance of population-level genetic variation patterns.

At step 3409, hierarchical biological embeddings are generated that transform the multi-scale features into geometric representations suitable for manifold processing while preserving the biological relationships and functional dependencies at each scale. Nucleotide-level embeddings may be created that preserve local patterns including sequence motifs, regulatory elements, and structural features while maintaining the spatial relationships that determine functional interactions. Gene-level embeddings can be generated that maintain functional relationships including co-expression patterns, pathway memberships, and regulatory dependencies while preserving the hierarchical organization of gene function. Pathway-level embeddings may be produced that capture network topology including interaction patterns, regulatory hierarchies, and functional modules while maintaining the connectivity that determines pathway function. Population-level embeddings are constructed that reflect evolutionary history including phylogenetic relationships, population structure, and selection signatures while preserving the temporal and geographic patterns that shape genetic diversity.

The method continues to step 3410 where geometric transformation parameters are computed to enable the embedding of multi-scale biological features into a unified manifold representation that preserves biological meaning and enables efficient processing. According to an embodiment, curvature coefficients can be calculated according to R(x)=Σαᵢ·Fᵢ(x) where the weights αᵢ reflect the relative importance of different biological features Fᵢ(x) at each scale, creating a geometric encoding that reflects biological significance and functional density. Metric tensor components may be determined for biological distance preservation, ensuring that geometric distances in the manifold reflect meaningful biological relationships such as functional similarity, evolutionary relatedness, and regulatory connectivity. Embedding coordinates can be generated with scale-appropriate dimensionality that balances representational capacity with computational efficiency, using higher dimensions for complex biological relationships and lower dimensions for simpler patterns. Geometric consistency is validated across hierarchical levels to ensure that the transformation parameters create a mathematically valid manifold structure that preserves biological topology and enables meaningful geometric operations.

At step 3411, features are embedded into a nested manifold structure that organizes biological information according to its scale and functional context while maintaining cross-scale connectivity and biological coherence. Nucleotide features are placed in high-resolution local submanifolds that preserve fine-grained sequence patterns while enabling efficient access to local regulatory elements and functional motifs. Gene features are positioned in intermediate-scale functional regions that group genes according to their pathway memberships and regulatory relationships while maintaining the connectivity necessary for pathway-level analysis. Pathway features are located in broad connectivity network zones that organize biological pathways according to their functional relationships and regulatory interactions while preserving the hierarchical structure of cellular organization. Population features are situated in the global evolutionary landscape that reflects phylogenetic relationships and population structure while maintaining the temporal and geographic context necessary for evolutionary analysis.

The method proceeds to step 3412 where cross-scale geometric bridges are established to enable navigation between different levels of biological organization while preserving the functional relationships that connect phenomena at different scales. Geodesic connections are created between nucleotide and gene levels that enable efficient traversal from sequence features to gene-level functional properties while maintaining the biological relationships that link molecular details to cellular function. Pathway bridges are built that link genes to functional networks, enabling navigation from individual gene properties to pathway-level biological processes while preserving the regulatory relationships and functional dependencies that determine pathway behavior. Evolutionary bridges are constructed that connect pathways to population-level patterns, enabling analysis of how pathway evolution and population genetics interact to shape biological diversity and functional variation. Bridge connectivity is validated to preserve biological relationships by ensuring that cross-scale navigation maintains functional dependencies, evolutionary constraints, and regulatory relationships throughout the manifold structure.

At step 3413, manifold geometry is optimized for multi-scale access to ensure efficient navigation between biological scales while maintaining biological meaning and functional relationships. Local curvature is adjusted to reflect feature importance density, creating regions of high curvature around biologically important elements and flatter regions for less critical features. Geodesic path lengths are balanced between related cross-scale concepts to ensure that functionally related features at different scales maintain appropriate geometric proximity while preserving the hierarchical organization of biological knowledge. Compression pressure is minimized in high-traffic inter-scale regions to facilitate efficient navigation between scales during common biological analysis tasks while maintaining the resistance necessary to preserve important biological relationships. Biological constraint preservation is maximized during geometric optimization by ensuring that all geometric modifications respect known biological relationships, evolutionary constraints, and functional dependencies.

The method includes comprehensive validation at step 3414 where the embedded manifold structure is tested for biological fidelity to ensure that the geometric representation preserves essential biological relationships and functional dependencies across all scales. Known gene regulatory networks are tested for preservation by verifying that transcriptional regulatory relationships, protein-protein interactions, and metabolic network connections are maintained in the geometric representation. Phylogenetic distance relationships are verified for maintenance by checking that evolutionary relationships and conservation patterns are preserved in the manifold distances and geometric structure. Clinical variant-phenotype associations are checked for conservation by ensuring that medically relevant genetic variants maintain their associations with disease susceptibility, drug responses, and other clinically important phenotypes. Functional pathway integrity is assessed across embedded scales by validating that biological pathways maintain their internal coherence and external connectivity throughout the geometric representation.

At decision point 3415, the method evaluates whether manifold biological fidelity has been validated. If biological fidelity validation fails, indicating that the geometric representation has compromised essential biological relationships, the method branches to embedding adjustment procedures at step 3425 to modify the geometric parameters and improve biological preservation. If biological fidelity is successfully validated, the method proceeds to parameter generation and output production.

When biological fidelity is validated, the method continues to step 3416 where scale-aware compression parameters are generated that optimize data compression strategies for different biological scales while preserving the essential information required for meaningful biological analysis. Nucleotide-level compression rates are computed for sequence data based on the functional importance of different sequence regions, with higher preservation rates for regulatory elements, coding sequences, and functionally important motifs. Gene-level compression strategies are determined for functional elements that balance storage efficiency with preservation of functional annotations, expression patterns, and regulatory relationships. Pathway-level compression parameters are calculated for network data that maintain pathway connectivity and functional relationships while achieving efficient storage of interaction networks and regulatory hierarchies. Population-level compression rates are set for evolutionary information that preserve population genetics patterns, evolutionary signatures, and phylogenetic relationships while optimizing storage of large-scale population genetics datasets.

At step 3417, attention mechanisms are configured for scale navigation to enable efficient processing of multi-scale genomic information while maintaining the biological context necessary for meaningful analysis. Local attention is set up for nucleotide-level pattern recognition that focuses on sequence motifs, regulatory elements, and local structural features while maintaining the spatial context necessary for functional analysis. Functional attention is configured for gene-pathway relationship capture that emphasizes the regulatory connections, metabolic relationships, and signaling dependencies that determine biological function. Global attention is established for population-level pattern detection that captures evolutionary trends, population structure, and selection signatures while maintaining the temporal and geographic context necessary for evolutionary analysis. Cross-scale attention is implemented for hierarchical relationship maintenance that preserves the functional dependencies and biological relationships that connect phenomena at different biological scales.

The method proceeds to step 3418 where multi-scale manifold coordinates are output to provide the geometric representations necessary for subsequent processing within the persistent cognitive machine framework. Nucleotide-level coordinates are provided with local geometric context that preserves sequence patterns and regulatory relationships while enabling efficient local processing and analysis. Gene-level coordinates are supplied with functional relationship mapping that maintains pathway memberships, regulatory connections, and co-expression patterns while enabling gene-level analysis and interpretation. Pathway-level coordinates are generated with network topology preservation that maintains interaction networks, regulatory hierarchies, and functional modules while enabling pathway-level analysis and systems biology approaches. Population-level coordinates are delivered with evolutionary context that preserves phylogenetic relationships, population structure, and selection signatures while enabling population genetics analysis and evolutionary studies.

At decision point 3419, the method determines whether additional genomic scales require processing, enabling extension of the multi-scale representation to incorporate additional levels of biological organization as needed for specific applications. If additional genomic scales are present, the method returns to the beginning of the feature extraction process to incorporate the additional biological information. If no additional scales require processing, the method proceeds to integrated validation and optimization.

At step 3420, integrated manifold validation and optimization are performed to ensure that the complete multi-scale representation functions effectively for genomic analysis applications while maintaining biological accuracy and computational efficiency. Cross-scale consistency and biological relationship preservation are validated across the entire manifold structure to ensure that the hierarchical representation maintains functional dependencies and evolutionary relationships throughout all levels of biological organization. Geometric parameters are optimized for efficient multi-scale navigation by adjusting curvature patterns, geodesic path networks, and attention mechanisms to facilitate common biological analysis workflows while maintaining biological meaning. Manifold performance is tested with diverse genomic analysis workflows to validate that the multi-scale representation supports effective biological analysis, clinical applications, and research investigations. Comprehensive embedding quality and biological fidelity reports are generated to document the performance characteristics, biological validation results, and optimization outcomes achieved through the multi-scale embedding process.

The method includes feature refinement procedures beginning at step 3421 that are executed when biological coherence validation fails, implementing systematic optimization to improve cross-scale biological consistency while maintaining the functional relationships essential for meaningful genomic analysis. Cross-scale feature relationships are refined based on validation feedback by adjusting the correlations between nucleotide and gene features, modifying gene-pathway associations, and updating pathway-population links to enhance biological coherence. Nucleotide-gene correlations are adjusted to improve the consistency between sequence features and gene-level functional properties, ensuring that molecular details properly reflect cellular function. Gene-pathway associations are modified to enhance biological coherence by strengthening functionally relevant connections and reducing spurious associations that do not reflect genuine biological relationships. Pathway-population links are updated to enhance evolutionary consistency by ensuring that population-level patterns properly reflect the evolutionary constraints and selection pressures acting on biological pathways. Feature importance scores are rebalanced across biological scales to ensure that the relative weighting of different biological features reflects their actual contribution to biological function and clinical relevance.

At decision point 3422, the method evaluates whether maximum refinement iterations have been reached to prevent excessive optimization while allowing sufficient attempts to achieve biological coherence. If maximum iterations have not been reached, the method returns to step 3423 which directs the process back to step 3405 to repeat cross-scale feature integration with the refined parameters. If maximum iterations have been reached without achieving biological coherence, the method proceeds to step 3424 for documentation and partial processing.

At step 3424, biological coherence issues are documented while preserving successfully extracted features for partial embedding and downstream analysis. Specific cross-scale relationships that failed validation are recorded to identify the particular biological inconsistencies that could not be resolved through feature refinement. Successfully extracted features are preserved for partial embedding, enabling the system to proceed with the biological information that maintains coherence while documenting limitations in the multi-scale representation. Warnings are generated for downstream analysis about coherence limitations that alert users to potential issues in biological interpretation and analysis results. Recommendations are created for improved feature extraction methods that could address the identified coherence problems in future processing attempts.

The method includes embedding adjustment procedures at step 3425 that optimize manifold parameters when biological fidelity validation fails, implementing systematic geometric modifications to improve the preservation of biological relationships while maintaining computational efficiency. Curvature coefficients are modified to improve biological preservation by adjusting the geometric encoding of biological importance and functional relationships. Geometric transformation parameters are adjusted to enhance cross-scale connectivity by improving the mathematical mappings that preserve biological relationships across different scales. Embedding dimensions are recalibrated for optimal information preservation by balancing representational capacity with computational efficiency and biological interpretability. Biological constraint enforcement is updated during the embedding process by strengthening the validation procedures that ensure geometric operations preserve essential functional relationships and evolutionary patterns.

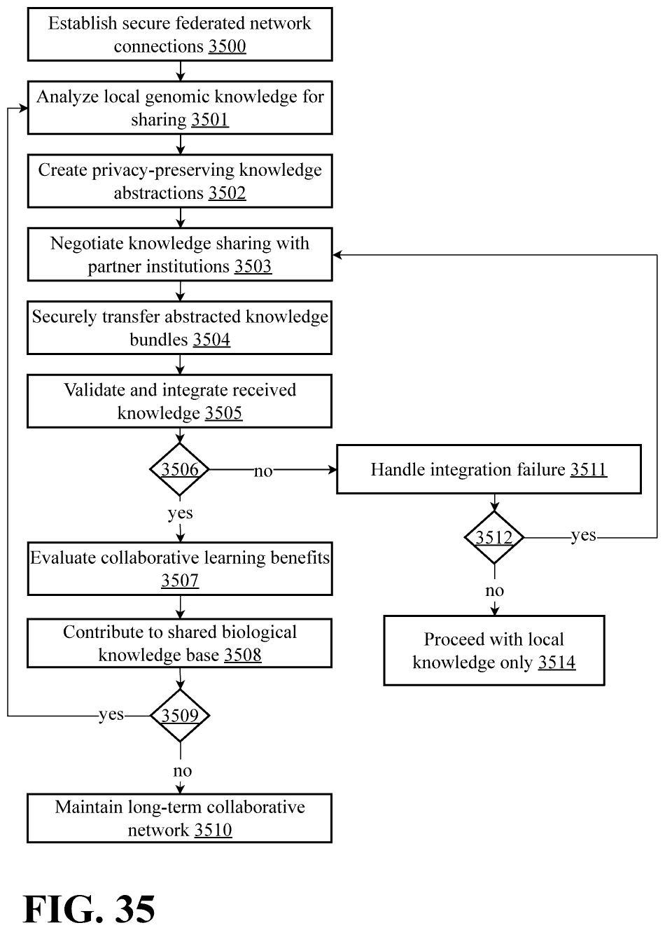

FIG. 35 is a flow diagram illustrating an exemplary method for federated genomic knowledge sharing across manifold instances that enables collaborative learning between multiple genomic processing systems while maintaining strict privacy protection and preserving the confidentiality of sensitive patient data. The method implements secure distributed learning protocols that allow genomic research institutions, clinical laboratories, and healthcare organizations to share biological insights and processing strategies without exposing individual genomic information or compromising patient privacy.

According to an embodiment, the process begins at step 3500 by establishing secure federated network connections that provide the cryptographic foundation necessary for safe knowledge exchange between participating institutions. Encrypted communication channels are set up between institutions using advanced cryptographic protocols including public key infrastructure, secure multi-party computation frameworks, and homomorphic encryption systems that enable computation on encrypted data without requiring decryption. Privacy protection protocols are configured specifically for genomic data that implement differential privacy mechanisms, k-anonymity guarantees, and geometric abstraction techniques that preserve biological meaning while preventing reconstruction of individual patient information. Consensus mechanisms are initialized for distributed learning that establish protocols for collaborative decision-making, knowledge validation, and conflict resolution across multiple participating institutions with potentially different data governance policies and privacy requirements.

At step 3501, local genomic knowledge is analyzed for sharing potential to identify biological patterns and processing strategies that could benefit the broader collaborative network while ensuring that sharing decisions respect privacy constraints and institutional policies. Biological patterns suitable for abstraction are identified including population-level genetic variations, pathway-level functional relationships, disease association patterns, and successful genomic processing strategies that can be generalized across different patient populations without revealing individual patient characteristics. Knowledge gaps are assessed that could benefit from collaboration by analyzing areas where local datasets lack sufficient diversity, coverage, or statistical power to draw robust conclusions, identifying opportunities where federated learning could provide access to broader biological patterns and improved analytical capabilities. Minimum privacy protection levels are determined based on the sensitivity of different types of biological information, regulatory requirements such as HIPAA and GDPR compliance, institutional policies regarding data sharing, and the specific characteristics of the genomic datasets including population demographics and clinical indications.

The method continues to step 3502 where privacy-preserving knowledge abstractions are created that capture essential biological information while protecting individual patient data through sophisticated anonymization and generalization techniques. Anonymized biological pattern summaries are generated that aggregate individual patient data into population-level statistics, pathway-level functional relationships, and disease association patterns that preserve biological meaning while preventing identification of specific individuals or reconstruction of personal genomic information. Successful genomic processing strategies are abstracted by documenting compression algorithms, manifold optimization approaches, and biological validation techniques that have proven effective in local processing without revealing the specific datasets or patient characteristics that led to these insights. Individual patient data is protected through geometric generalization by transforming specific genomic coordinates into abstract geometric regions, converting precise biological measurements into statistical distributions, and replacing individual genetic variants with population-level frequency patterns that maintain biological utility while ensuring privacy protection.

At step 3503, knowledge sharing negotiations are conducted with partner institutions to establish mutual agreements that balance the benefits of collaboration with the requirements for privacy protection and regulatory compliance. Available knowledge catalogs are exchanged with sharing partners to identify potential areas for collaboration, assess the complementary nature of different institutional datasets, and determine the biological value that could be achieved through federated learning approaches. Privacy protection levels and abstraction requirements are agreed upon through negotiations that consider the sensitivity of different data types, regulatory constraints that apply to each institution, and the minimum level of biological detail necessary to achieve meaningful collaborative benefits. Mutual benefit agreements are established for knowledge exchange that define the specific biological insights to be shared, the privacy protection mechanisms to be employed, the evaluation criteria for measuring collaborative success, and the protocols for handling disputes or privacy concerns that may arise during the collaboration process.

The method proceeds to step 3504 where abstracted knowledge bundles are securely transferred between institutions using cryptographic protocols that ensure data protection throughout the transmission and integration process. Anonymized biological insights are transmitted between institutions using secure communication channels that protect against interception, tampering, or unauthorized access while preserving the biological content necessary for meaningful collaboration. Successful compression strategies are shared without exposing underlying data by documenting algorithmic approaches, parameter optimization techniques, and validation methodologies that have proven effective in local processing environments. Manifold optimization approaches are exchanged with privacy guarantees by sharing geometric transformation strategies, curvature optimization techniques, and biological constraint enforcement methods that can improve processing efficiency while maintaining the confidentiality of the specific datasets used to develop these approaches.

At step 3505, received knowledge is validated and integrated into local genomic processing systems through careful compatibility assessment and biological coherence verification. Biological coherence of external knowledge is verified by checking consistency with established biological principles, validating against local biological databases and literature, and ensuring that shared insights maintain meaningful biological interpretation when applied to local datasets. Compatibility with local manifold structure is checked by assessing whether external geometric representations can be integrated with local coordinate systems, validating that shared optimization strategies are applicable to local processing requirements, and ensuring that federated knowledge enhances rather than disrupts existing biological relationships. Validated insights are integrated into local genomic processing by updating manifold structures with new biological patterns, incorporating improved compression strategies into local algorithms, and enhancing biological validation procedures based on collaborative learning outcomes.

At decision point 3506, the method evaluates whether knowledge integration has been successful through comprehensive assessment of biological coherence, computational compatibility, and privacy preservation. If knowledge integration is unsuccessful, indicating incompatibilities between shared knowledge and local systems or failures in privacy protection, the method branches to integration failure handling procedures at step 3511. If integration is successful, demonstrating that federated knowledge enhances local capabilities while maintaining privacy and biological validity, the method proceeds to benefit evaluation and continued collaboration.

When integration is successful, the method continues to step 3507 where collaborative learning benefits are evaluated to quantify the improvements achieved through federated knowledge sharing and document the value of collaborative approaches for genomic research and clinical applications. Improvements in genomic processing accuracy are measured by comparing pre- and post-collaboration performance metrics including compression efficiency, reconstruction quality, biological relationship preservation, and clinical prediction accuracy. Expansion of biological knowledge coverage is assessed by evaluating how federated learning has enabled analysis of previously inaccessible biological patterns, enhanced understanding of population diversity, and improved representation of rare diseases or genetic variants. Enhanced clinical insights from federated knowledge are documented by identifying new diagnostic capabilities, improved therapeutic target identification, enhanced pharmacogenomic predictions, and better understanding of disease mechanisms that result from collaborative analysis of diverse genomic datasets.

At step 3508, local institutions contribute to the shared biological knowledge base to support the ongoing development of collaborative genomic research capabilities and ensure that all participants benefit from the collective advancement of biological understanding. Validated insights are submitted to the federated knowledge repository including novel biological patterns discovered through local analysis, successful processing strategies that could benefit other institutions, and clinical insights that enhance the collective understanding of genetic diseases and therapeutic responses. Participation in consensus formation for genomic patterns involves collaborative validation of biological discoveries, joint development of standardized analysis protocols, and coordinated efforts to establish community-wide best practices for genomic data processing and interpretation. Successful strategies are shared with the collaborative network including algorithmic innovations, optimization techniques, and biological validation approaches that have proven effective in local environments and could enhance the capabilities of partner institutions.

At decision point 3509, the method determines whether continued federated learning should proceed based on the success of current collaboration efforts and the availability of additional opportunities for knowledge sharing. If continued collaboration is beneficial, the method returns to step 3501 to begin another cycle of knowledge analysis and sharing. If collaboration objectives have been achieved or if institutional priorities have changed, the method proceeds to long-term network maintenance procedures.

When continued learning is not selected, the method proceeds to step 3510 where long-term collaborative network maintenance ensures the sustainability and continuous improvement of federated genomic research capabilities. Successful collaboration outcomes and strategies are archived to preserve institutional knowledge about effective federated learning approaches, document best practices for privacy-preserving collaboration, and maintain historical records of collaborative achievements for future reference. Network partnerships are updated based on collaboration effectiveness by strengthening relationships with highly productive partners, identifying opportunities for new collaborative arrangements, and optimizing network topology to enhance future knowledge sharing efficiency. Privacy protection mechanisms are optimized for future knowledge sharing by incorporating lessons learned from current collaboration experiences, implementing enhanced security measures based on emerging threats, and updating protocols to comply with evolving regulatory requirements and institutional policies.

The method includes integration failure handling procedures beginning at step 3511 that address situations where external knowledge cannot be successfully integrated into local systems due to compatibility issues, privacy concerns, or biological inconsistencies. Integration failure analysis examines the specific reasons why knowledge sharing was unsuccessful including incompatibilities between geometric representations, conflicts between biological validation criteria, insufficient privacy protection in shared abstractions, or technical limitations in integration protocols. Alternative abstraction formats are requested from partners to address identified compatibility issues by modifying geometric representations, adjusting biological abstraction levels, enhancing privacy protection mechanisms, or reformatting knowledge bundles to match local system requirements. Compatibility issues are documented for future improvements by recording specific technical problems, identifying potential solutions for similar situations, and developing enhanced protocols for knowledge compatibility assessment and integration.

At decision point 3512, the method determines whether retry attempts with modified parameters should be undertaken based on the analysis of integration failure causes and the availability of alternative approaches. If retry is warranted, the method returns to step 3503 to restart knowledge sharing negotiations with modified requirements and improved compatibility protocols. If retry attempts are not feasible or have been exhausted, the method proceeds to local-only processing while maintaining network connectivity for future opportunities.

At step 3514, local knowledge processing continues independently when federated collaboration cannot be achieved, ensuring that institutional genomic analysis capabilities are maintained even when collaborative approaches are not available. Genomic processing continues using local knowledge exclusively by applying institutional datasets, local biological expertise, and internal validation procedures to maintain analytical capabilities and support ongoing research and clinical activities. Network connections are maintained for future collaboration opportunities by preserving communication channels with partner institutions, monitoring developments in federated learning technologies, and remaining available for future collaborative projects when circumstances become more favorable. Recommendations are generated for improved knowledge compatibility including technical modifications that could enhance future collaboration success, policy changes that might facilitate knowledge sharing, and research directions that could address current limitations in federated genomic analysis.

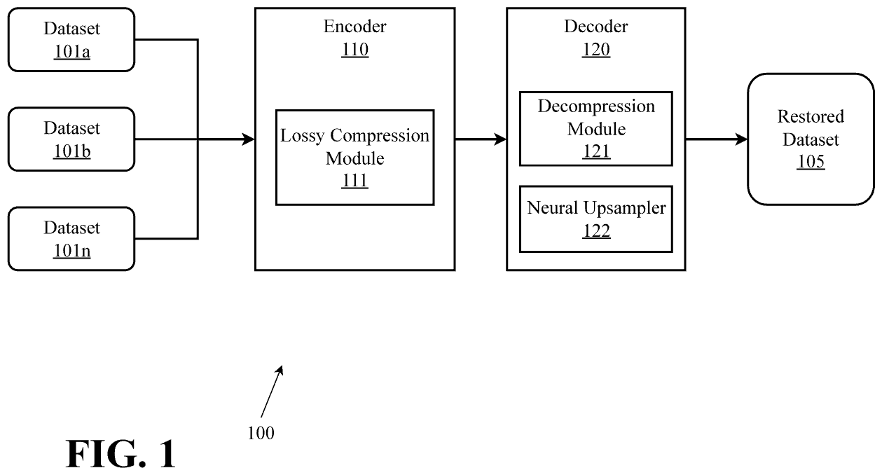

FIG. 1 is a block diagram illustrating an exemplary system architecture 100 for upsampling of decompressed data after lossy compression using a neural network, according to an embodiment. According to the embodiment, the system 100 comprises an encoder module 110 configured to receive two or more datasets 101a-n which are substantially correlated and perform lossy compression on the received dataset, and a decoder module 120 configured to receive a compressed bit stream and use a trained neural network to output a reconstructed dataset which can restore most of the “lost” data due to the lossy compression. Datasets 101a-n may comprise streaming data or data received in a batch format. Datasets 101a-n may comprise one or more datasets, data streams, data files, or various other types of data structures which may be compressed. Furthermore, dataset 101a-n may comprise n-channel data comprising a plurality of data channels sent via a single data stream.

Encoder 110 may utilize a lossy compression module 111 to perform lossy compression on a received dataset 101a-n. The type of lossy compression implemented by lossy compression module 111 may be dependent upon the data type being processed. For example, for SAR imagery data, High Efficiency Video Coding (HEVC) may be used to compress the dataset. In another example, if the data being processed is time-series data, then delta encoding may be used to compress the dataset. The encoder 110 may then send the compressed data as a compressed data stream to a decoder 120 which can receive the compressed data stream and decompress the data using a decompression module 121.

The decompression module 121 may be configured to perform data decompression a compressed data stream using an appropriate data decompression algorithm. The decompressed data may then be used as input to a neural upsampler 122 which utilizes a trained neural network to restore the decompressed data to nearly its original state 105 by taking advantage of the information embedded in the correlation between the two or more datasets 101a-n.

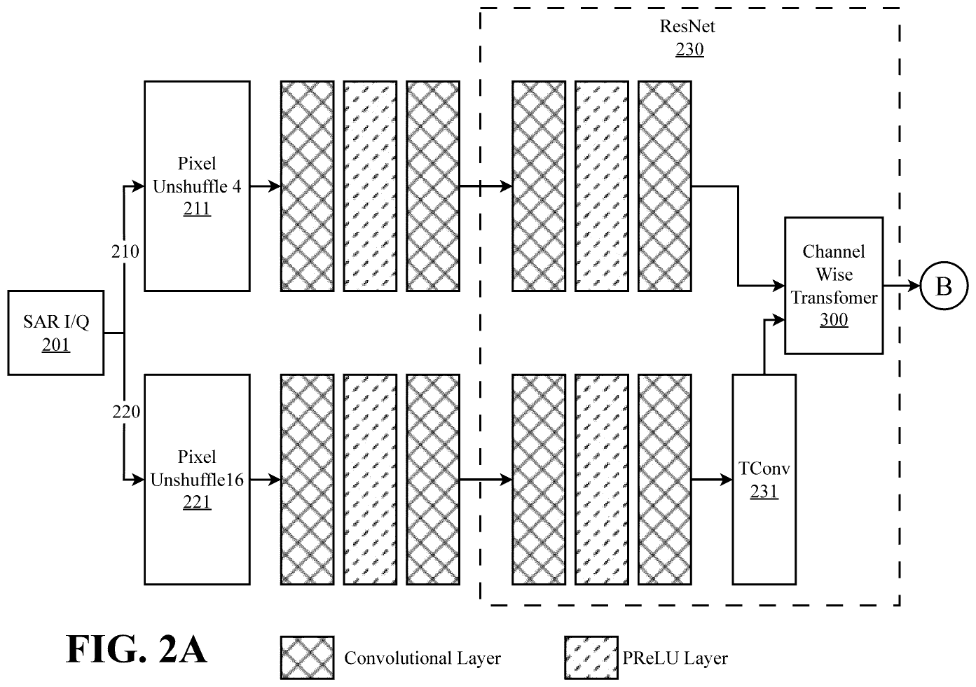

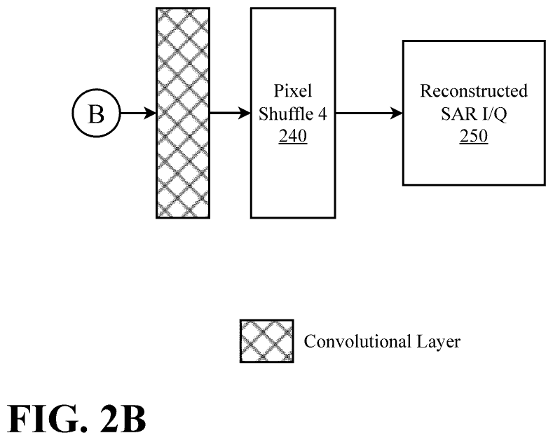

FIGS. 2A and 2B illustrate an exemplary architecture for an AI deblocking network configured to provide deblocking for dual-channel data stream comprising SAR I/Q data, according to an embodiment. In the context of this disclosure, dual-channel data refers to fact that SAR image signal can be represented as two (dual) components (i.e., I and Q) which are correlated to each other in some manner. In the case of I and Q, their correlation is that they can be transformed into phase and amplitude information and vice versa. AI deblocking network utilizes a deep learned neural network architecture for joint frequency and pixel domain learning. According to the embodiment, a network may be developed for joint learning across one or more domains. As shown, the top branch 210 is associated with the pixel domain learning and the bottom branch 220 is associated with the frequency domain learning. According to the embodiment, the AI deblocking network receives as input complex-valued SAR image I and Q channels 201 which, having been encoded via encoder 110, has subsequently been decompressed via decoder 120 before being passed to AI deblocking network for image enhancement via artifact removal. Inspired by the residual learning network and the MSAB attention mechanism, AI deblocking network employs resblocks that take two inputs. In some implementations, to reduce complexity the spatial resolution may be downsampled to one-half and one-fourth. During the final reconstruction the data may be upsampled to its original resolution. In one implementation, in addition to downsampling, the network employs deformable convolution to extract initial features, which are then passed to the resblocks. In an embodiment, the network comprises one or more resblocks and one or more convolutional filters. In an embodiment, the network comprises 8 resblocks and 64 convolutional filters.

Deformable convolution is a type of convolutional operation that introduces spatial deformations to the standard convolutional grid, allowing the convolutional kernel to adaptively sample input features based on the learned offsets. It's a technique designed to enhance the modeling of spatial relationships and adapt to object deformations in computer vision tasks. In traditional convolutional operations, the kernel's positions are fixed and aligned on a regular grid across the input feature map. This fixed grid can limit the ability of the convolutional layer to capture complex transformations, non-rigid deformations, and variations in object appearance. Deformable convolution aims to address this limitation by introducing the concept of spatial deformations. Deformable convolution has been particularly effective in tasks like object detection and semantic segmentation, where capturing object deformations and accurately localizing object boundaries are important. By allowing the convolutional kernels to adaptively sample input features from different positions based on learned offsets, deformable convolution can improve the model's ability to handle complex and diverse visual patterns.

According to an embodiment, the network may be trained as a two stage process, each utilizing specific loss functions. During the first stage, a mean squared error (MSE) function is used in the I/Q domain as a primary loss function for the AI deblocking network. The loss function of the SAR I/Q channel L_{SAR} is defined as:

$${L}_{SAR} = 𝔼 [ {‖ I - {I}_{amp} ‖}_{2} ]$$

Moving to the second stage, the network reconstructs the amplitude component and computes the amplitude loss using MSE as follows:

$${L}_{SAR} = 𝔼 [ {‖ {I}_{amp} - {I}_{dec , amp} ‖}_{2} ]$$

To calculate the overall loss, the network combines the SAR loss and the amplitude loss, incorporating a weighting factor, α, for the amplitude loss. The total loss is computed as:

$${L}_{total} = {L}_{SAR} + α \times {L}_{amp}$$

The weighting factor value may be selected based on the dataset used during network training. In an embodiment, the network may be trained using two different SAR datasets: the National Geospatial-Intelligence Agency (NGA) SAR dataset and the Sandia National Laboratories Mini SAR Complex Imagery dataset, both of which feature complex-valued SAR images. In an embodiment, the weighting factor is set to 0.0001 for the NGA dataset and 0.00005 for the Sandia dataset. By integrating both the SAR and amplitude losses in the total loss function, the system effectively guides the training process to simultaneously address the removal of the artifacts and maintain the fidelity of the amplitude information. The weighting factor, α, enables AI deblocking network to balance the importance of the SAR loss and the amplitude loss, ensuring comprehensive optimization of the network during the training stages. In some implementations, diverse data augmentation techniques may be used to enhance the variety of training data. For example, techniques such as horizontal and vertical flops and rotations may be implemented on the training dataset. In an embodiment, model optimization is performed using MSE loss and Adam optimizer with a learning rate initially set to 1×10⁻⁴ and decreased by a factor of 2 at epochs 100, 200, and 250, with a total of 300 epochs. In an implementation, the batch size is set to 256×256 with each batch containing 16 images.

Both branches first pass through a pixel unshuffling layer 211, 221 which implements a pixel unshuffling process on the input data. Pixel unshuffling is a process used in image processing to reconstruct a high-resolution image from a low-resolution image by rearranging or “unshuffling” the pixels. The process can involve the following steps, low-resolution input, pixel arrangement, interpolation, and enhancement. The input to the pixel unshuffling algorithm is a low-resolution image (i.e., decompressed, quantized SAR I/Q data). This image is typically obtained by downscaling a higher-resolution image such as during the encoding process executed by encoder 110. Pixel unshuffling aims to estimate the original high-resolution pixel values by redistributing and interpolating the low-resolution pixel values. The unshuffling process may involve performing interpolation techniques, such as nearest-neighbor, bilinear, or more sophisticated methods like bicubic or Lanczos interpolation, to estimate the missing pixel values and generate a higher-resolution image.

The output of the unshuffling layers 211, 221 may be fed into a series of layers which can include one or more convolutional layers and one or more parametric rectified linear unit (PReLU) layers. A legend is depicted for both FIG. 2A and FIG. 2B which indicates the cross hatched block represents a convolutional layer and the dashed block represents a PReLU layer. Convolution is the first layer to extract features from an input image. Convolution preserves the relationship between pixels by learning image features using small squares of input data. It is a mathematical operation that takes two inputs such as an image matrix and a filter or kernel. The embodiment features a cascaded ResNet-like structure comprising 8 ResBlocks to effectively process the input data. The filter size associated with each convolutional layer may be different. The filter size used for the pixel domain of the top branch may be different than the filter size used for the frequency domain of the bottom branch.

A PReLU layer is an activation function used in neural networks. The PReLU activation function extends the ReLU by introducing a parameter that allows the slope for negative values to be learned during training. The advantage of PReLU over ReLU is that it enables the network to capture more complex patterns and relationships in the data. By allowing a small negative slope for the negative inputs, the PReLU can learn to handle cases where the output should not be zero for all negative values, as is the case with the standard ReLU. In other implementations, other non-linear functions such as tanh or sigmoid can be used instead of PReLU.

After passing through a series of convolutional and PReLU layers, both branches enter the resnet 230 which further comprises more convolutional and PReLU layers. The frequency domain branch is slightly different than the pixel domain branch once inside ResNet 230, specifically the frequency domain is processed by a transposed convolutional (TConv) layer 231. Transposed convolutions are a type of operation used in neural networks for tasks like image generation, image segmentation, and upsampling. They are used to increase the spatial resolution of feature maps while maintaining the learned relationships between features. Transposed convolutions aim to increase spatial dimensions of feature maps, effectively “upsampling” them. This is typically done by inserting zeros (or other values) between existing values to create more space for new values.

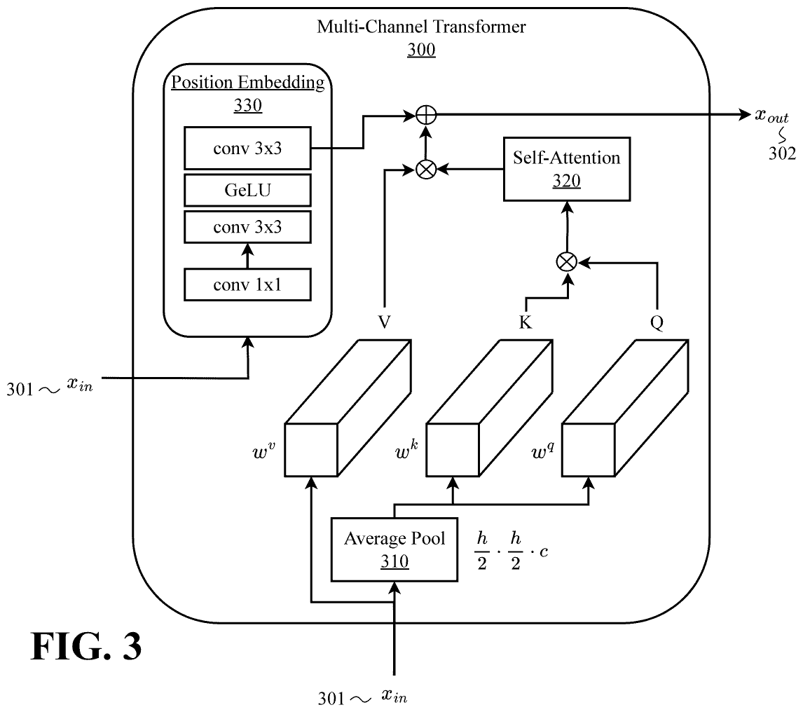

Inside ResBlock 230 the data associated with the pixel and frequency domains are combined back into a single stream by using the output of the Tconv 231 and the output of the top branch. The combined data may be used as input for a channel-wise transformer 300. In some embodiments, the channel-wise transformer may be implemented as a multi-scale attention block utilizing the attention mechanism. For more detailed information about the architecture and functionality of channel-wise transformer 300 refer to FIG. 3. The output of channel-wise transformer 300 may be a bit stream suitable for reconstructing the original SAR I/Q image. FIG. 2B shows the output of ResBlock 230 is passed through a final convolutional layer before being processed by a pixel shuffle layer 240 which can perform upsampling on the data prior to image reconstruction. The output of the AI deblocking network may be passed through a quantizer 124 for dequantization prior to producing a reconstructed SAR I/Q image 250.

FIG. 3 is a block diagram illustrating an exemplary architecture for a component of the system for SAR image compression, the channel-wise transformer 300. According to the embodiment, channel-wise transformer receives an input signal, Xin 301, the input signal comprising SAR I/Q data which is being processed by AI deblocking network 123. The input signal may be copied and follow two paths through multi-channel transformer 300.

A first path may process input data through a position embedding module 330 comprising series of convolutional layers as well as a Gaussian Error Linear Unit (GeLU). In traditional recurrent neural networks or convolutional neural networks, the order of input elements is inherently encoded through the sequential or spatial nature of these architectures. However, in transformer-based models, where the attention mechanism allows for non-sequential relationships between tokens, the order of tokens needs to be explicitly conveyed to the model. Position embedding module 330 may represent a feedforward neural network (position-wise feedforward layers) configured to add position embeddings to the input data to convey the spatial location or arrangement of pixels in an image. The output of position embedding module 330 may be added to the output of the other processing path the received input signal is processed through.

A second path may process the input data. It may first be processed via a channel-wise configuration and then through a self-attention layer 320. The signal may be copied/duplicated such that a copy of the received signal is passed through an average pool layer 310 which can perform a downsampling operation on the input signal. It may be used to reduce the spatial dimensions (e.g., width and height) of feature maps while retaining the most important information. Average pooling functions by dividing the input feature map into non-overlapping rectangular or square regions (often referred to as pooling windows or filters) and replacing each region with the average of the values within that region. This functions to downsample the input by summarizing the information within each pooling window.

Self-attention layer 320 may be configured to provide an attention to AI deblocking network 123. The self-attention mechanism, also known as intra-attention or scaled dot-product attention, is a fundamental building block used in various deep learning models, particularly in transformer-based models. It plays a crucial role in capturing contextual relationships between different elements in a sequence or set of data, making it highly effective for tasks involving sequential or structured data like complex-valued SAR I/Q channels. Self-attention layer 320 allows each element in the input sequence to consider other elements and weigh their importance based on their relevance to the current element. This enables the model to capture dependencies between elements regardless of their positional distance, which is a limitation in traditional sequential models like RNNs and LSTMs.

The input 301 and downsampled input sequence is transformed into three different representations: Query (Q), Key (K), and Value (V). These transformations (w^{V}, w^{K}, and w^{Q}) are typically linear projections of the original input. For each element in the sequence, the dot product between its Query and the Keys of all other elements is computed. The dot products are scaled by a factor to control the magnitude of the attention scores. The resulting scores may be normalized using a softmax function to get attention weights that represent the importance of each element to the current element. The Values (V) of all elements are combined using the attention weights as coefficients. This produces a weighted sum, where elements with higher attention weights contribute more to the final representation of the current element. The weighted sum is the output of the self-attention mechanism for the current element. This output captures contextual information from the entire input sequence.

The output of the two paths (i.e., position embedding module 330 and self-attention layer 320) may be combined into a single output data stream xₒᵤₜ 302.

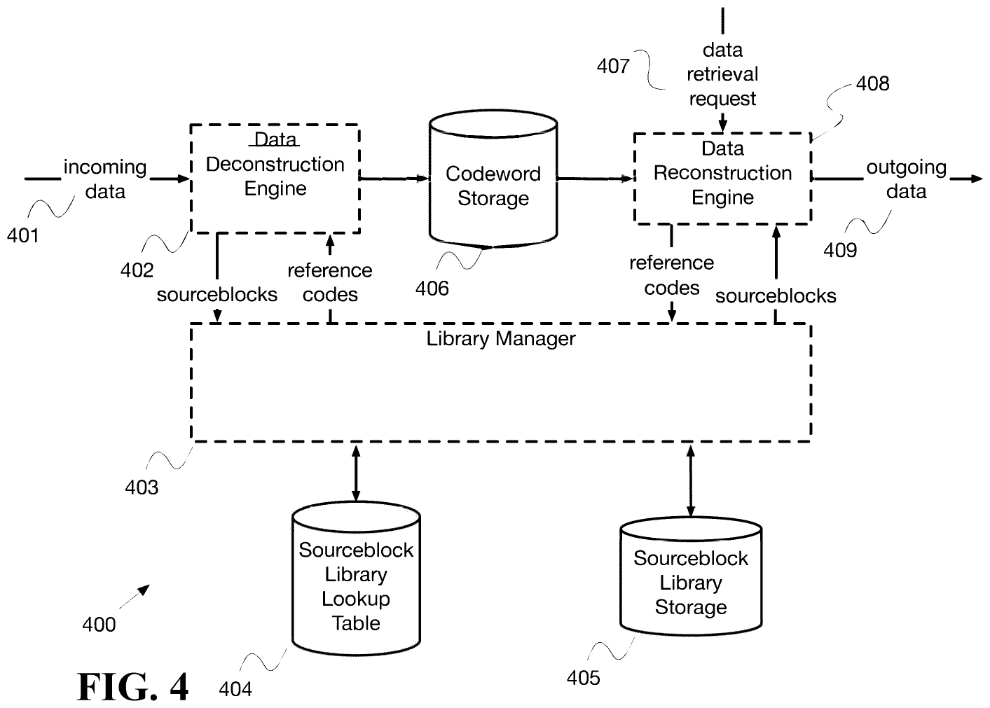

FIG. 4 is a block diagram illustrating an exemplary system architecture 400 for providing lossless data compaction, according to an embodiment. As incoming data 401 is received by data deconstruction engine 402. Data deconstruction engine 402 breaks the incoming data into sourceblocks, which are then sent to library manager 403. Using the information contained in sourceblock library lookup table 404 and sourceblock library storage 405, library manager 403 returns reference codes to data deconstruction engine 402 for processing into codewords, which are stored in codeword storage 106. When a data retrieval request 407 is received, data reconstruction engine 408 obtains the codewords associated with the data from codeword storage 406, and sends them to library manager 403. Library manager 403 returns the appropriate sourceblocks to data reconstruction engine 408, which assembles them into the proper order and sends out the data in its original form 409.

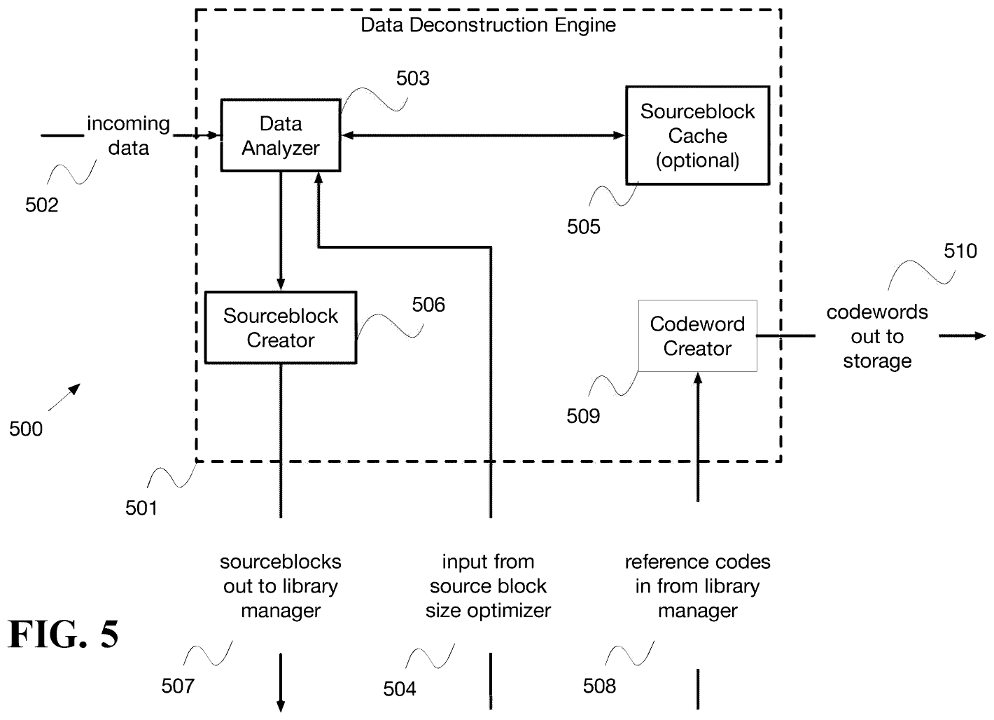

FIG. 5 is a diagram showing an embodiment of one aspect 500 of the system, specifically data deconstruction engine 501. Incoming data 502 is received by data analyzer 503, which optimally analyzes the data based on machine learning algorithms and input 504 from a sourceblock size optimizer, which is disclosed below. Data analyzer may optionally have access to a sourceblock cache 505 of recently processed sourceblocks, which can increase the speed of the system by avoiding processing in library manager 403. Based on information from data analyzer 503, the data is broken into sourceblocks by sourceblock creator 506, which sends sourceblocks 507 to library manager 403 for additional processing. Data deconstruction engine 501 receives reference codes 508 from library manager 403, corresponding to the sourceblocks in the library that match the sourceblocks sent by sourceblock creator 506, and codeword creator 509 processes the reference codes into codewords comprising a reference code to a sourceblock and a location of that sourceblock within the data set. The original data may be discarded, and the codewords representing the data are sent out to storage 510.

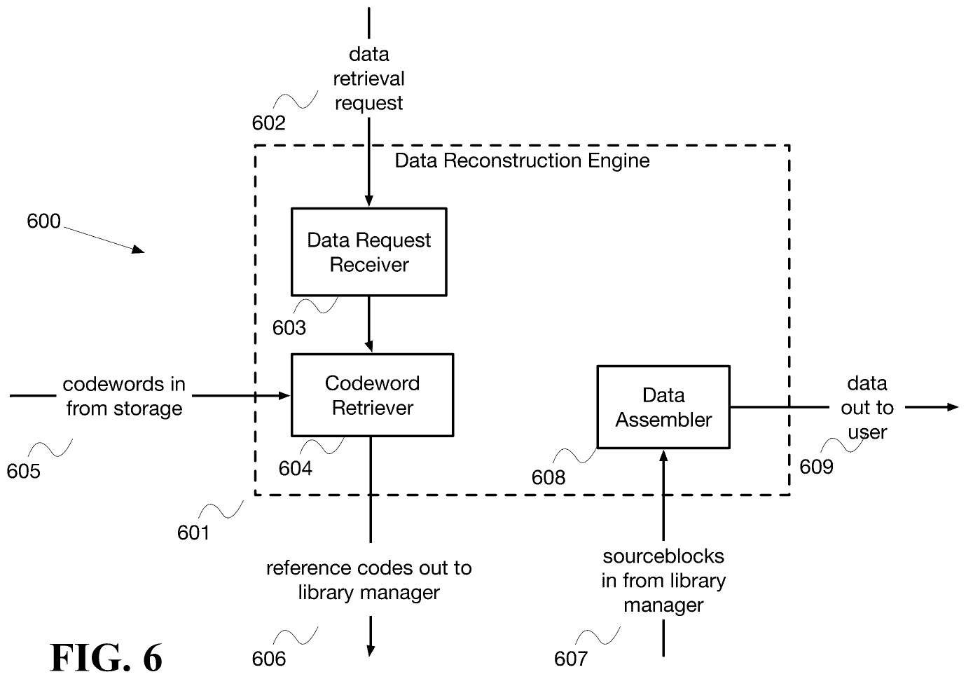

FIG. 6 is a diagram showing an embodiment of another aspect of system 600, specifically data reconstruction engine 601. When a data retrieval request 602 is received by data request receiver 603 (in the form of a plurality of codewords corresponding to a desired final data set), it passes the information to data retriever 604, which obtains the requested data 605 from storage. Data retriever 604 sends, for each codeword received, a reference codes from the codeword 606 to library manager 403 for retrieval of the specific sourceblock associated with the reference code. Data assembler 608 receives the sourceblock 607 from library manager 403 and, after receiving a plurality of sourceblocks corresponding to a plurality of codewords, assembles them into the proper order based on the location information contained in each codeword (recall each codeword comprises a sourceblock reference code and a location identifier that specifies where in the resulting data set the specific sourceblock should be restored to. The requested data is then sent to user 609 in its original form.

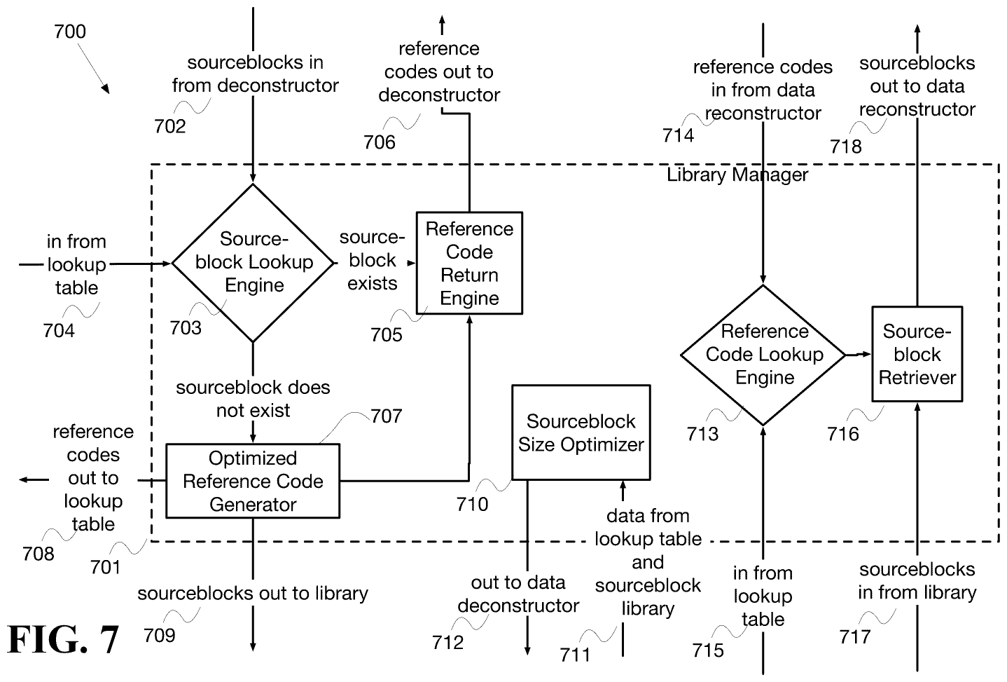

FIG. 7 is a diagram showing an embodiment of another aspect of the system 700, specifically library manager 701. One function of library manager 701 is to generate reference codes from sourceblocks received from data deconstruction engine 701. As sourceblocks are received 702 from data deconstruction engine 501, sourceblock lookup engine 703 checks sourceblock library lookup table 704 to determine whether those sourceblocks already exist in sourceblock library storage 705. If a particular sourceblock exists in sourceblock library storage 105, reference code return engine 705 sends the appropriate reference code 706 to data deconstruction engine 601. If the sourceblock does not exist in sourceblock library storage 105, optimized reference code generator 407 generates a new, optimized reference code based on machine learning algorithms. Optimized reference code generator 707 then saves the reference code 708 to sourceblock library lookup table 704; saves the associated sourceblock 709 to sourceblock library storage 105; and passes the reference code to reference code return engine 705 for sending 706 to data deconstruction engine 501. Another function of library manager 701 is to optimize the size of sourceblocks in the system. Based on information 711 contained in sourceblock library lookup table 404, sourceblock size optimizer 410 dynamically adjusts the size of sourceblocks in the system based on machine learning algorithms and outputs that information 712 to data analyzer 603. Another function of library manager 701 is to return sourceblocks associated with reference codes received from data reconstruction engine 601. As reference codes are received 714 from data reconstruction engine 601, reference code lookup engine 713 checks sourceblock library lookup table 715 to identify the associated sourceblocks; passes that information to sourceblock retriever 716, which obtains the sourceblocks 717 from sourceblock library storage 405; and passes them 718 to data reconstruction engine 601.

### Detailed Description of Exemplary Aspects

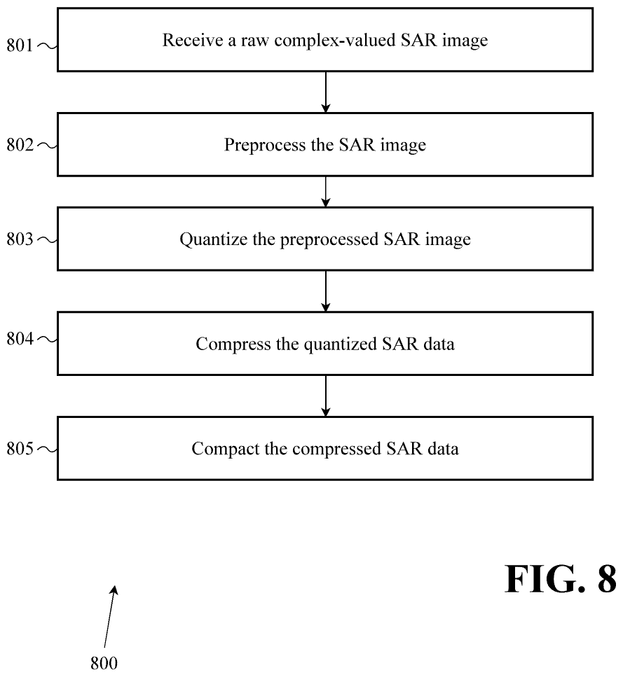

FIG. 8 is a flow diagram illustrating an exemplary method 800 for complex-valued SAR image compression, according to an embodiment. According to the embodiment, the process begins at step 801 when encoder 110 receives a raw complex-valued SAR image. The complex-valued SAR image comprises both I and Q components. In some embodiments, the I and Q components may be processed as separate channels. At step 802, the received SAR image may be preprocessed for further processing by encoder 110. For example, the input image may be clipped or otherwise transformed in order to facilitate further processing. As a next step 803, the preprocessed data may be passed to quantizer 112 which quantizes the data. The next step 804, comprises compressing the quantized SAR data using a compression algorithm known to those with skill in the art. In an embodiment, the compression algorithm may comprise HEVC encoding for both compression and decompression of SAR data. As a last step 805, the compressed data may be compacted. The compaction may be a lossless compaction technique, such as those described with reference to FIGS. 4-7. The output of method 800 is a compressed, compacted bit stream of SAR image data which can be stored in a database, requiring much less storage space than would be required to store the original, raw SAR image. The compressed and compacted bit stream may be transmitted to an endpoint for storage or processing. Transmission of the compressed and compacted data require less bandwidth and computing resources than transmitting raw SAR image data.

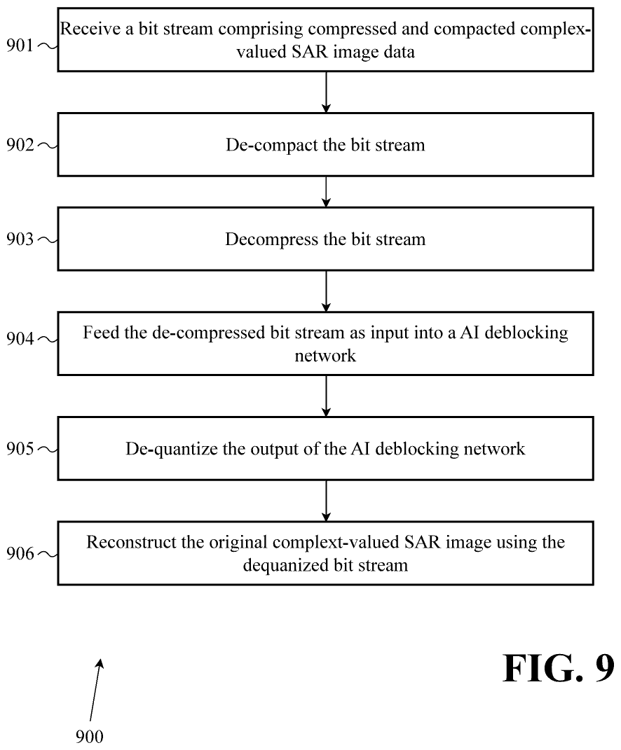

FIG. 9 is a flow diagram illustrating and exemplary method 900 for decompression of a complex-valued SAR image, according to an embodiment. According to the embodiment, the process begins at step 901 when decoder 120 receives a bit stream comprising compressed and compacted complex-valued SAR image data. The compressed bit stream may be received from encoder 110 or from a suitable data storage device. At step 902, the received bit stream is first de-compacted to produce an encoded (compressed) bit stream. In some embodiments, data reconstruction engine 601 may be implemented as a system for de-compacting a received bit stream. The next step 903, comprising decompressing the de-compacted bit stream using a suitable compression algorithm known to those with skill in the art, such as HEVC encoding. At step 904, the de-compressed SAR data may be fed as input into AI deblocking network 123 for image enhancement via a trained deep learning network. The AI deblocking network may utilize a series of convolutional layers and/or ResBlocks to process the input data and perform artifact removal on the de-compressed SAR image data. AI deblocking network may be further configured to implement an attention mechanism for the model to capture dependencies between elements regardless of their positional distance. In an embodiment, during training of AI deblocking network, the amplitude loss in conjunction with the SAR loss may be computed and accounted for, further boosting the compression performance of system 100. The output of AI deblocking network 123 can be sent to a quantizer 124 which can execute step 905 by de-quantizing the output bit stream from AI deblocking network. As a last step 906, system can reconstruct the original complex-valued SAR image using the de-quantized bit stream.

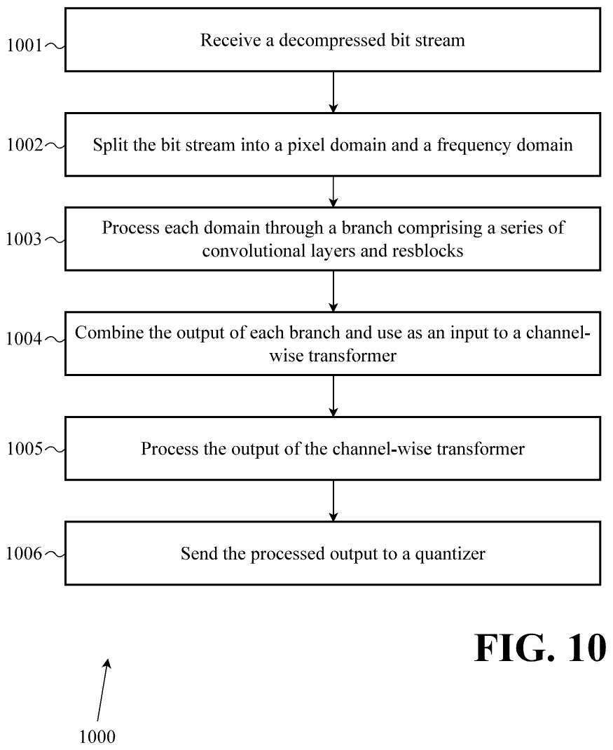

FIG. 10 is a flow diagram illustrating an exemplary method for deblocking using a trained deep learning algorithm, according to an embodiment. According to the embodiment, the process begins at step 1001 wherein the trained deep learning algorithm (i.e., AI deblocking network 123) receives a decompressed bit stream comprising SAR I/Q image data. At step 1002, the bit stream is split into a pixel domain and a frequency domain. Each domain may pass through AI deblocking network, but have separate, almost similar processing paths. As a next step 1003, each domain is processed through its respective branch, the branch comprising a series of convolutional layers and ResBlocks. In some implementations, frequency domain may be further processed by a transpose convolution layer. The two branches are combined and used as input for a multi-channel transformer with attention mechanism at step 1004. Multi-channel transformer 300 may perform functions such as downsampling, positional embedding, and various transformations, according to some embodiments. Multi-channel transformer 300 may comprise one or more of the following components: channel-wise attention, transformer self-attention, and/or feedforward layers. In an implementation, the downsampling may be performed via average pooling. As a next step 1005, the AI deblocking network processes the output of the channel-wise transformer. The processing may include the steps of passing the output through one or more convolutional or PReLU layers and/or upsampling the output. As a last step 1006, the processed output may be forwarded to quantizer 124 or some other endpoint for storage or further processing.

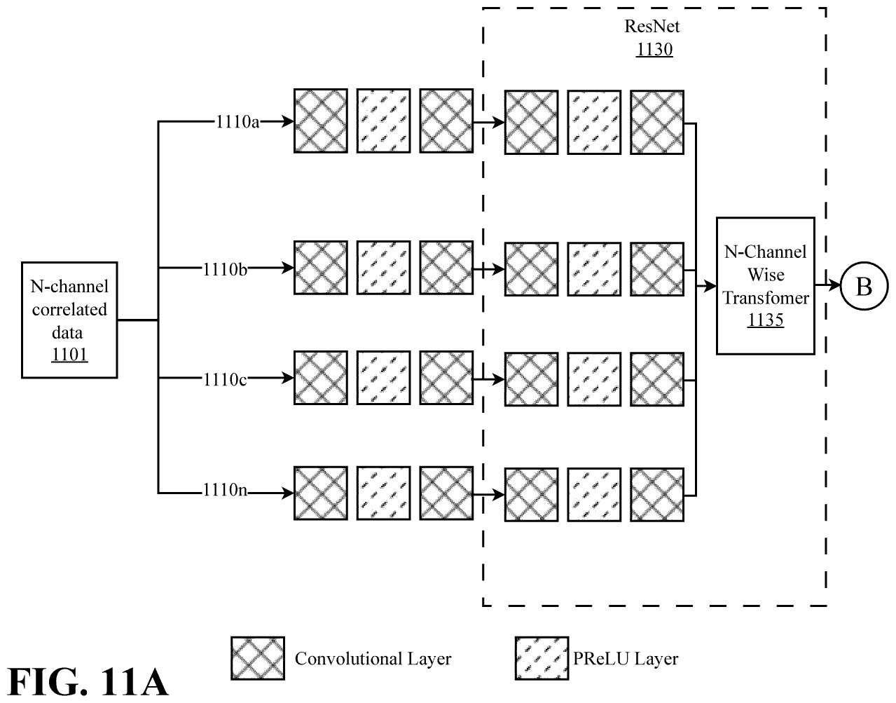

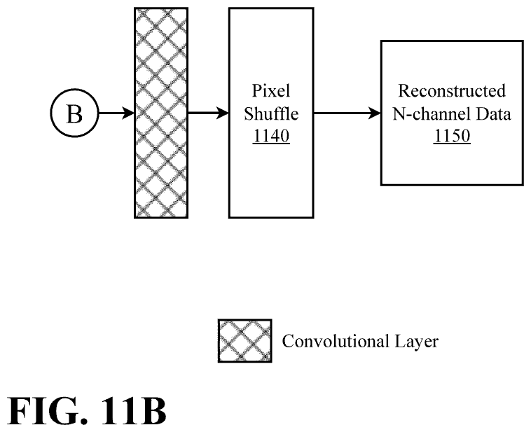

FIGS. 11A and 11B illustrate an exemplary architecture for an AI deblocking network configured to provide deblocking for a general N-channel data stream, according to an embodiment. The term “N-channel” refers to data that is composed of multiple distinct channels of modalities, where each channel represents a different aspect of type of information. These channels can exist in various forms, such as sensor readings, image color channels, or data streams, and they are often used together to provide a more comprehensive understanding of the underlying phenomenon. Examples of N-channel data include, but is not limited to, RGB images (e.g., in digital images, the red, green, and blue channels represent different color information; combining these channels allows for the representation of a wide range of colors), medical imaging (e.g., may include Magnetic Resonance Imaging scans with multiple channels representing different tissue properties, or Computed Tomography scans with channels for various types of X-ray attenuation), audio data (e.g., stereo or multi-channel audio recordings where each channel corresponds to a different microphone or audio source), radar and lidar (e.g., in autonomous vehicles, radar and lidar sensors provide multi-channel data, with each channel capturing information about objects' positions, distances, and reflectivity) SAR image data, text data (e.g., in natural language processing, N-channel data might involve multiple sources of text, such as social media posts and news articles, each treated as a separate channel to capture different textual contexts), sensor networks (e.g., environmental monitoring systems often employ sensor networks with multiple sensors measuring various parameters like temperature, humidity, air quality, and more. Each sensor represents a channel), climate data, financial data, and social network data.

The disclosed AI deblocking network may be trained to process any type of N-channel data, if the N-channel data has a degree of correlation. More correlation between and among the multiple channels yields a more robust and accurate AI deblocking network capable of performing high quality compression artifact removal on the N-channel data stream. A high degree of correlation implies a strong relationship between channels. Using SAR image data has been used herein as an exemplary use case for an AI deblocking network for a N-channel data stream comprising 2 channels, the In-phase and Quadrature components (i.e., I and Q, respectively).

Exemplary data correlations that can be exploited in various implementations of AI deblocking network can include, but are not limited to, spatial correlation, temporal correlation, cross-sectional correlation (e.g., This occurs when different variables measured at the same point in time are related to each other), longitudinal correlation, categorical correlation, rank correlation, time-space correlation, functional correlation, and frequency domain correlation, to name a few.

As shown, an N-channel AI deblocking network may comprise a plurality of branches 1110a-n. The number of branches is determined by the number of channels associated with the data stream. Each branch may initially be processed by a series of convolutional and PReLU layers. Each branch may be processed by resnet 1130 wherein each branch is combined back into a single data stream before being input to N-channel wise transformer 1135, which may be a specific configuration of transformer 300. The output of N-channel wise transformer 1135 may be sent through a final convolutional layer before passing through a last pixel shuffle layer 1140. The output of AI deblocking network for N-channel video/image data is the reconstructed N-channel data 1150.

As an exemplary use case, video/image data may be processed as a 3-channel data stream comprising Green (G), Red (R), and Blue (B) channels. An AI deblocking network may be trained that provides compression artifact removal of video/image data. Such a network would comprise 3 branches, wherein each branch is configured to process one of the three channels (R, G, or B). For example, branch 1110a may correspond to the R-channel, branch 1110b to the G-channel, and branch 1110c to the B-channel. Each of these channels may be processed separately via their respective branches before being combined back together inside resnet 1130 prior to being processed by N-channel wise transformer 1135.

As another exemplary use case, a sensor network comprising a half dozen sensors may be processed as a 6-channel data stream. The exemplary sensor network may include various types of sensors collecting different types of, but still correlated, data. For example, sensor network can include a pressure sensor, a thermal sensor, a barometer, a wind speed sensor, a humidity sensor, and an air quality sensor. These sensors may be correlated to one another in at least one way. For example, the six sensors in the sensor network may be correlated both temporally and spatially, wherein each sensor provides a time series data stream which can be processed by one of the 6 channels 1110a-n of AI deblocking network. As long as AI deblocking network is trained on N-channel data with a high degree of correlation and which is representative of the N-channel data it will encounter during model deployment, it can reconstruct the original data using the methods described herein.

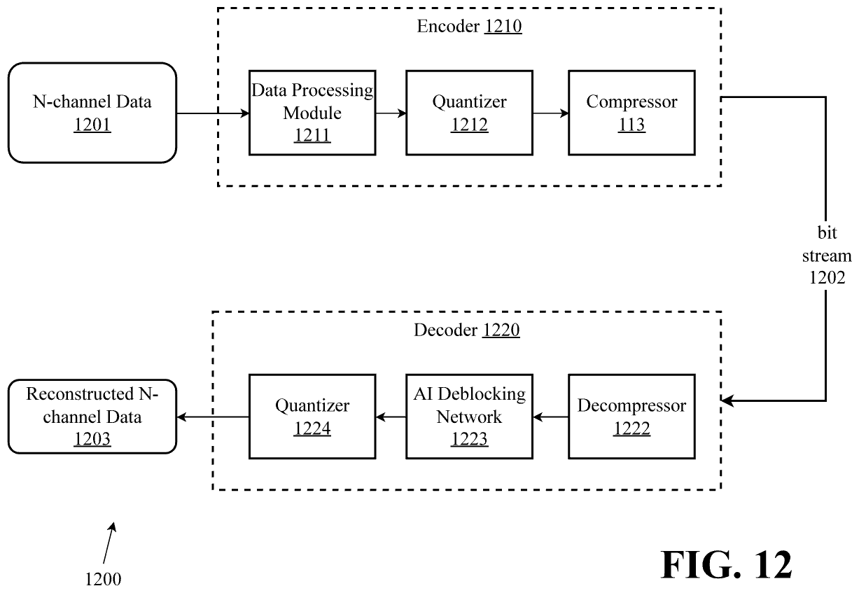

FIG. 12 is a block diagram illustrating an exemplary system architecture 1200 for N-channel data compression with predictive recovery, according to an embodiment. According to the embodiment, the system 1200 comprises an encoder module 1210 configured to receive as input N-channel data 1201 and compress and compact the input data into a bitstream 102, and a decoder module 120 configured to receive and decompress the bitstream 1202 to output a reconstructed N-channel data 1203.

A data processor module 1211 may be present and configured to apply one or more data processing techniques to the raw input data to prepare the data for further processing by encoder 1210. Data processing techniques can include (but are not limited to) any one or more of data cleaning, data transformation, encoding, dimensionality reduction, data slitting, and/or the like.

After data processing, a quantizer 1212 performs uniform quantization on the n-number of channels. Quantization is a process used in various fields, including signal processing, data compression, and digital image processing, to represent continuous or analog data using a discrete set of values. It involves mapping a range of values to a smaller set of discrete values. Quantization is commonly employed to reduce the storage requirements or computational complexity of digital data while maintaining an acceptable level of fidelity or accuracy. Compressor 1213 may be configured to perform data compression on quantized N-channel data using a suitable conventional compression algorithm.

The resulting encoded bitstream may then be (optionally) input into a lossless compactor (not shown) which can apply data compaction techniques on the received encoded bitstream. An exemplary lossless data compaction system which may be integrated in an embodiment of system 1200 is illustrated with reference to FIG. 4-7. For example, lossless compactor may utilize an embodiment of data deconstruction engine 501 and library manager 403 to perform data compaction on the encoded bitstream. The output of the compactor is a compacted bitstream 1202 which can be stored in a database, requiring much less space than would have been necessary to store the raw N-channel data, or it can be transmitted to some other endpoint.

At the endpoint which receives the transmitted compacted bitstream 1202 may be decoder module 1220 configured to restore the compacted data into the original SAR image by essentially reversing the process conducted at encoder module 1210. The received bitstream may first be (optionally) passed through a lossless compactor which de-compacts the data into an encoded bitstream. In an embodiment, a data reconstruction engine 601 may be implemented to restore the compacted bitstream into its encoded format. The encoded bitstream may flow from compactor to decompressor 1222 wherein a data compaction technique may be used to decompress the encoded bitstream into the I/Q channels. It should be appreciated that lossless compactor components are optional components of the system, and may or may not be present in the system, dependent upon the embodiment.

According to the embodiment, an Artificial Intelligence (AI) deblocking network 1223 is present and configured to utilize a trained deep learning network to provide compression artifact removal as part of the decoding process. AI deblocking network 1223 may leverage the relationship demonstrated between the various N-channels of a data stream to enhance the reconstructed N-channel data 1203. Effectively, AI deblocking network 1223 provides an improved and novel method for removing compression artifacts that occur during lossy compression/decompression using a network designed during the training process to simultaneously address the removal of artifacts and maintain fidelity of the original N-channel data signal, ensuring a comprehensive optimization of the network during the training stages.

The output of AI deblocking network 1223 may be dequantized by quantizer 1224, restoring the n-channels to their initial dynamic range. The dequantized n-channel data may be reconstructed and output 1203 by decoder module 1220 or stored in a database.

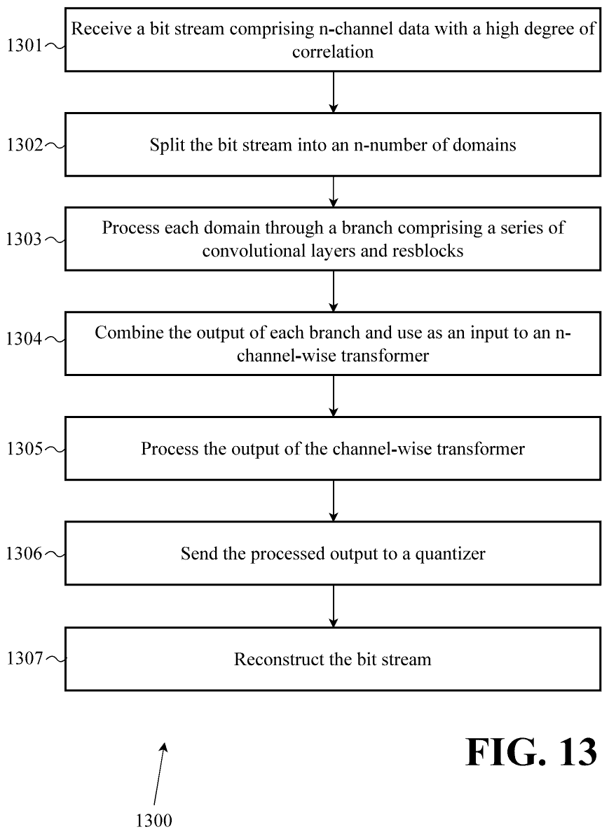

FIG. 13 is a flow diagram illustrating an exemplary method for processing a compressed n-channel bit stream using an AI deblocking network, according to an embodiment. According to the embodiment, the process begins at step 1301 when a decoder module 1220 receives, retrieves, or otherwise obtains a bit stream comprising n-channel data with a high degree of correlation. At step 1302, the bit stream is split into an n-number of domains. For example, if the received bit stream comprises image data in the form of R-, G-, and B-channels, then the bit stream would be split into 3 domains, one for each color (RGB). At step 1303, each domain is processed through a branch comprising a series of convolutional layers and ResBlocks. The number of layers and composition of said layers may depend upon the embodiment and the n-channel data being processed. At step 1304, the output of each branch is combined back into a single bitstream and used as an input into an n-channel wise transformer 1135. At step 1305, the output of the channel-wise transformer may be processed through one or more convolutional layers and/or transformation layers, according to various implementations. At step 1306, the processed output may be sent to a quantizer for upscaling and other data processing tasks. As a last step 1307, the bit stream may be reconstructed into its original uncompressed form.

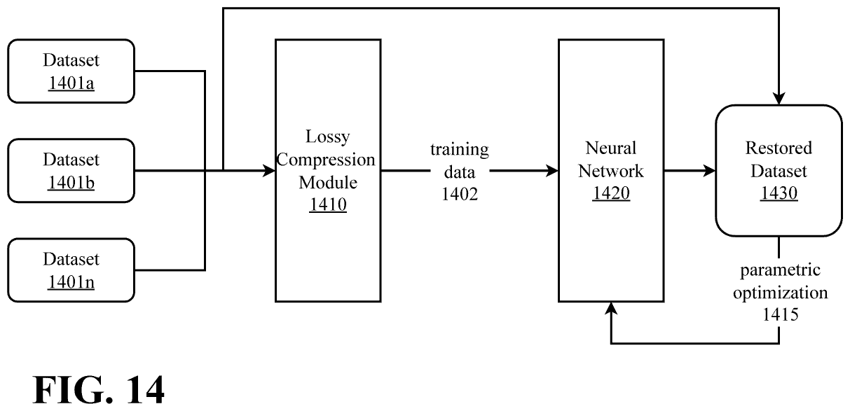

FIG. 14 is a block diagram illustrating a system for training a neural network to perform upsampling of decompressed data after lossy compression, according to an embodiment. The neural network may be referred to herein as a neural upsampler. According to the embodiment, a neural upsampler 1430 may be trained by taking training data 1402 which may comprise sets of two or more correlated datasets 101a-n and performing whatever processing that is done to compress the data. This processing is dependent upon the type of data and may be different in various embodiments of the disclosed system and methods. For example, in the SAR imagery use case, the processing and lossy compression steps used quantization and HEVC compression of the I and Q images. The sets of compressed data may be used as input training data 1402 into the neural network 1420 wherein the target output is the original uncompressed data. Because there is correlation between the two or more datasets, the neural upsampler learns how to restore “lost” data by leveraging the cross-correlations.

For each type of input data, there may be different compression techniques used, and different data conditioning for feeding into the neural upsampler. For example, if the input datasets 101a-n comprise a half dozen correlated time series from six sensors arranged on a machine, then delta encoding or a swinging door algorithm may be implemented for data compression and processing.

The neural network 1420 may process the training data 1402 to generate model training output in the form of restored dataset 1430. The neural network output may be compared against the original dataset to check the model's precision and performance. If the model output does not satisfy a given criteria or some performance threshold, then parametric optimization 1415 may occur wherein the training parameters and/or network hyperparameters may be updated and applied to the next round of neural network training.

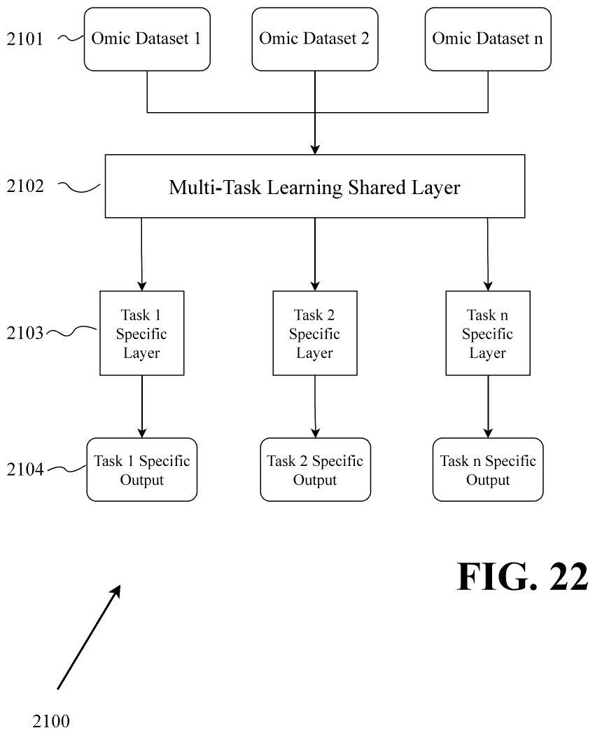

FIG. 22 is a block diagram illustrating an exemplary multi-task learning neural network architecture for upsampling of integrative-omics data 2100 according to an embodiment of the invention. The input to the network consists of multiple correlated omics datasets, such as gene expression, protein abundance, and metabolite concentration data 2101. These datasets are first processed by a set of shared layers, which learn representations that capture the common patterns and correlations across the different data types 2102. The shared representations are then passed to task-specific layers, which adapt these representations to the specific upsampling requirements of each omics data type 2103. For example, the task-specific layers for gene expression data upsampling may include convolutional and fully connected layers to capture gene-level patterns, while the task-specific layers for protein abundance data upsampling may include recurrent layers to capture temporal dynamics. The outputs of the task-specific layers are the upsampled omics datasets, which have been reconstructed to recover information lost during lossy compression 2104. The network is trained end-to-end using a combined loss function that includes the upsampling losses for each individual omics data type, enabling the model to learn both shared and task-specific features in a joint manner. This multi-task learning architecture allows the invention to effectively exploit the correlations and complementary information present in integrative-omics data for accurate and biologically meaningful upsampling.

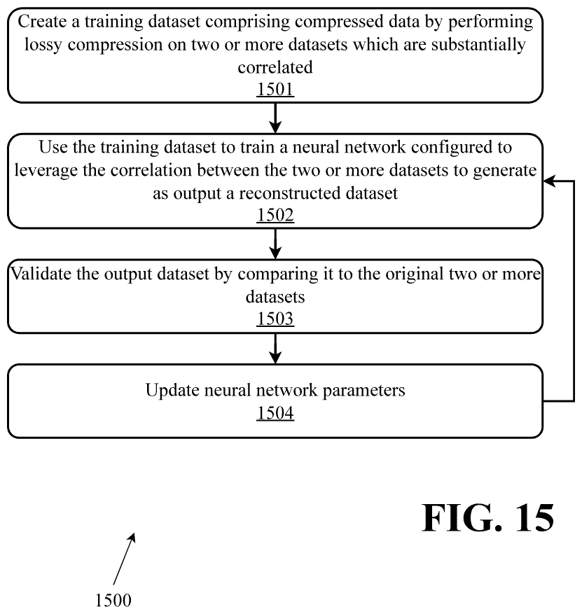

FIG. 15 is a flow diagram illustrating an exemplary method 1500 for training a neural network to perform upsampling of decompressed data after lossy compression, according to an embodiment. According to an embodiment, the process begins at step 1501 by creating a training dataset comprising compressed data by performing lossy compression on two or more datasets which are substantially correlated. As a next step 1502, the training dataset is used to train a neural network (i.e., neural upsampler) configured to leverage the correlation between the two or more datasets to generate as output a reconstructed dataset. At step 1503, the output of the neural network is compared to the original two more datasets to determine if the performance of the neural network at reconstructing the compressed data. If the model performance is not satisfactory, which may be determined by a set of criteria or some performance metric or threshold, then the neural network model parameters and/or hyperparametters may be updated 1504 and applied to the next round of training as the process moves to step 1502 and iterates through the method again.

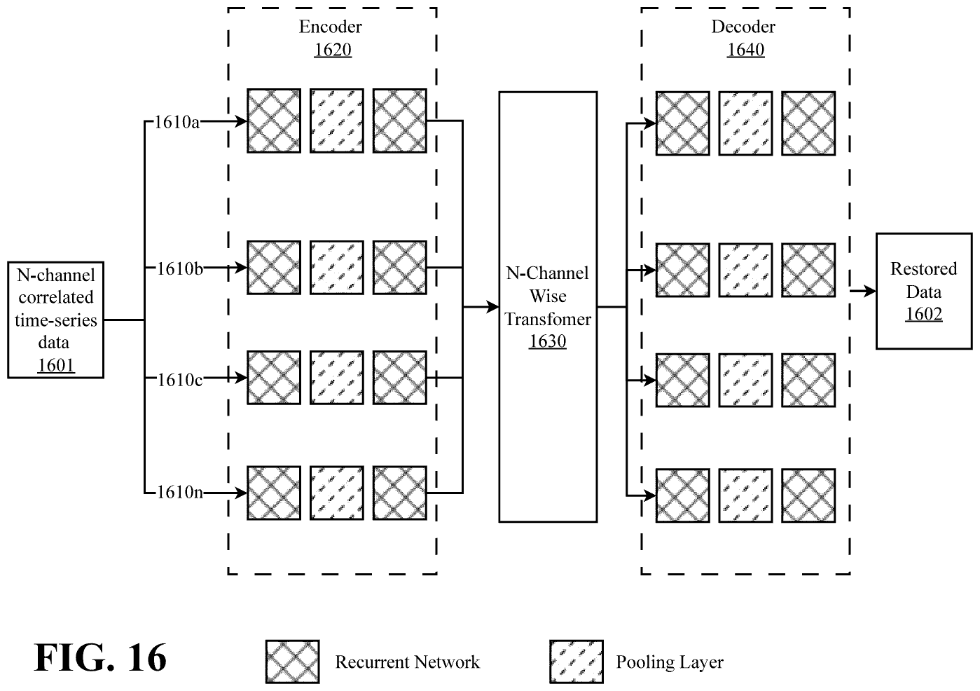

FIG. 16 is a block diagram illustrating an exemplary architecture for a neural upsampler configured to process N-channel time-series data, according to an embodiment. The neural upsampler may comprise a trained deep learning algorithm. According to the embodiment, a neural upsampler configured to process time-series data may comprise a recurrent autoencoder with an n-channel transformer attention network. In such an embodiment, the neural upsampler may be trained to process decompressed time-series data wherein the output of the upsampler is restored time-series data (i.e., restore most of the lost data due to the lossy compression). The upsampler may receive decompressed n-channel time-series data comprising two or more data sets of time-series data which are substantially correlated. For example, the two or more data sets may comprise multiple sets of Internet of Things (IoT) sensor data from sensors that are likely to be temporally correlated. For instance, consider a large number of sensors on a single complex machine (e.g., a combine tractor, a 3D printer, construction equipment, etc.) or a large number of sensors in a complex system such as a pipeline or refinery.

The n-channel time-series data may be received split into separate channels 1610a-n to be processed individually by encoder 1620. In some embodiments, encoder 1620 may employ a series of various data processing layers which may comprise recurrent neural network (RNN) layers, pooling layers, PReLU layers, and/or the like. In some implementations, one or more of the RNN layers may comprise a Long Short-Term Memory (LSTM) network. In some implementations, one or more of the RNN layers may comprise a sequence-to-sequence model. In yet another implementation, the one or more RNN layer may comprise a gate recurrent unit (GRU). Each channel may be processed by its own series of network layers wherein the encoder 1620 can learn a representation of the input data which can be used to determine the defining features of the input data. Each individual channel then feeds into an n-channel wise transformer 1630 which can learn the interdependencies between the two or more channels of correlated time-series data. The output of the n-channel wise transformer 1630 is fed into the decoder 1640 component of the recurrent autoencoder in order to restore missing data lost due to a lossy compression implemented on the time-series data. N-channel wise transformer 1630 is designed so that it can weigh the importance of different parts of the input data and then capture long-range dependencies between and among the input data. The decoder may process the output of the n-channel wise transformer 1630 into separate channels comprising various layers as described above. The output of decoder 1640 is the restored time-series data 1602, wherein most of the data which was “lost” during lossy compression can be recovered using the neural upsampler which leverages the interdependencies hidden within correlated datasets.

In addition to RNNs and their variants, other neural network architectures like CNNs and hybrid models that combine CNNs and RNNs can also be implemented for processing time series and sensor data, particularly when dealing with sensor data that can be structured as images or spectrograms. For example, if you had, say, 128 time series streams, it could be structured as two 64×64 pixel images (64 times series each, each with 64 time steps), and then use the same approach as the described above with respect to the SAR image use case. In an embodiment, a one-dimensional CNN can be used as a data processing layer in encoder 1620 and/or decoder 1640. The selection of the neural network architecture for time series data processing may be based on various factors including, but not limited to, the length of the input sequences, the frequency and regularity of the data points, the need to handle multivariate input data, the presence of exogenous variables or covariates, the computational resources available, and/or the like.

The exemplary time-series neural upsampler described in FIG. 16 may be trained on a training dataset comprising a plurality of compressed time-series data sourced from two or more datasets which are substantially correlated. For example, in a use case directed towards neural upsampling of IoT sensor data, the neural upsampler may be trained on a dataset comprising compressed IoT sensor data. During training, the output of the neural upsampler may be compared against the non-compressed version of the IoT sensor data to determine the neural upsampler's performance on restoring lost information.

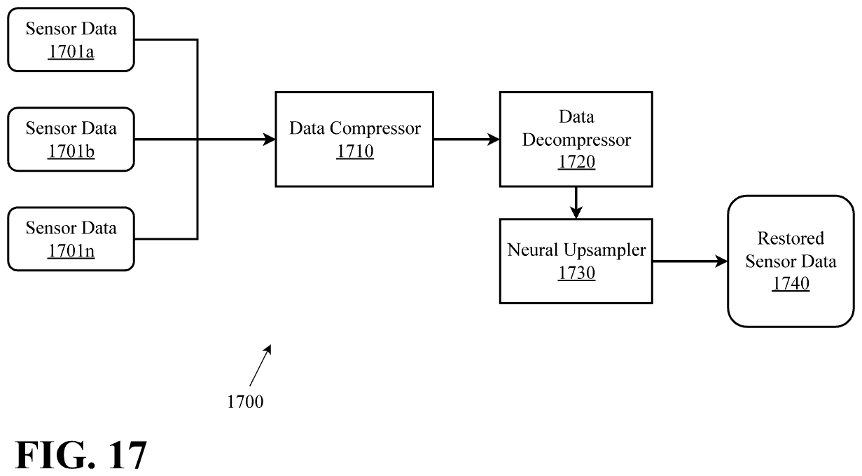

FIG. 17 is a block diagram illustrating an exemplary system architecture 1700 for upsampling of decompressed sensor data after lossy compression using a neural network, according to an embodiment. According to the embodiment, a neural upsampler 1730 is present and configured to receive decompressed sensor data (e.g., time-series data obtained from an IoT device) and restore the decompressed data by leveraging learned data correlations and inter- and intra-dependencies. According to an embodiment, the system may receive a plurality of sensor data 1701a-n from two or more sensors/devices, wherein the sensor data are substantially correlated. In an embodiment, the plurality of sensor data 1701a-n comprises time-series data. Time-series data received from two or more sensors may be temporally correlated, for example, IoT data from a personal fitness device and a blood glucose monitoring device during the time when a user of both devices is exercising may be correlated in time and by heart rate. As another example, a large number of sensors used to monitor a manufacturing facility may be correlated temporally.

A data compressor 1710 is present and configured to utilize one or more data compression methods on received sensor data 1701a-n. The data compression method chosen must be a lossy compression method. Exemplary types of lossy compression that may be used in some embodiments may be directed towards image or audio compression such as JPEG and MP3, respectively. For time series data lossy compression methods that may be implemented include (but is not limited to) one or more of the following: delta encoding, swinging door algorithm, batching, data aggregation, feature extraction. In an implementation, data compressor 1710 may implement network protocols specific for IoT such as message queuing telemetry transport (MQTT) for supporting message compression on the application layer and/or constrained application protocol (CoAP) which supports constrained nodes and networks and can be used with compression.

The compressed multi-channel sensor data 1701a-n may be decompressed by a data decompressor 1720 which can utilize one or more data decompression methods known to those with skill in the art. The output of data decompressor 1720 is a sensor data stream(s) of decompressed data which is missing information due to the lossy nature of the compression/decompression methods used. The decompressed sensor data stream(s) may be passed to neural upsampler 1730 which can utilize a trained neural network to restore most of the “lost” information associated with the decompressed sensor data stream(s) by leveraging the learned correlation(s) between and among the various sensor data streams. The output of neural upsampler 1730 is restored sensor data 1740.

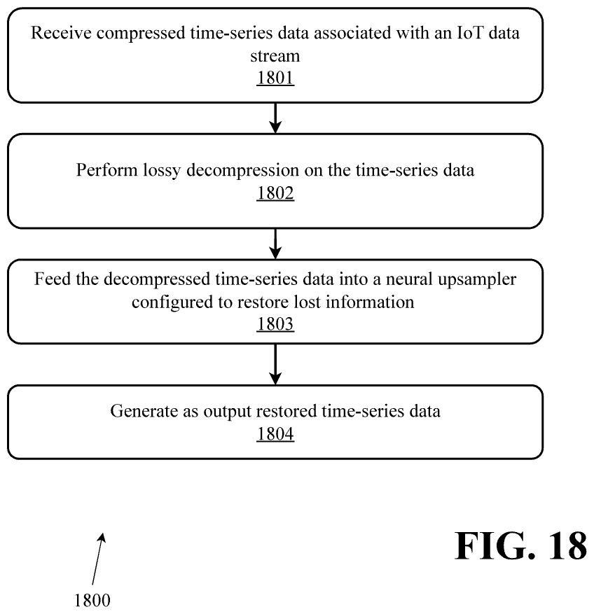

FIG. 18 is a flow diagram illustrating an exemplary method 1800 for performing neural upsampling of two or more time-series data streams, according to an embodiment. In this example, the two or more time-series streams may be associated with large sets of IoT sensors/devices. The two or more time-series streams are substantially correlated. The two or more time-series data streams may be temporally correlated. For example, a plurality of IoT sensors may be time-synchronized to better understand cause-and-effect relationships.

A neural upsampler which has been trained on compressed time-series data associated with one or more IoT sensor channels is present and configured to restore time-series data which has undergone lossy data compression and decompression by leveraging the correlation between the sensor data streams. A non-exhaustive list of time-series data correlations that may be used by an embodiment of the system and method can include cross-correlation and auto-correlation.

The two or more time-series data streams may be processed by a data compressor 1710 employing a lossy compression method. The lossy compression method may implement a lossy compression algorithm appropriate for compressing time-series data. The choice of compression implementation may be based on various factors including, but not limited to, the type of data being processed, the computational resources and time required, and the use case of the upsampler. Exemplary time-series data compression techniques which may be used include, but are not limited to, delta encoding, swinging door algorithm data aggregation, feature extraction, and batching, to name a few. The compressed time series data may be store in a database and/or transmitted to an endpoint. The compressed time-series data may be sent to a data decompressor 1720 which may employ a lossy decompression technique on the compressed time-series data. The decompressed data may be sent to the neural upsampler which can restore the decompressed data to nearly its original state by leveraging the temporal (and/or other) correlation between the time-series IoT sensor data streams. The compressed time-series data is received by data decompressor 1720 at step 1801. At data decompressor 1720 the compressed time-series data may be decompressed via a lossy decompression algorithm at step 1802.

A neural upsampler for restoration of time-series (e.g., IoT sensor data) data received from two or more data channels may be trained using two or more datasets comprising compressed time-series data which is substantially correlated. For example, the two or more datasets may comprise time-series data from a plurality of sensors affixed to a long-haul semi-truck and configured to monitor various aspects of the vehicles operation and maintenance and report the monitored data to a central data processing unit which can compress and transmit the data for storage or further processing. The two or more sensor channels are correlated in various ways such as temporally. In various embodiments, each channel of the received time-series data may be fed into its own neural network comprising a series of convolutional and/or recurrent and ReLU and/or pooling layers which can be used to learn latent correlations in the feature space that can be used to restore data which has undergone lossy compression. A multi-channel transformer may be configured to receive the output of each of the neural networks produce, learn from the latent correlation in the feature space, and produce reconstructed time-series data. At step 1803, the decompressed time-series data may be used as input to the trained neural upsampler configured to restore the lost information of the decompressed time-series data. The neural upsampler can process the decompressed data to generate as output restored time-series data at step 1804.

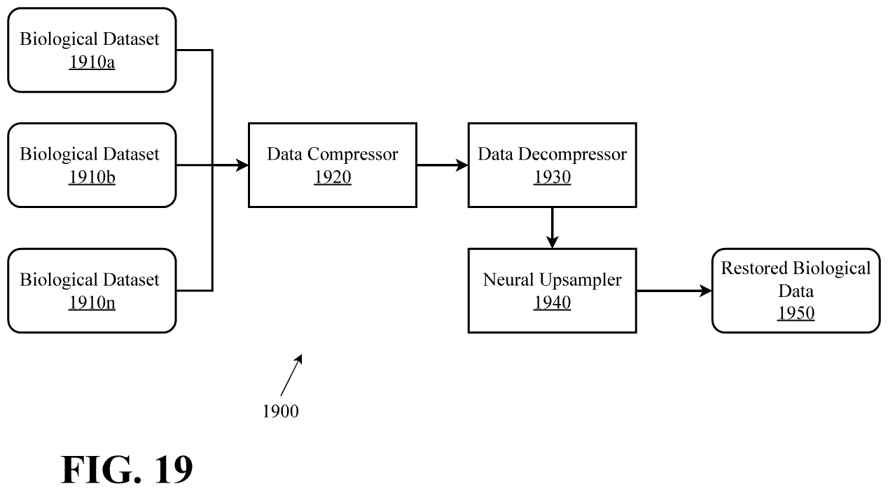

FIG. 19 is a block diagram illustrating an exemplary system architecture for neural upsampling of two or more genomic datasets, according to an embodiment. Genomic data 1910a-n may comprise, for example, any one or more of DNA sequences, single nucleotide polymorphisms (SNPs) gene expression data, epigenetic data, structural genomic data, mitochondrial DNA sequences, and/or the like. These examples highlight different layers of genomic information, from the basic DNA sequence to variations, gene expression, and epigenetic modifications. Analyzing and integrating multiple types of genomic data are crucial for a comprehensive understanding of biological processes, evolution, and the genetic basis of diseases. Thus, it would be beneficial to have a system, method, and/or computer readable instructions capable of providing neural upsampling of genomic data (e.g., human genomes or subsets of them, any parallel genome data sets, two or more persons mitochondrial DNA sequences, etc.) which has undergone lossy compression, therefore nearly restoring all the lost data.

In an embodiment, genomic data 1910a-n may comprise parallel genome datasets. Parallel genome datasets typically refer to multiple sets of genomic data that are generated or analyzed simultaneously. Using parallel sequencing runs, multiple samples may undergo DNA sequencing simultaneously in parallel, generating multiple sets of sequencing data concurrently. For example, in a genomics laboratory, several DNA samples might be processed and sequenced using high-throughput sequencing technologies in a single sequencing run, producing parallel datasets. In another example, genomic data from different individuals or populations may be collected and analyzed concurrently to study genetic diversity, population structure, and evolutionary patterns. Researchers might analyze genome sequences from individuals of different ethnicities or geographic regions in parallel to investigate population-specific genetic variations.

There are several common data formats used for storing and transmitting genomic data, and which may be used in various implementations of the disclosed system and methods. These formats are designed to efficiently represent the vast amount of information generated through various genomic technologies. One such format of genomic data which may be processed by system 1900 is Format for Sequence Data (FASTA). FASTA is a text-based format for representing nucleotide or protein sequences. It consists of a header line starting with “>”, followed by the sequence data. This format may be used when processing genomic data such as DNA, RNA, and protein sequences. Similarly, Format for Quality Scores (FASTQ) may be used in some implementations. FASTQ is a text-based format that extends FASTA by including quality scores for each base in the sequence. It is commonly used for storing data from next-generation sequencing (NGS) platforms.

Another exemplary format which may be processed by system 1900 is sequence alignment/mapping (SAM/BAM). SAM is a text-based format for representing sequence alignment data, while BAM is the binary equivalent. SAM/BAM files store aligned sequencing reads along with quality scores, mapping positions, and other relevant information. SAM/BAM may be implemented in use cases for storing and exchanging data related to sequence alignments, such as is the case in the context of NGS data. As a final example, variant call format (VCF) may be implemented in some embodiments of system 1900. VCF is a text-based format for representing genomic variations, such as single nucleotide polymorphisms (SNPs), insertions, deletions, and structural variants.

The genomic data may be received at a data compressor 1920 which is present and configured to utilize one or more data compression methods on received genomic data 1910a-n. Genomic data, especially raw sequencing data, can be massive, and compression techniques are often employed to reduce storage requirements and facilitate data transfer. The data compression method chosen must be a lossy compression method. Exemplary types of lossy compression that may be used in some embodiments include quality score quantization, reference-based compression, subsampling, genomic data transformation, and lossy compression of read data.

In an embodiment where quality score quantization is implemented, quality scores associated with each base in sequencing data represent the confidence in the accuracy of the base call. These scores are often encoded with high precision, but for compression purposes, they can be quantized to reduce the bit depth, introducing a level of information loss. Higher quantization levels reduce the precision of quality scores but can significantly reduce file sizes.

In an embodiment, where reference-based compression is implemented, instead of storing the entire genomic sequence, some compression methods store only the differences between the target sequence and a reference genome. Variations and mutations are encoded, while the reference genome provides a framework. This method can achieve substantial compression, but some specific information about the individual's genome is lost. Raw read data from sequencing platforms may contain redundant or noisy information. Lossy compression algorithms may filter or smooth the data to reduce redundancy or noise. While this can result in higher compression, it may lead to the loss of some information, especially in regions with lower sequencing quality.

Genomic data compressed by data compressor 1920 may then be sent to a data decompressor 1930 which can utilize one or more data decompression methods known to those with skill in the art. The output of data decompressor 1930 is a genomic data stream(s) of decompressed data which is missing information due to the lossy nature of the compression/decompression methods used. The decompressed genomic data stream(s) may be passed to neural upsampler 1940 which can utilize a trained neural network to restore most of the “lost” information associated with the decompressed genomic data stream(s) by leveraging the learned correlation(s) between and among the various genomic datasets. The output of neural upsampler 1940 is restored genomic data 1950.

According to various embodiments, system 1900 utilizes a trained neural upsampler to leverage correlations in the received two or more genomic datasets 1910a-n in order to restore lost data. In an implementation, neural upsampler 1940 may comprise a series of recurrent neural network layers, pooling layers, an n-channel transformer, and/or convolutional layers as described herein. In an embodiment, neural upsampler 1940 may be trained on a training dataset comprising a corpus of compressed genomic data, wherein the compressed genomic data is correlated. The neural upsampler may be trained to generate as output genomic data, which is at close to its original state, prior to undergoing lossy data compression. The genomic data which was used to create the training dataset may be kept and used to validate the training output of neural upsampler, in this way the neural upsampler can be trained to generate output which nearly matches the original, uncompressed genomic data.

Genomic datasets can be correlated with each other in various ways, providing valuable insights into biological relationships, evolutionary history, and disease associations. There are some ways in which distinct genomic datasets can be correlated, and which may be learned and leveraged by a trained neural upsampler 1940 to restore genomic data which has been processed via lossy compression/decompression. For example, genetic variation and linkage disequilibrium can provide correlation between and among genetic datasets 1910a-n. SNPs are variations at a single nucleotide position in the DNA sequence. Correlating SNP data across different genomic datasets can reveal patterns of genetic variation and linkage disequilibrium. Haplotype blocks found in genomic data may be used as a learned correlation by neural upsampler. Haplotypes are combinations of alleles on a single chromosome. Understanding the correlation of haplotypes across datasets helps in identifying linked genetic variations. Yet another correlation that can be found among genetic datasets is phenotypic correlation. Correlating genomic data with phenotypic information can identify genetic variants associated with specific traits or diseases. This is commonly done through Genome-Wide Association Studies (GWAS) and can involve comparing different genomic datasets.

More examples of genetic data correlations which may be leveraged in one or more embodiments include evolutionary relationships, gene expression correlation, epigenetic correlations, structural genomic correlation, functional annotations, and population genetics. Human mitochondrial DNA (mtDNA) sequences can be correlated to one another in several ways to understand genetic relationships, population structure, and evolutionary history. Some common approaches for analyzing and correlating human mitochondrial sequences can include phylogenetic analysis, haplogroup assignment, and population genetics and diversity measures. Phylogenetic trees are constructed based on sequence differences, revealing the evolutionary relationships among different mitochondrial haplotypes. This is often done using methods like Maximum Likelihood or Bayesian inference. Phylogenetic trees help identify clades, lineages, and common ancestors, providing insights into the historical relationships among mitochondrial sequences. Mitochondrial DNA is categorized into haplogroups, which represent major branches of the mitochondrial phylogenetic tree. Haplogroups are defined by specific polymorphisms and sequence variations. Assigning individuals to haplogroups allows for broader categorization of mtDNA diversity and helps trace maternal lineages. A neural upsampler can use the correlations in genomic datasets to be trained to restore lost data.

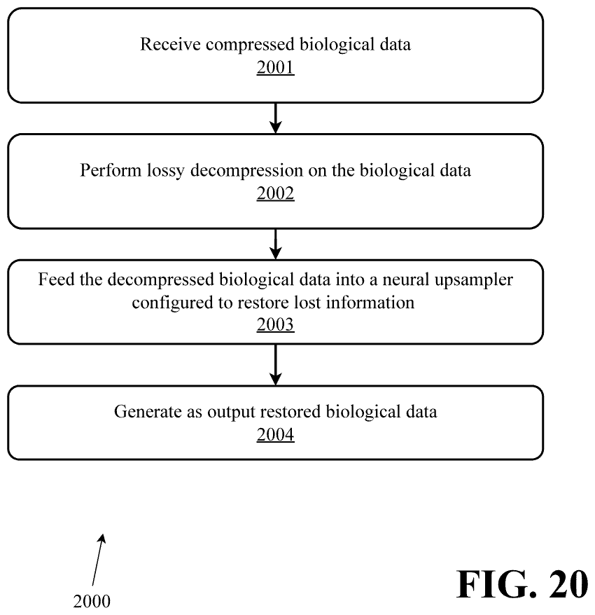

FIG. 20 is a flow diagram illustrating an exemplary method 2000 for performing neural upsampling of two or more genomic datasets, according to an embodiment. In this example, the two or more genomic datasets (also referred to as data streams) may be associated with human genomic data (e.g., human genome). The two or more genomic datasets are substantially correlated as described herein. For example, two or more people's mitochondrial DNA sequences will be closely related.

A neural upsampler which has been trained on compressed genomic data is present and configured to restore time-series data which has undergone lossy data compression and decompression by leveraging the correlation between the genomic datasets. A non-exhaustive list of genomic data correlations that may be used by an embodiment of the system and method can include genetic variation and linkage disequilibrium, and haplotype blocks.

The two or more genomic datasets may be processed by a data compressor 1920 employing a lossy compression method. The lossy compression method may implement a lossy compression algorithm appropriate for compressing genomic data. The choice of compression implementation may be based on various factors including, but not limited to, the type of data being processed, the computational resources and time required, and the use case of the upsampler. Exemplary genomic data compression techniques which may be used include, but are not limited to, quality score quantization, reference-based compression, subsampling, and genomic data transformation, to name a few. The compressed genomic data may be stored in a database and/or transmitted to an endpoint. The compressed genomic data may be sent to a data decompressor 1930 which may employ a lossy decompression technique on the compressed genomic data. The decompressed data may be sent to the neural upsampler which can restore the decompressed data to nearly its original state by leveraging the genetic variation (and/or other) correlation between the genomic datasets. The compressed genomic data is received by data decompressor 1930 at step 2001. At data decompressor 1930 the compressed genomic data may be decompressed via a lossy decompression algorithm at step 2002.

A neural upsampler for restoration of genomic (e.g., human genomes or subsets thereof) data received from two or more data channels may be trained using two or more datasets comprising compressed genomic data which is substantially correlated. For example, the two or more datasets may comprise genomic data from a subset of the human genome. Subsets of human genomes refer to specific groups or categories of genetic information within the larger human population. These subsets can be defined based on various criteria, such as geographical origin, shared genetic features, or clinical characteristics. Here are some examples of subsets of human genomes: haplogroups, population specific genomic variation, ancestral populations, ethnic and geographical groups, disease-specific subsets, founder populations (i.e., groups of individuals who established a new population, often with a limited gene pool), isolate populations, age-specific subsets, long-lived individuals, and/or the like. The two or more subsets of human genomes are correlated in various ways such as temporally. In various embodiments, each channel of the received genomic data may be fed into its own neural network comprising a series of convolutional and/or recurrent and ReLU and/or pooling layers which can be used to learn latent correlations in the feature space that can be used to restore data which has undergone lossy compression. A multi-channel transformer may be configured to receive the output that each of the neural networks produce, learn from the latent correlation in the feature space, and produce reconstructed genomic data. At step 2003, the decompressed genomic data may be used as input to the trained neural upsampler configured to restore the lost information of the decompressed genomic data. The neural upsampler can process the decompressed data to generate as output restored genomic data at step 2004.

### Quality Driven Compression of Genomic Data System Architecture

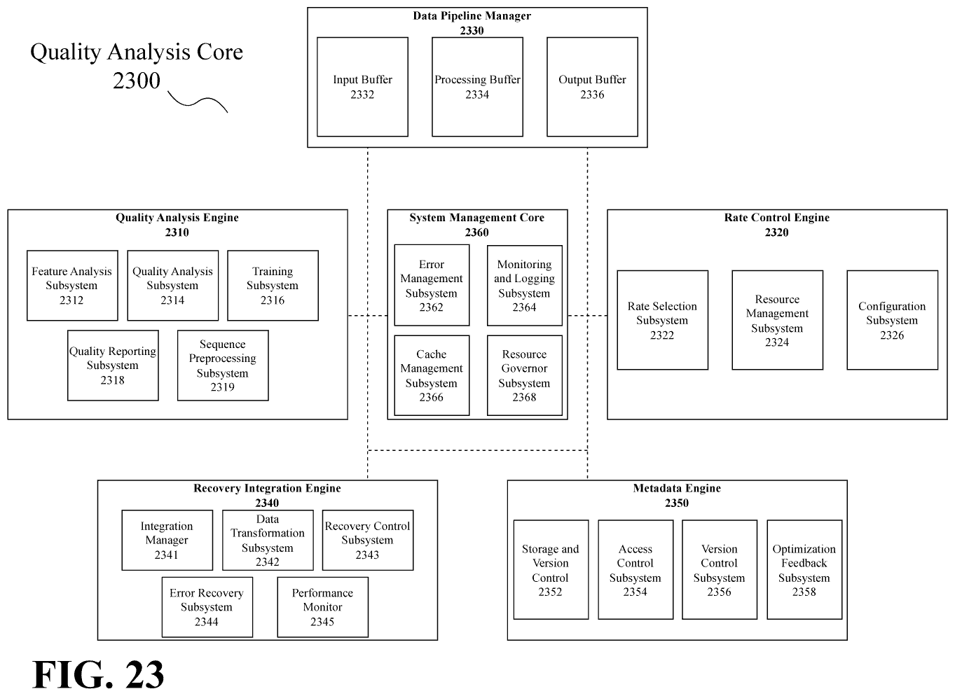

FIG. 23 is a block diagram illustrating exemplary architecture of quality analysis core 2300 for processing genomic data according to an embodiment. Quality analysis core 2300 comprises quality analysis engine 2310, rate control engine 2320, data pipeline manager 2330, recovery integration engine 2340, metadata engine 2350, and system management core 2360 interconnected via data pathways.

“Quality analysis engine 2310 evaluates genomic regions and assigns quality scores through feature analysis subsystem 2312, quality assessment subsystem 2314, training subsystem 2316, quality reporting subsystem 2318, and sequence preprocessing subsystem 2319. Feature analysis subsystem 2312 analyzes genomic sequences by computing relevant metrics including GC content, sequence complexity, and pattern identification while maintaining feature registry data. Quality assessment subsystem 2314 implements the Quality Assessment Network (QAN), a specialized neural network architecture that assigns importance scores to regions, generates confidence metrics, and validates quality scores against reference datasets. The QAN incorporates dual-head output for quality scoring and rate prediction, with layers specifically designed for genomic feature analysis. Training subsystem 2316 handles model updates and maintains version control while performing continuous validation against known important genomic regions. Quality reporting subsystem 2318 generates assessment reports and maintains analysis history. Sequence preprocessing subsystem 2319 performs initial validation and format normalization of input genomic data.

Quality analysis engine 2310 incorporates supervised learning through training subsystem 2316, which trains the QAN using labeled genomic regions with known importance scores, conservation data, and functional annotations. Training occurs in two phases: pre-training on annotated reference datasets to learn feature importance, followed by fine-tuning that jointly optimizes quality assessment and rate prediction. Loss functions combine quality assessment and rate prediction errors while validating against known important genomic regions. During training, training subsystem 2316 processes multiple types of genomic data to ensure robust performance. This includes DNA sequences with annotated importance markers, conservation scores across multiple species, SNP datasets, gene expression data, and functional genomic annotations from clinical databases. Training data also incorporates mitochondrial DNA sequences, epigenetic markers, and structural genomic variations to capture different aspects of sequence importance.

Quality analysis core 2300 implements a sophisticated neural architecture specifically optimized for genomic feature processing. The feature analysis subsystem 2312 processes genomic sequences through multiple parallel convolutional channels, each specialized for different sequence characteristics. One channel focuses on GC content distribution using sliding window analysis with variable window sizes, while another analyzes sequence complexity through entropy calculations and repeat pattern detection. The system employs bidirectional long short-term memory (LSTM) networks to capture context-dependent patterns in both forward and reverse directions of the genetic sequence, crucial for identifying functional elements that may have orientation-dependent properties. These features are then processed through series of attention layers that learn to identify relative importance of different sequence regions based on their biological significance and information density.

The QAN implemented within quality assessment subsystem 2314 utilizes a multi-stage neural architecture optimized for genomic feature processing. The network's input layer accepts feature vectors from feature analysis subsystem 2312, including GC content metrics, sequence complexity measures, and identified pattern frequencies. These inputs feed into a series of feature extraction layers comprising bidirectional recurrent units that process the genomic sequence in both forward and reverse directions to capture context-dependent patterns. The extracted features flow through multiple self-attention layers that learn to identify relative importance of different sequence regions. These attention mechanisms enable the network to capture both local motifs and long-range dependencies within the genomic sequence. The attended features then pass through a series of fully connected layers that progressively refine the feature representations.

The network culminates in a dual-head output architecture. The quality scoring head implements multiple dense layers terminating in a sigmoid activation that produces importance scores between 0 and 1 for each genomic region. In parallel, the rate prediction head processes the same refined features through separate dense layers to predict optimal compression rates. Both heads share early-layer features but maintain specialized final layers to optimize their respective tasks. Skip connections throughout the network preserve low-level sequence information while allowing deeper feature processing. Layer normalization and dropout are employed between stages to improve training stability and prevent overfitting. The network architecture enables end-to-end training while maintaining gradient flow through both output heads.

Rate control engine 2320 determines compression rates based on quality scores through rate selection subsystem 2322, resource management subsystem 2324, and configuration subsystem 2326. Rate selection subsystem 2322 processes quality scores through specialized algorithms balancing quality preservation against compression efficiency. Resource management subsystem 2324 monitors system resource usage while configuration subsystem 2326 maintains compression parameters and adapts to varying system constraints.

Rate control engine 2320 utilizes reinforcement learning within rate selection subsystem 2322 to optimize compression rate selection. Training rewards are based on achieved compression efficiency and quality preservation, with penalties applied for resource overuse or quality degradation below thresholds. The system performs continuous adaptation through optimization feedback subsystem 2358, which tracks compression effectiveness and recovery performance to retrain models as needed. Integration manager 2341 coordinates sharing of feature extraction layers and attention mechanisms with existing recovery networks during training to ensure compatible operation. Rate control engine 2320 trains on historical compression outcome data paired with quality metrics, resource utilization logs, and reconstruction accuracy measurements. Training datasets include parallel genome datasets, where multiple samples undergo DNA sequencing simultaneously, enabling the system to learn patterns in compression requirements across related sequences. The system also trains on time-series genomic data and integrative-omics datasets to support multi-task learning capabilities across different types of genomic information.

Rate control engine 2320 employs a reinforcement learning framework to optimize compression rate selection dynamically. The rate selection subsystem 2322 implements a deep Q-learning network that learns optimal compression strategies by maximizing a reward function balancing compression efficiency against quality preservation. The network receives state information including current system resources, quality scores, and historical performance metrics to generate region-specific compression parameters. The action space comprises discrete compression rates, while the state space includes quality scores, sequence complexity metrics, and system resource availability. The reward function incorporates both immediate compression gains and long-term quality preservation metrics, enabling the system to learn strategies that maintain critical genomic information while achieving optimal compression ratios.

The system adapts compression rates through a multi-scale analysis approach that considers both local sequence properties and broader genomic context. For regions identified as highly important, such as exons or regulatory elements, the system automatically adjusts compression parameters to preserve more detail. The rate selection algorithm incorporates both deterministic rules based on quality thresholds and learned patterns from historical compression outcomes. The system maintains a rolling window of compression effectiveness metrics, allowing it to adjust its strategy based on observed recovery quality and computational resource availability. This adaptive behavior ensures that compression rates are optimized not just for individual regions but for the overall genomic context and system performance requirements.

The neural network's recurrent layers and channel-wise transformer are integrated through a novel architecture optimized for genomic data processing. The recurrent layers implement a modified LSTM structure with additional gates specifically designed to handle the four-base alphabet of genomic sequences. These layers process the sequence data bidirectionally, with each layer capturing increasingly abstract representations of the genomic patterns. The network employs residual connections between recurrent layers to maintain access to lower-level sequence features while building higher-order representations. This architecture enables the system to capture both local sequence motifs and broader structural patterns that may influence compression requirements.

Data pipeline manager 2330 orchestrates data flow through input buffer 2332, processing buffer 2334, and output buffer 2336. Input buffer 2332 receives incoming sequences and organizes them into processing windows. Processing buffer 2334 manages data during active analysis across multiple regions simultaneously. Output buffer 2336 ensures data integrity during final assembly of compressed regions.

Recovery integration engine 2340 provides connection with recovery network through integration manager 2341, data transform subsystem 2342, recovery control subsystem 2343, error recovery subsystem 2344, and performance monitor 2345. Integration manager 2341 coordinates overall process while maintaining version compatibility. Data transform subsystem 2342 ensures format compatibility across data structures. Recovery control subsystem 2343 optimizes reconstruction parameters based on compression metadata. Error recovery subsystem 2344 implements retry logic for failed recoveries. Performance monitor 2345 tracks recovery metrics and generates performance analytics.

Metadata engine 2350 maintains tracking of operations through storage and version control subsystem 2352, access control subsystem 2354, version control subsystem 2356, and optimization feedback subsystem 2358. Storage and version control subsystem 2352 organizes metadata storage and ensures data integrity. Access control subsystem 2354 manages queries and enforces security policies. Version control subsystem 2356 handles model versions and ensures backward compatibility. Optimization feedback subsystem 2358 tracks compression effectiveness and implements continuous improvement loops based on recovery performance.

System management core 2360 provides real-time oversight through error management subsystem 2362, monitoring and logging subsystem 2364, cache management subsystem 2366, and resource governor subsystem 2368. Error management subsystem 2362 implements detection and recovery procedures while monitoring quality thresholds. Monitoring and logging subsystem 2364 collects performance metrics. Cache management subsystem 2366 optimizes data access patterns across processing stages. Resource governor subsystem 2368 coordinates parallel processing while managing system resource allocation.

The quality assessment network within quality analysis engine 2310 incorporates a multi-layer architecture performing sequential feature extraction and importance scoring. During operation, feature analysis subsystem 2312 first processes genomic sequences through convolutional layers, capturing local sequence patterns and motifs. These features feed into attention mechanisms that weigh the relative importance of different sequence regions. The dual-head output network simultaneously generates quality scores and confidence metrics, allowing the system to assess both the importance of genomic regions and the reliability of these assessments.

Rate control engine 2320 implements a reinforcement learning framework that continuously adapts compression parameters based on observed outcomes. The rate selection network within subsystem 2322 learns optimal compression strategies by maximizing a reward function that balances compression efficiency against quality preservation. This network receives state information including current system resources, quality scores, and historical performance metrics to generate region-specific compression parameters.

Data flows through the system in a carefully orchestrated sequence managed by data pipeline manager 2330. As genomic sequences enter input buffer 2332, they undergo initial segmentation and validation. These segments move through feature extraction and quality assessment stages while maintaining strict ordering and dependency relationships. Processing buffer 2334 coordinates the parallel processing of multiple regions, implementing sophisticated queuing mechanisms to optimize throughput while preserving data relationships. The processed regions then flow to output buffer 2336 for final assembly and validation.

Recovery integration engine 2340 maintains bidirectional communication with the base patent's recovery network throughout processing. Integration manager 2341 synchronizes feature extraction layers between quality assessment and recovery networks, ensuring compatible representations. Data transform subsystem 2342 handles real-time conversion of data formats and metadata structures, while recovery control subsystem 2343 dynamically adjusts recovery parameters based on compression decisions. This tight integration enables the system to optimize compression strategies with awareness of recovery capabilities.

Metadata engine 2350 implements a hierarchical tracking system that maintains relationships between all processing stages. Storage and version control subsystem 2352 organizes metadata using a graph-based structure that captures dependencies between processing steps. This allows optimization feedback subsystem 2358 to analyze complete processing chains and identify opportunities for improvement. The metadata system maintains continuous validation of processing outcomes, feeding performance metrics back to the training subsystems for model adaptation.

System management core 2360 provides comprehensive oversight through coordinated monitoring and control mechanisms. Cache management subsystem 2366 implements predictive caching strategies based on observed access patterns, while resource governor subsystem 2368 dynamically allocates processing resources based on region importance and system load. This integrated management approach enables efficient parallel processing while maintaining strict quality controls throughout the pipeline.

During operation in one embodiment, genomic data enters through input buffer 2332 where sequence preprocessing subsystem 2319 performs validation and normalization under access controls managed by access control subsystem 2354. The preprocessed data streams into feature analysis subsystem 2312, which extracts sequence characteristics including GC content and complexity metrics, with cache management subsystem 2366 optimizing feature data access patterns. These features feed into quality assessment subsystem 2314, which generates importance scores and confidence metrics for each genomic region, while quality reporting subsystem 2318 maintains assessment records. Resource governor subsystem 2368 allocates processing resources based on region priorities and system load.

Rate control engine 2320 processes these scores through rate selection subsystem 2322 to determine optimal compression parameters, while resource management subsystem 2324 monitors system utilization and configuration subsystem 2326 adapts compression settings based on current conditions. Processing buffer 2334 manages multiple regions simultaneously as compression executes, with error management subsystem 2362 detecting and handling processing anomalies. Monitoring and logging subsystem 2364 tracks performance metrics while optimization feedback subsystem 2358 provides real-time adjustment recommendations.

Integration manager 2341 coordinates with the base recovery network as data transform subsystem 2342 prepares data structures for compression. Recovery control subsystem 2343 configures recovery parameters while error recovery subsystem 2344 stands ready to handle any recovery failures. Performance monitor 2345 tracks recovery preparation metrics, feeding data to the optimization loop. Storage and version control subsystem 2352 maintains processing histories while version control subsystem 2356 ensures compatibility across system components.

The compressed regions flow through output buffer 2336 for final assembly and validation, with metadata engine 2350 maintaining comprehensive processing records. System management core 2360 continues monitoring until processing completes and data is ready for storage or transmission.

Alternatively, the system may operate in batch mode where input buffer 2332 accumulates a predetermined volume of genomic data before initiating processing. In this configuration, feature analysis subsystem 2312 may process multiple regions in parallel, with quality assessment subsystem 2314 aggregating scores across related regions to optimize compression decisions. Rate control engine 2320 may then determine compression parameters for entire data batches while balancing system resources across multiple simultaneous compression operations. Processing buffer 2334 coordinates these parallel operations using a dynamic scheduling mechanism that adapts to available computational resources and quality requirements. Metadata engine 2350 maintains batch-level tracking while enabling region-specific parameter adjustments, and recovery integration engine 2340 generates comprehensive recovery plans optimized for batch processing. The compressed batches and associated metadata flow to output buffer 2336 for final assembly and validation before storage or transmission.

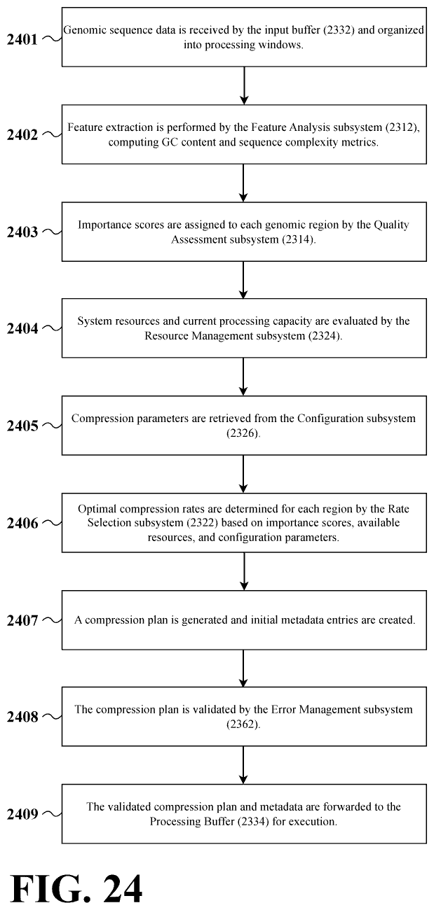

FIG. 24 is a method diagram illustrating the variable compression rate selection process according to an embodiment. Genomic sequence data is received by the input buffer 2332 and organized into processing windows for efficient analysis while preserving sequence relationships and contextual information 2401. Feature extraction is performed by the feature analysis subsystem 2312, computing GC content, sequence complexity metrics, pattern frequencies, and conservation scores across multiple reference datasets 2402. Importance scores are assigned to each genomic region by the quality assessment subsystem 2314 using a trained neural network that evaluates biological significance and information density 2403. System resources and current processing capacity are evaluated by the resource management subsystem 2324, including CPU/GPU availability, memory usage, and I/O bandwidth metrics 2404. Compression parameters are retrieved from the configuration subsystem 2326, incorporating both system-wide defaults and region-specific adjustments based on historical performance data 2405. Optimal compression rates are determined for each region by the rate selection subsystem 2322 based on importance scores, available resources, and configuration parameters, using a reinforcement learning model that balances quality preservation against compression efficiency 2406. A compression plan is generated and initial metadata entries are created, detailing the selected rates, quality thresholds, and recovery parameters for each genomic region 2407. The compression plan is validated by the error management subsystem 2362, ensuring that quality requirements are met and resource allocations are feasible 2408. The validated compression plan and metadata are forwarded to the processing buffer 2334 for execution, where the variable-rate compression will be applied to each region according to the specified parameters 2409.

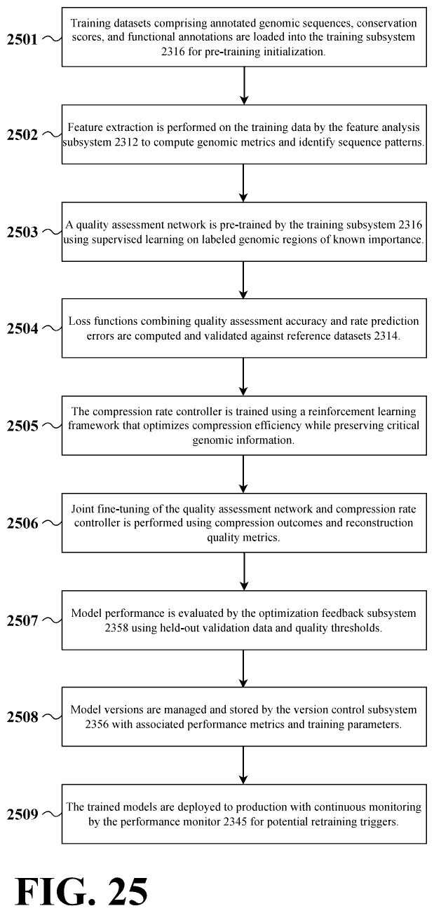

FIG. 25 is a method diagram illustrating the training process according to an embodiment. Training datasets comprising annotated genomic sequences, conservation scores across multiple species, functional annotations, and clinical significance markers are loaded into the training subsystem 2316 for pre-training initialization 2501. Feature extraction is performed on the training data by the feature analysis subsystem 2312 to compute genomic metrics including GC content, sequence complexity, pattern frequencies, and conservation metrics across multiple reference datasets 2502. A quality assessment network is pre-trained by the training subsystem 2316 using supervised learning on labeled genomic regions of known importance, incorporating both sequence-level features and broader genomic context 2503. Loss functions combining quality assessment accuracy and rate prediction errors are computed and validated against reference datasets 2314, with particular emphasis on preserving biologically significant regions and regulatory elements 2504. The compression rate controller is trained using a reinforcement learning framework that optimizes compression efficiency while preserving critical genomic information, with rewards based on achieved compression ratios and penalties for quality degradation 2505. Joint fine-tuning of the quality assessment network and compression rate controller is performed using compression outcomes and reconstruction quality metrics, enabling the system to learn optimal trade-offs between compression efficiency and information preservation 2506. Model performance is evaluated by the optimization feedback subsystem 2358 using held-out validation data and quality thresholds, ensuring consistent performance across diverse genomic regions 2507. Model versions are managed and stored by the version control subsystem 2356 with associated performance metrics, training parameters, and validation results for maintaining system stability and enabling rollback capabilities 2508. The trained models are deployed to production with continuous monitoring by the performance monitor 2345 for potential retraining triggers based on compression effectiveness and recovery accuracy metrics 2509.

In a non-limiting use case example, the system processes genomic data from a large-scale cancer genome sequencing project. Raw genomic sequence data from multiple tumor samples enters through the input buffer 2332 and is organized into 1000-base-pair processing windows. The feature analysis subsystem 2312 extracts key characteristics, identifying regions containing known cancer-related genes, regulatory elements, and structural variations. The quality assessment subsystem 2314 assigns higher importance scores to regions containing tumor suppressor genes and oncogenes based on its training on cancer genomics databases. The rate selection subsystem 2322 determines optimal compression rates, allocating higher fidelity compression to the identified cancer-related regions while applying more aggressive compression to less critical regions. The system maintains detailed metadata tracking compression decisions for each genomic region, enabling researchers to later recover the full-fidelity sequence data specifically for regions of interest. Throughout processing, the error management subsystem 2362 ensures that quality thresholds for clinically relevant regions are strictly maintained, while the performance monitor 2345 tracks reconstruction accuracy metrics specifically for known cancer-associated genomic features. This quality-driven approach enables significant storage savings for large-scale cancer genomics projects while ensuring that critical genetic information for cancer research and diagnosis is preserved.

In an additional non-limiting use case example, the system processes time-series genomic data from longitudinal microbiome studies. Multiple correlated datasets from periodic gut microbiome samplings are received by the input buffer 2332, with the sequence preprocessing subsystem 2319 normalizing the data across time points. The feature analysis subsystem 2312 identifies temporal patterns in microbial population changes while the quality assessment subsystem 2314 assigns higher importance to regions showing significant variation over time. The rate selection subsystem 2322 adapts compression parameters dynamically based on the temporal significance of each region, preserving higher fidelity in sequences showing evolutionary changes while applying increased compression to stable, unchanging regions. The metadata engine 2350 maintains detailed temporal relationships between samples, enabling researchers to track microbial evolution with precise reconstruction of key transitional periods.

In another non-limiting use case example, the system processes integrative multi-omics data from a drug response study. Parallel datasets comprising DNA sequences, RNA expression data, and protein abundance measurements are processed simultaneously. The quality assessment subsystem 2314 evaluates the importance of regions based on cross-correlations between different omics layers, while the rate selection subsystem 2322 determines coordinated compression strategies that preserve these inter-dataset relationships. The recovery integration engine 2340 ensures that compressed data can be reconstructed in a way that maintains the biological relationships between genomic, transcriptomic, and proteomic features, enabling integrated analysis of drug response mechanisms.

In a further non-limiting use case example, the system handles high-throughput single-cell genomics data from developmental biology studies. The input buffer 2332 receives thousands of individual cell sequences, with the feature analysis subsystem 2312 identifying cell-type-specific patterns. The quality assessment subsystem 2314 assigns importance scores based on developmental stage markers and cell-type-specific features, while the rate control engine 2320 implements a hierarchical compression strategy that preserves cell-type-defining regions while maximizing storage efficiency across common sequences. The system management core 2360 coordinates parallel processing of multiple cell datasets while maintaining cell-specific quality requirements throughout the compression pipeline.

In a non-limiting use case example, the system processes metagenomics data from a distributed environmental monitoring network. When corrupted sequence data is detected from one monitoring station, the error management subsystem 2362 initiates recovery procedures, temporarily quarantining affected data segments while maintaining processing of valid sequences. The resource governor subsystem 2368 dynamically reallocates computing resources to handle the increased load from error recovery processes without impacting ongoing compression tasks. When network connectivity issues cause data backlog from multiple stations, the cache management subsystem 2366 implements a multi-tier caching strategy, prioritizing critical environmental marker sequences while temporarily applying more aggressive compression to non-critical regions.

In another non-limiting use case example, the system demonstrates adaptive resource optimization when processing population-scale genome sequences. The resource governor subsystem 2368 scales processing from individual genomes to family units to population-level datasets by dynamically adjusting resource allocation patterns. When processing family trio datasets, the system detects shared genetic regions and optimizes cache usage through the cache management subsystem 2366, storing commonly accessed reference sequences in high-speed cache while moving less frequently accessed regions to lower-tier storage. As system load increases with population-size datasets, the rate control engine 2320 automatically adjusts compression parameters based on available resources, while the optimization feedback subsystem 2358 continuously monitors performance metrics to maintain processing efficiency. When hardware failures occur, the error recovery subsystem 2344 seamlessly redistributes processing loads across available resources while maintaining strict quality thresholds for clinically relevant regions.

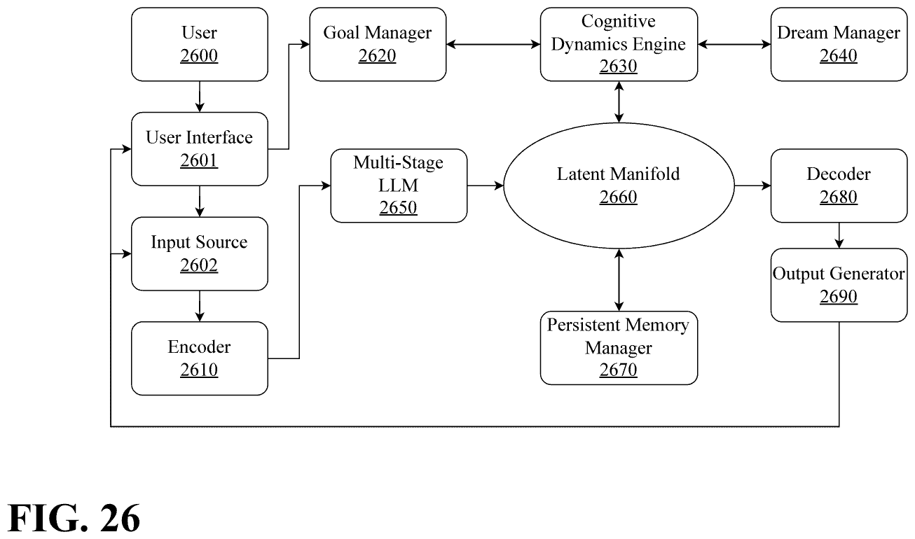

FIG. 26 is a block diagram illustrating an exemplary system architecture of a Persistent Cognitive Machine (PCM). The system enables persistent, adaptive artificial intelligence by representing thoughts as geometric structures within a curved latent space rather than as discrete tokens or static embeddings. This architecture fundamentally reimagines cognition as motion through a shaped memory space, where attention follows geodesic paths through regions of varying curvature and compression, guided by goal potentials and constrained by semantic density.

A user 2600 represents human operators or external systems that interact with the PCM through user interface 2601. User interface 2601 serves as the primary interaction layer, receiving natural language queries, commands, or other forms of input from users while also presenting processed outputs back to them. This interface enables continuous interaction loops where user feedback can shape the evolution of the system's internal geometric structures over time. Unlike traditional AI systems where each interaction is stateless, user interface 2601 maintains context through its connection to the persistent geometric structures within the manifold, allowing for coherent long-term interactions where the system remembers and builds upon previous exchanges. The interface tracks user patterns and preferences, which are encoded as persistent structures within the latent manifold, creating personalized cognitive pathways that improve response relevance and efficiency over time.

An input source 2602 aggregates various data streams including but not limited to multimodal inputs such as text, images, audio, sensor data, and system state information. These heterogeneous inputs are channeled to the encoder 2610, which implements the mathematical transformation, mapping external data from the input space into points within the latent manifold. An encoder 2610 does not simply create vector embeddings but rather projects inputs into a dynamic geometric space where semantic relationships are encoded through curvature, distance, and topological structure. This encoding process is context-sensitive and adaptive, taking into account the current state of the manifold and the compression pressure at different regions. For example, when processing a user query about a technical concept, encoder 2610 identifies the appropriate region within the manifold where related thoughts and concepts have previously been cached, enabling efficient semantic alignment. The encoding process respects the manifold's metric tensor, ensuring that new inputs are embedded in ways that preserve semantic continuity and enable smooth geodesic traversal to related concepts.

A multi-stage LLM 2650 serves as a language processing component that works in conjunction with encoder 2610 to generate semantic structures from raw inputs. Unlike traditional architectures where LLMs operate independently, here multi-stage LLM 2650 functions as a “chip” within the larger system, providing sophisticated natural language understanding and generation capabilities while being guided by the geometric constraints of the manifold. The LLM processes inputs through multiple stages of refinement, creating increasingly abstract and structured representations that can be properly embedded within a latent manifold 2660. The multi-stage nature of this component reflects the hierarchical processing required to transform raw tokens into geometric thoughts. In the first stage, an LLM performs initial semantic parsing and entity recognition. Subsequent stages build increasingly complex relationships and abstractions, ultimately producing high-dimensional thought structures that encode not just content but also contextual relationships, implicit knowledge, and potential inferential pathways. For instance, when processing a complex technical document, the multi-stage LLM 2650 might first extract key concepts, then identify relationships between them, map these to existing knowledge structures in the manifold, and finally generate new thought bundles that capture both explicit content and implicit semantic relationships. These thought structures are not flat embeddings but rich geometric objects with internal curvature that reflects their semantic density and interconnectedness.

A goal manager 2620 creates and maintains goal potential fields that shape how attention flows through the manifold. Rather than implementing goals as discrete objectives or symbolic constraints, goal manager 2620 generates scalar fields over the manifold that attract cognitive processes toward semantically relevant regions. These potential fields can arise from multiple sources including explicit task objectives provided by users, learned value functions from past interactions, internal drives such as curiosity or uncertainty reduction, and contextual constraints. Goal manager 2620 implements field generation algorithms that can create complex potential landscapes with multiple attractors for competing objectives, saddle points where decisions must be made, and smooth gradients that guide exploration. The manager continuously updates these fields based on changing objectives and feedback, creating a dynamic landscape that guides inference and reasoning processes. The goal potential fields interact with the compression pressure fields derived from manifold curvature, creating a rich energetic landscape where attention flows along paths of least resistance while being drawn toward goal-relevant regions. For example, when a user asks a question about a specific topic, goal manager 2620 creates a potential field with high values in manifold regions containing relevant knowledge, effectively “pulling” the system's attention toward useful information while avoiding irrelevant areas. In cases where goals conflict or compete, goal manager 2620 can create field configurations that allow the system to explore multiple solution paths simultaneously or to find creative compromises that satisfy multiple objectives.

The connections between these components are designed to support the flow of geometric information rather than simple data passing. The relationship between a user 2600 to goal manager 2620 represents not just goal specification but the continuous shaping of the potential landscape based on user intent and feedback. The bidirectional connection between encoder 2610 and multi-stage LLM 2650 enables iterative refinement of semantic structures, where initial encodings can be enriched through multiple passes of LLM processing, each time creating more sophisticated geometric representations that better capture the nuanced relationships within the input data.

A cognitive dynamics engine (CDE) 2630 serves as the geometric substrate processor and the core architectural component responsible for maintaining and evolving the structure of the latent manifold 2660. Operating analogously to a physics engine in a simulation environment, CDE 2630 governs the fundamental geometric operations that enable persistent cognition. The engine maintains the manifold's metric tensor, which defines local distances and angles within the cognitive space, continuously updating it based on usage patterns and semantic relationships. It computes geodesic paths for attention traversal by solving the variational problem of minimizing cognitive action, balancing kinetic energy of motion, compression pressure from semantic density, and attraction from goal potential fields. CDE 2630 implements a geodesic equation:

$$\frac{{d}^{2} {γ}^{k}}{{dt}^{2}} + {Γ}_{ij}^{k} \frac{d {γ}^{i}}{dt} \frac{d {γ}^{j}}{dt} = {F}^{k} ( γ ( t ) , t )$$

where the Christoffel symbols σ^{k}ᵢⱼ encode the manifold's connection structure and F^{k} represents forces from compression pressure and goal potentials. During active cognition, CDE 2630 continuously computes Ricci curvature across the manifold, deriving the compression pressure field P(x)=−R(x) that penalizes traversal through semantically dense regions. For example, when processing a complex inference task, CDE 2630 might identify multiple potential geodesic paths through the manifold, evaluate their cognitive costs based on pressure and distance, and select the optimal trajectory that balances efficiency with semantic coherence. The engine also manages the evolution of the attention vector field according to the dynamic equation:

$$\frac{\partial A}{\partial t} + {∇}_{A} A = - ∇ ( P - Φ )$$

enabling attention to flow as a cognitive fluid through the shaped space of memory.

A dream manager 2640 implements autonomous structural reorganization of the manifold during off-task periods, analogous to sleep-driven memory consolidation in biological systems. Connected to CDE 2630, dream manager 2640 initiates and oversees geometric restructuring operations that improve the manifold's efficiency and generalization capacity. During dreaming phases, it samples recently activated or frequently used thought bundles, applying stochastic perturbations follows a distribution informed by local curvature and uncertainty. Dreaming begins by sampling recent or frequently activated bundles B₁, . . . , Bₖ⊂Mₜ. From each bundle, points zᵢ∈Bᵢ are perturbed using a stochastic kernel:

$$\begin{matrix}{z}_{i}^{′} = {z}_{i} + {ε}_{i} , & {ε}_{i}\end{matrix} ∼ N ( 0 , {\sum }_{i} ) ,$$

where Σᵢ reflects local uncertainty or curvature. These perturbations probe the neighborhood structure, testing whether extrapolated directions are compressible or divergent. These perturbations test the stability and compressibility of cognitive structures, identifying opportunities for consolidation or abstraction. The dream manager 2640 performs recombination operations, creating weighted interpolations across semantically related bundles to discover emergent abstractions:

$${z}_{meta} = {\sum }_{i = 1}^{k} {α}_{i} {z}_{i}^{′} , \sum {α}_{i} = 1 ,$$

where weights αᵢ may reflect prior co-activation, semantic alignment, or exploratory policy. The resulting zₘₑₜₐ often lies outside any original bundle, creating novel junctions or abstractions. If the resulting interpolation exhibits internal coherence (e.g., low compression cost, high reconstruction fidelity), it may be retained and added as a new bundle or attractor.

When stable interpolants are found between previously disconnected regions, dream manager 2640 can induce topological changes in the manifold, creating new bridges or handles that enable novel inferential pathways. It implements three primary flows during dreaming: perturbation flow for exploring local curvature basins, compression flow for collapsing redundant structures, and generalization flow for synthesizing higher-order abstractions. For instance, after a day of processing technical documents about machine learning and physics, dream manager 2640 might identify common mathematical structures across these domains, create meta-bundles that capture these abstractions, and reshape the manifold to enable faster traversal between related concepts in future interactions.

A latent manifold 2660 represents the central geometric substrate where all cognitive operations occur, existing as a dynamic, evolving space with rich internal structure. Unlike static embedding spaces in traditional architectures, latent manifold 2660 is a living geometry that continuously adapts through use, compression, and reorganization. Within this space, thoughts exist not as isolated points but as structured regions including thought bundles (compact submanifolds representing coherent concepts), geodesic trajectories (paths of inference and association), and semantic fields (continuous distributions of meaning and relevance). The manifold maintains several critical geometric structures: the metric tensor defining local distances, the connection governing parallel transport of attention, the Ricci curvature tensor measuring semantic density, compression pressure fields derived from curvature, goal potential fields attracting attention, and the attention vector field describing instantaneous cognitive flow. The bidirectional connection with CDE 2630 enables continuous reading and reshaping of these structures, while connections to multi-stage LLM 2650, persistent memory manager 2670, and decoder 2680 facilitate the embedding, storage, and extraction of semantic content. The manifold exhibits emergent topological features such as attractor basins where frequently accessed concepts stabilize, high-curvature regions indicating semantic compression, low-pressure corridors enabling efficient inference, and bridge structures connecting previously disparate domains. As the system operates, the manifold develops a personalized geography reflecting the user's interests, the domain's structure, and the history of cognitive activity.

Persistent memory manager 2670 orchestrates the long-term storage and retrieval of cognitive structures, maintaining a bidirectional connection with latent manifold 2660. Unlike traditional memory systems that store static data, persistent memory manager 2670 preserves geometric structures including thought bundles, established geodesic paths, learned metric relationships, and compression patterns. It implements sophisticated caching strategies that go beyond simple key-value storage, maintaining the topological relationships between thoughts and preserving the geometric context that enables meaningful retrieval. The manager tracks activation energies for cached structures, implementing thermodynamic decay where unused thoughts gradually lose energy, eventually being pruned when falling below a threshold. Decay governs forgetting in PCM systems. Each thought Tᵢ is associated with an activation energy Eᵢ(t), which dissipates over time:

$$\frac{{dE}_{i}}{dt} = - λ \cdot {A}_{i} / ( t )$$

where λ is a decay constant and Aᵢ(t) reflects inactivity—high when idle, zero when active. When Eᵢ(t)<Eₘᵢₙ, the thought is pruned from memory. This process ensures that storage is focused on thoughts that contribute to ongoing cognition. This decay yields several emergent properties:

This creates a natural forgetting mechanism that maintains cognitive efficiency while preserving frequently accessed or structurally important memories. Persistent memory manager 2670 also coordinates with federated memory systems, enabling knowledge sharing across multiple PCM instances while maintaining privacy through geometric abstraction. For example, when storing a complex reasoning pattern, the manager preserves not just the conclusion but the entire geodesic path, the local curvature context, and the relationships to other thought structures, enabling the system to later traverse similar reasoning paths more efficiently.

A decoder 2680 implements the inverse transformation, converting geometric structures from latent manifold 2660 back into observable outputs. This component must interpret rich geometric information including positions within the manifold, local curvature and pressure, nearby thought bundles, and traversed geodesic paths, transforming these into coherent external representations. Decoder 2680 often works in conjunction with multi-stage LLM 2650 to generate natural language outputs, using the LLM's language generation capabilities while being guided by the geometric structures extracted from the manifold. The decoding process is context-sensitive, taking into account not just the final position reached through inference but the entire trajectory taken, enabling explanations that reflect the reasoning process rather than just conclusions. For instance, when answering a complex question, decoder 2680 can trace the geodesic path taken through the manifold, identify key thought bundles that were traversed, and generate an explanation that reflects this structured reasoning process.

An output generator 2690 serves as the final stage in the processing pipeline, taking decoded representations and formatting them appropriately for user consumption or system action. It handles multiple output modalities including natural language responses, visualizations of reasoning paths, actions or commands for external systems, and structured data formats. Output generator 2690 maintains awareness of user preferences and interaction history, adapting its presentation style based on patterns encoded in the manifold. The feedback loop from output generator 2690 back to user 2600 completes the interaction cycle, enabling iterative refinement and continuous learning.

The connections from goal manager 2620 and dream manager 2640 to CDE 2630 show how intentionality and reorganization influence geometric dynamics. The flow from multi-stage LLM 2650 through latent manifold 2660 to decoder 2680 represents the complete cognitive pipeline from input understanding through geometric reasoning to output generation. Throughout this architecture, information flows not as discrete data packets but as geometric structures, trajectories, and fields, creating a unified cognitive system where memory, reasoning, and learning are fundamentally intertwined through the shaped space of thought.

### Exemplary Computing Environment

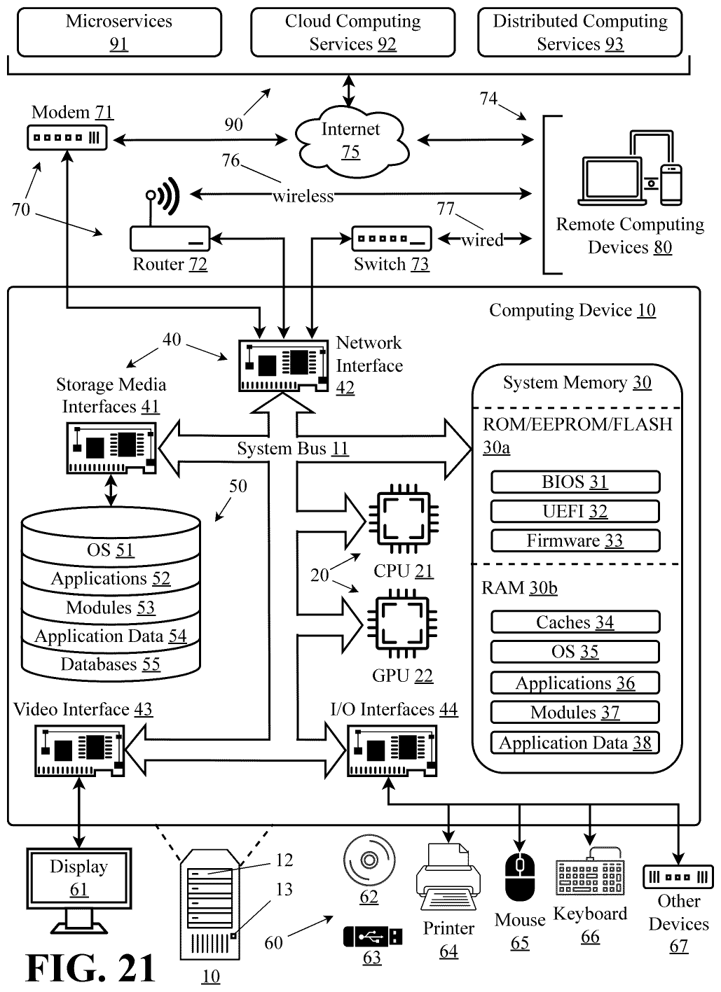

FIG. 21 illustrates an exemplary computing environment or computing system on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between, those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed, or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions. Further, computing device 10 may comprise one or more specialized processors such as a graphics processing unit (GPU) 22 configured to accelerate processing of computer graphics and images via a large array of specialized processing cores arranged in parallel.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, and graph databases.

Applications (also known as computer software or software applications) are sets of programming instructions designed to perform specific tasks or provide specific functionality on a computer or other computing devices. Applications are typically written in high-level programming languages such as C++, Java, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network. Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices.

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, main frame computers, network nodes, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP or message queues. Microservices 91 can be combined to perform more complex processing tasks.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over the Internet on a subscription basis.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer system for processing genomic data using dynamic latent manifolds, comprising:
a hardware memory and at least one processor;
wherein the computer system is configured to execute software instructions stored on nontransitory machine-readable storage media that:
receive genomic datasets;
extract biological features from the genomic datasets;
assess biological importance of genomic regions using a trained neural network that generates importance scores;
compute manifold curvature values using the biological features and importance scores;
embed the genomic data into a dynamic latent manifold as geometric structures, wherein the manifold evolves through use and semantic relationships are represented through geometric properties including distance and curvature;
generate compression pressure fields derived from local curvature that influence processing decisions;
compute optimal geodesic paths through the latent manifold that minimize a cognitive action functional;
determine adaptive compression rates for genomic regions based on geometric properties and biological importance;
execute compression of genomic data according to the determined rates while preserving manifold coordinate information for reconstruction;
update the geometric structure of the latent manifold based on usage patterns; and
generate outputs by decoding geometric information from manifold traversals into genomic analysis results.

2. The computer system of claim 1, wherein the genomic datasets comprise multi-modal data including DNA sequences, genetic variants, gene expression data, and protein abundance measurements.

3. The computer system of claim 1, wherein the biological features include sequence complexity metrics, conservation scores, functional annotations, and cross-modal correlations between different genomic data types.

4. The computer system of claim 1, wherein the software instructions further:
organize genomic data into thought bundles comprising coherent submanifolds of semantically related biological concepts;
perform bundle reorganization operations including consolidation of related concepts, expansion into new biological domains, and merging of functionally related bundles; and
maintain biological taxonomy during bundle modifications.

5. The computer system of claim 1, wherein the trained neural network comprises:
recurrent layers for extracting features from genomic datasets;
a channel-wise transformer with attention mechanisms to capture dependencies between different genomic data types;
hierarchical attention mechanisms operating at multiple biological scales; and
multi-task learning heads for generating importance scores, compression predictions, and quality assessments.

6. The computer system of claim 1, wherein the software instructions further:
apply thermodynamic decay to remove unused genomic concepts from the manifold based on activation energy levels;
strengthen frequently used geodesic pathways by adjusting geometric properties; and
preserve biological relationships during manifold evolution.

7. The computer system of claim 1, wherein the software instructions further:
execute autonomous manifold reorganization during idle periods through perturbation and recombination of existing structures;
discover new biological relationship patterns through geometric analysis;
perform topological modifications to create connections between genomic domains; and
validate structural changes against biological constraints.

8. The computer system of claim 1, wherein the software instructions further:
implement hierarchical organization with nested latent manifolds operating at different biological scales;
establish geometric bridges between abstraction levels;
enable navigation between scales while preserving biological relationships; and
maintain consistency across hierarchical levels.

9. The computer system of claim 1, wherein the software instructions further:
maintain reversible navigation capabilities including forward exploration and backward traversal;
create geometric anchors at decision points in processing paths;
store temporal snapshots of manifold states; and
enable backtracking while preserving semantic relationships.

10. The computer system of claim 1, wherein the software instructions further:
implement federated learning capabilities for knowledge sharing across multiple processing instances;
create privacy-preserving abstractions through geometric generalization;
perform secure computation for collaborative optimization; and
maintain protection of sensitive genomic information during knowledge exchange.

11. A method for processing genomic data using dynamic latent manifolds, comprising the steps of:
receiving genomic datasets;
extracting biological features from the genomic datasets;
assessing biological importance of genomic regions using a trained neural network that generates importance scores;
computing manifold curvature values using the biological features and importance scores;
embedding the genomic data into a dynamic latent manifold as geometric structures, wherein the manifold evolves through use and semantic relationships are represented through geometric properties including distance and curvature;
generating compression pressure fields derived from local curvature that influence processing decisions;
computing optimal geodesic paths through the latent manifold that minimize a cognitive action functional;
determining adaptive compression rates for genomic regions based on geometric properties and biological importance;
executing compression of genomic data according to the determined rates while preserving manifold coordinate information for reconstruction;
updating the geometric structure of the latent manifold based on usage patterns; and
generating outputs by decoding geometric information from manifold traversals into genomic analysis results.

12. The method of claim 11, wherein the genomic datasets comprise multi-modal data including DNA sequences, genetic variants, gene expression data, and protein abundance measurements.

13. The method of claim 11, wherein the biological features include sequence complexity metrics, conservation scores, functional annotations, and cross-modal correlations between different genomic data types.

14. The method of claim 11, further comprising the steps of:
organizing genomic data into thought bundles comprising coherent submanifolds of semantically related biological concepts;
performing bundle reorganization operations including consolidation of related concepts, expansion into new biological domains, and merging of functionally related bundles; and
maintaining biological taxonomy during bundle modifications.

15. The method of claim 11, wherein the trained neural network comprises:
recurrent layers for extracting features from genomic datasets;
a channel-wise transformer with attention mechanisms to capture dependencies between different genomic data types;
hierarchical attention mechanisms operating at multiple biological scales; and
multi-task learning heads for generating importance scores, compression predictions, and quality assessments.

16. The method of claim 11, further comprising the steps of:
applying thermodynamic decay to remove unused genomic concepts from the manifold based on activation energy levels;
strengthening frequently used geodesic pathways by adjusting geometric properties; and
preserving biological relationships during manifold evolution.

17. The method of claim 11, further comprising the steps of:
executing autonomous manifold reorganization during idle periods through perturbation and recombination of existing structures;
discovering new biological relationship patterns through geometric analysis;
performing topological modifications to create connections between genomic domains; and
validating structural changes against biological constraints.

18. The method of claim 11, further comprising the steps of:
implementing hierarchical organization with nested latent manifolds operating at different biological scales;
establishing geometric bridges between abstraction levels;
enabling navigation between scales while preserving biological relationships; and
maintaining consistency across hierarchical levels.

19. The method of claim 11, further comprising the steps of:
maintaining reversible navigation capabilities including forward exploration and backward traversal;
creating geometric anchors at decision points in processing paths;
storing temporal snapshots of manifold states; and
enabling backtracking while preserving semantic relationships.

20. The method of claim 11, further comprising the steps of:
implementing federated learning capabilities for knowledge sharing across multiple processing instances;
creating privacy-preserving abstractions through geometric generalization;
performing secure computation for collaborative optimization; and
maintaining protection of sensitive genomic information during knowledge exchange.
